(19) United States
(12) Patent Application Publication
(10) Pub. No.: US 2024/0338204 A1
(43) Pub. Date: Oct. 10, 2024

(54) VEHICLE COMMUNICATION SYSTEM AND IN-VEHICLE SYSTEM

(71) Applicant: DENSO CORPORATION, Kariya-city (JP)

(72) Inventors: Yuzo HARATA, Kariya-city (JP); Hideo YOSHIMI, Kariya-city (JP); Nao KOJIMA, Kariya-city (JP)

(73) Assignee: DENSO CORPORATION, Kariya-city (JP)

(21) Appl. No.: 18/750,007

(22) Filed: Jun. 21, 2024

Related U.S. Application Data
(63) Continuation-in-part of application No. PCT/JP2022/041351, filed on Nov. 7, 2022.

(30) Foreign Application Priority Data
Dec. 24, 2021 (JP) 2021-210817

(51) Int. Cl. G06F 8/65; H04L 67/125; H04W 4/48

(52) U.S. Cl. CPC G06F 8/65; H04L 67/125; H04W 4/48

(57) ABSTRACT

A vehicle communication system is configured to receive vehicle configuration information from a vehicle and determine whether there is campaign information, generate campaign notification information for the vehicle, manage a generation state of the campaign information, and deliver the campaign notification information to the vehicle. The vehicle communication system includes a center apparatus in which an application program that implements functions employs a serverless architecture. When an in-vehicle system transmits a first request including vehicle information to the center apparatus, the center apparatus transmits an intermediate response including a job ID to the in-vehicle system. When receiving the intermediate response, the in-vehicle system transmits a response request of a final response corresponding to the first request to the center apparatus as a second request to which the job ID is assigned.

### CROSS REFERENCE TO RELATED APPLICATIONS

The present application is a continuation-in-part application of International Patent Application No. PCT/JP2022/041351 filed on Nov. 7, 2022, which designated the U.S. and claims the benefit of priority from Japanese Patent Application No. 2021-210817 filed on Dec. 24, 2021. The entire disclosures of all of the above applications are incorporated herein by reference.

### TECHNICAL FIELD

The present disclosure relates to a vehicle communication system and an in-vehicle system.

### BACKGROUND

A related art discloses a technique in which an update program of an ECU is distributed from a server to an onboard device by Over The Air (OTA), and the update program is rewritten on the vehicle side.

### SUMMARY

A vehicle communication system is configured to receive vehicle configuration information from a vehicle and determine whether there is campaign information, generate campaign notification information for the vehicle, manage a generation state of the campaign information, and deliver the campaign notification information to the vehicle. The vehicle communication system includes a center apparatus in which an application program that implements functions employs a serverless architecture. When an in-vehicle system transmits a first request including vehicle information to the center apparatus, the center apparatus transmits an intermediate response including a job ID to the in-vehicle system. When receiving the intermediate response, the in-vehicle system transmits a response request of a final response corresponding to the first request to the center apparatus as a second request to which the job ID is assigned.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram illustrating a configuration of an OTA center in the first embodiment;

FIG. 2 is a diagram illustrating an example in which the functions of the OTA center are implemented by applying the AWS;

FIG. 3 is a flowchart schematically illustrating a process performed between a vehicle-side system and an OTA center;

FIG. 4A is a flowchart (part 1) illustrating a process from reception of vehicle configuration information to transmission of campaign information;

FIG. 4B is a flowchart (part 2) illustrating a process from reception of vehicle configuration information to transmission of campaign information;

FIG. 5A is a flowchart (part 1) illustrating a process from registration of campaign information to registration of a distribution package to a CDN distribution section;

FIG. 5B is a flowchart (part 2) illustrating a process from registration of campaign information to registration of a distribution package to a CDN distribution section;

FIG. 6 is a flowchart illustrating a process from data access by the vehicle to distribution of a package by the CDN distribution section;

FIG. 7 is a flowchart illustrating a software update data registration process;

FIG. 8A is a flowchart (part 1) illustrating a process from registration of case information to generation of a package;

FIG. 8B is a flowchart (part 2) illustrating a process from registration of case information to generation of a package;

FIG. 9 is a flowchart (part 3) illustrating a process from registration of case information to generation of a package;

FIG. 10 is a diagram for describing an effect obtained by accumulating data in a queuing buffer section for a certain period of time and then passing the data to a next-stage compute service function section;

FIG. 11 is a view illustrating a processing form of each of a server model and a serverless model;

FIG. 12 is a diagram illustrating running costs of the server model and the serverless model;

FIG. 13 is a functional block diagram illustrating a configuration of an OTA center in the second embodiment;

FIG. 14 is a diagram illustrating an example in which the functions of the OTA center are implemented by applying the AWS;

FIG. 15A is a flowchart (part 1) illustrating a process from reception of vehicle configuration information to transmission of a job ID and generation of campaign information;

FIG. 15B is a flowchart (part 2) illustrating a process from reception of vehicle configuration information to transmission of a job ID and generation of campaign information;

FIG. 16 is a flowchart illustrating a process from reception of a campaign information request to check of a generation status and transmission;

FIG. 17A is a flowchart (part 1) illustrating a process from registration of campaign information to registration of a distribution package to a CDN distribution section;

FIG. 17B is a flowchart (part 2) illustrating a process from registration of campaign information to registration of a distribution package to a CDN distribution section;

FIG. 18 is a flowchart (part 3) illustrating a process from registration of campaign information to registration of a distribution package to a CDN distribution section;

FIG. 19A is a flowchart (part 1) illustrating a process from registration of case information to generation of a package;

FIG. 19B is a flowchart (part 2) illustrating a process from registration of case information to generation of a package;

FIG. 20 is a flowchart (part 3) illustrating a process from registration of case information to generation of a package;

FIG. 21 is a functional block diagram illustrating a configuration of an OTA center in the third embodiment;

FIG. 22 is a diagram illustrating an example in which the functions of the OTA center are implemented by applying the AWS;

FIG. 23 is a flowchart illustrating a process from reception of vehicle configuration information to transmission of a job ID and generation of campaign information;

FIG. 24A is a flowchart (part 1) illustrating a process from reception of a campaign information request to check of a generation status and transmission of the campaign information;

FIG. 24B is a flowchart (part 2) illustrating a process from reception of the campaign information request to check of a generation status and transmission of the campaign information;

FIG. 25A is a flowchart (part 1) illustrating a process from registration of campaign information to registration of a distribution package to a CDN distribution section;

FIG. 25B is a flowchart (part 2) illustrating a process from registration of campaign information to registration of a distribution package to a CDN distribution section;

FIG. 26A is a flowchart (part 1) illustrating a process from reception of a registration request of case information to check and transmission of registration information;

FIG. 26B is a flowchart (part 2) illustrating a process from reception of a registration request of case information to check and transmission of registration information;

FIG. 27 is a diagram for describing a problem that may occur in the third embodiment in the fourth embodiment;

FIG. 28 is a functional block diagram illustrating a configuration of an OTA center;

FIG. 29 is a diagram illustrating an example in which the functions of the OTA center are implemented by applying the AWS;

FIG. 30 is a flowchart illustrating a process from reception of vehicle configuration information to transmission of a job ID and generation of campaign information;

FIG. 31 is a functional block diagram illustrating a configuration of an OTA center in the fifth embodiment;

FIG. 32 is a diagram illustrating an example in which the functions of the OTA center are implemented by applying the AWS;

FIG. 33 is a flowchart illustrating a process from reception of vehicle configuration information to transmission of a job ID and generation of campaign information;

FIG. 34 is a flowchart illustrating a process from registration of campaign information to registration of a distribution package to a CDN distribution section;

FIG. 35 is a flowchart illustrating a process from registration of case information to generation of a package;

FIG. 36 is a functional block diagram illustrating a configuration of an OTA center in the sixth embodiment;

FIG. 37 is a diagram illustrating an example in which the functions of the OTA center are implemented by applying the AWS;

FIG. 38A is a flowchart (part 1) illustrating a process from reception of a campaign information request to check of a generation status and transmission of the campaign information;

FIG. 38B is a flowchart (part 2) illustrating a process from reception of a campaign information request to check of a generation status and transmission of the campaign information;

FIG. 39 is a flowchart illustrating a process from data access by the vehicle to distribution of a package by the CDN distribution section;

FIG. 40 is a functional block diagram illustrating a configuration of a vehicle communication system in the seventh embodiment;

FIG. 41 is a diagram illustrating an example in which the functions of the OTA center are implemented by applying the AWS;

FIG. 42 is a diagram for explaining functional sections included in the downloader of the OTA master;

FIG. 43 is a flowchart illustrating a process by the OTA master from transmission of vehicle configuration information to reception of campaign information;

FIG. 44 is a flowchart illustrating a process of transmitting entire data of the vehicle configuration information;

FIG. 45A is a flowchart (part 1) illustrating a process by the OTA center from transmission of vehicle configuration information (request 1) to transmission of campaign information;

FIG. 45B is a flowchart (part 2) illustrating a process by the OTA center from transmission of the vehicle configuration information (request 1) to transmission of the campaign information;

FIG. 45C is a flowchart (part 3) illustrating a process by the OTA center from transmission of the vehicle configuration information (request 1) to transmission of the campaign information;

FIG. 46A is a flowchart (part 4) illustrating a process by the OTA center from transmission of vehicle configuration information (request 1) to transmission of campaign information;

FIG. 46B is a flowchart (part 5) illustrating a process by the OTA center from transmission of the vehicle configuration information (request 1) to transmission of the campaign information;

FIG. 47 is a flowchart illustrating a process by the OTA center from transmission of vehicle configuration information (request 2) to transmission of campaign information;

FIG. 48A is a flowchart (part 1) illustrating a process performed between an OTA center and an OTA master when acceptance related to program update by a campaign is sequentially performed in the eighth embodiment;

FIG. 48B is a flowchart (part 2) illustrating a process performed between the OTA center and the OTA master when acceptance related to program update by a campaign is sequentially performed;

FIG. 49A is a flowchart (part 1) illustrating a process performed between an OTA center and an OTA master when acceptance related to program update by a campaign is sequentially performed in the ninth embodiment;

FIG. 49B is a flowchart (part 2) illustrating a process performed between the OTA center and the OTA master when acceptance related to program update by a campaign is sequentially performed;

FIG. 50 is a flowchart illustrating VIN list a registration process of a premium member in the tenth embodiment;

FIG. 51 is a flowchart (part 1) illustrating a process by the OTA center from transmission of vehicle configuration information to transmission of campaign information;

FIG. 52 is a flowchart (part 2) illustrating a process by the OTA center from transmission of vehicle configuration information to transmission of campaign information;

FIG. 53 is a functional block diagram assuming a case where the functions of the OTA center are mainly configured by applying a server architecture;

FIG. 54 is a diagram illustrating a tendency of server access by a time zone in the connected car service; and

FIG. 55 is a diagram illustrating a difference in the number of vehicles sold in each region.

### DETAILED DESCRIPTION

In recent years, with diversification of vehicle control such as a driving assistance function and an automated driving function, a scale of application programs for vehicle control, diagnosis, and the like mounted on an electronic control unit (hereinafter, referred to as an electronic control unit (ECU)) of a vehicle is increasing. In addition, with the version up by function improvement or the like, there is an increasing opportunity to perform so-called reprogramming in which the application program of the ECU is rewritten. On the other hand, with the development of communication networks and the like, connected car technology has also become widespread.

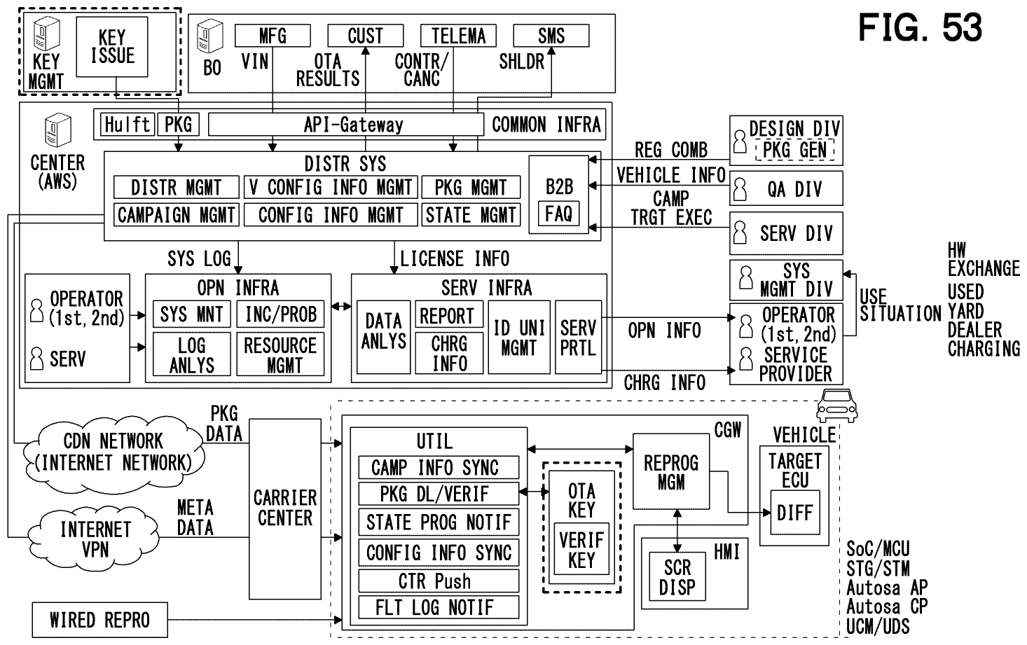

When the center apparatus disclosed in a related art is actually configured, for example, a configuration as illustrated in FIG. 53 is obtained, and it is assumed that each of the management blocks and the like constituting the center apparatus is realized by an architecture on the assumption that a server is generally used. In the present application, an environment or a configuration for executing the application program on the premise of using a server is referred to as a “server architecture”. In other words, in the server architecture, a resource is constantly allocated to the application program, and the program is executed as a resident type process.

The abbreviation in FIG. 53 will be explained as follows. “KEY MGMT” corresponds to key management center. “KEY ISSUE” corresponds to OTA key issuance/management. “BO” corresponds to OEM back office. “MFG” corresponds to manufacturing information system management system. “CUST” corresponds to customer management system. “OTA RESULTS” corresponds to OTA results/implementation history. “TELEMA” corresponds to telematics contract system. “CONTR/CANC” corresponds to telematics contract/cancellation. “SMS” corresponds to SMS distribution center. “SHLDR” corresponds to shoulder tap. “COMMON INFRA” corresponds to common infrastructure. “CENTER” corresponds to OTA center. “DISTR SYS” corresponds to OTA distribution system. “DISTR MGMT” corresponds to distribution management. “V CONFIG INFO MGMT” corresponds to vehicle configuration information management. “PKG MGMT” corresponds to package management. “CAMPAIGN MGMT” corresponds to campaign management. “CONFIG INFO MGMT” corresponds to configuration information management. “STATE MGMT” corresponds to state management/output of individual vehicle. “B2B” corresponds to B2B portal. “OPERATOR” corresponds to OTA operator. “SERV” corresponds to OTA service provider. “SYS LOG” corresponds to system log/analysis log/error information. “OPN INFRA” corresponds to operational infrastructure. “SYS MNT” corresponds to system monitoring. “INC/PROB” corresponds to incident/problem management. “LOG ANLYS” corresponds to LOG analysis. “RESOURCE MGMT” corresponds to asset management/resource management. “LICENSE INFO” corresponds to license information/charging source data, OTA record/ID information. “SERV INFRA” corresponds to service infrastructure. “DATA ANLYS” corresponds to data analysis. “REPORT” corresponds to report output. “CHRG INFO” corresponds to charging information output. “ID UNI MGMT” corresponds to ID unified management. “SERV PRTL” corresponds to service portal. “REG COMB” corresponds to regular combination campaign information package file. “DESIGN DIV” corresponds to vehicle design division. “PKG GEN” corresponds to package generation. “VEHICLE INFO” corresponds to target vehicle information. “QA DIV” corresponds to quality assurance division. “CAMP TRGT EXEC” corresponds to campaign target vehicle execution date. “SERV DIV” corresponds to service division. “SYS MGMT DIV” corresponds to OTA system management division. “OPN INFO” corresponds to operation/maintenance information. “CHRG INFO” corresponds to charging/billing information. “USE SITUATION” corresponds to use situation/charging information. “USED” corresponds to sales of used vehicle. “PKG DATA” corresponds to package data. “WIRED REPRO” corresponds to wired reprogramming tool. “UTIL” corresponds to utility/downloader. “CAMP INFO SYNC” corresponds to campaign information synchronization. “PKG DL/VERIF” corresponds to package download/verification. “STATE PROG NOTIF” corresponds to OTA state progress notification. “CONFIG INFO SYNC” corresponds to vehicle configuration information synchronization. “CTR Push” corresponds to center Push. “FLT LOG NOTIF” corresponds to fault log information notification. “VERIF KEY” corresponds to verification key placement. “REPROG MGM” corresponds to reprogramming management (installation). “SCR DISP” corresponds to screen display. “HMI” corresponds to in-vehicle HMI. “DIFF” corresponds to difference update. “STG/STM” corresponds to storage/streaming.

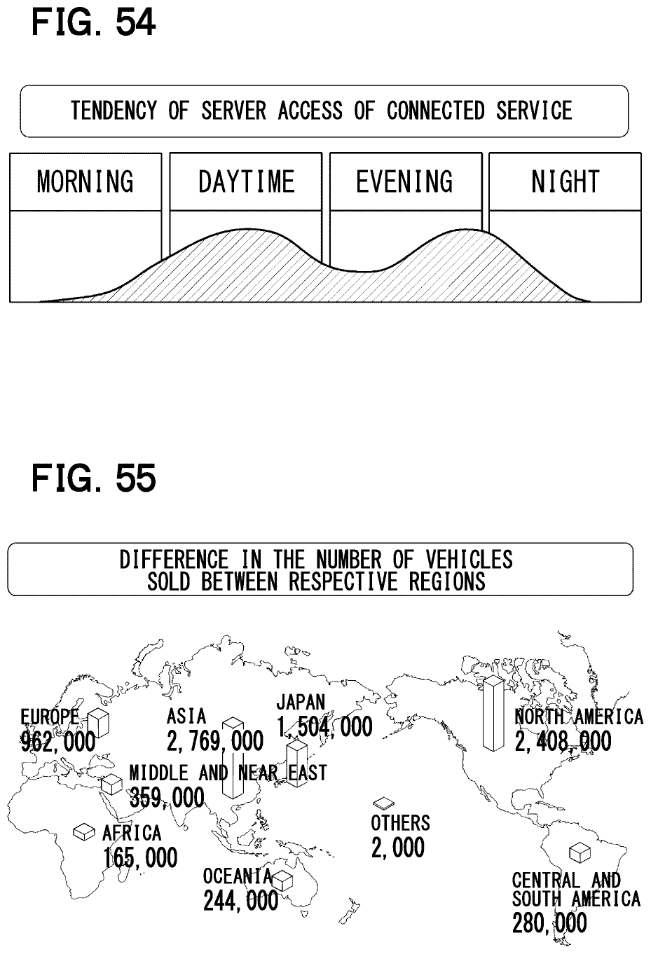

As illustrated in FIG. 54, it is assumed that the access from the vehicle to the server included in the center apparatus increases during the day and decreases during the night. Therefore, when the server is operated at night, the cost is wasteful.

In addition, legally, it is necessary to install a center apparatus corresponding to a connected car in each country. Therefore, when a system of the same scale is constructed for each country, in an area where there are few vehicles, the cost of operating the server is wasteful (see FIG. 55).

Therefore, it is assumed that an environment or a configuration in which an application program is executed by the center apparatus is realized by a serverless architecture that does not depend on the server architecture described above. A serverless architecture will be described in detail below, but refers to one that uses a computing service to execute program code on demand without using a server.

The communication performed between the vehicle and the center apparatus basically has a flow in which a response is returned to the vehicle after a process corresponding to a request from the vehicle is performed by the center apparatus. When the serverless architecture is used, billing in the computing service occurs every time the process is executed. Therefore, how to suppress the occurrence of billing is an issue. In addition, it is necessary to efficiently perform communication performed between the vehicle and the center apparatus and to effectively use computing resources.

The present disclosure provides a vehicle communication system and an in-vehicle system that can minimize consumption of computing resources that occurs with employment of a serverless architecture when a plurality of vehicles performs wireless communication with a center apparatus.

According to a vehicle communication system, a center apparatus implements, by an application program, a plurality of functions for managing data to be written into an electronic control unit mounted on a vehicle and transmitting update data to the vehicle by wireless communication. An application program implementing at least one of the other functions employs a serverless architecture in which the application program is activated upon occurrence of an event and is dynamically allocated with a resource in an on-demand manner for execution of a code of the application program, and in which the resource allocated to the application program is released when the execution of the code is terminated.

As described above, the number of accesses from the vehicle to the center apparatus varies depending on the time zone, and the number of vehicles varies depending on the region. When the application program that implements at least some functions employs the serverless architecture, the resource being dynamically allocated and the program is activated every time access from the vehicle occurs, and the resource is released when the execution of the code is completed. Therefore, as compared with a case of employing a server architecture executed as a resident type process, consumption of computing resources can be saved, and as a result, running costs for the infrastructure can be reduced.

A campaign determination section receives vehicle configuration information from a vehicle and determines whether there is campaign information for the vehicle. A campaign generation section generates campaign notification information for the vehicle when there is the campaign information. A status management section manages a generation state of the campaign information. A campaign transmission section delivers the campaign notification information to a vehicle according to the generation state. An application program that implements functions of the campaign determination section, the status management section, and the campaign generation section employs the serverless architecture.

For example, since the status management section manages the generation state of the campaign information even in communication in which connection management is required to be performed, the campaign generation section and the campaign transmission section do not need to continue to operate during a period until the campaign notification information is distributed to the vehicle. Therefore, it is possible to enjoy more merits of realizing these functions by the serverless architecture.

And at this time, when the in-vehicle system transmits a first request including vehicle information to the center apparatus, the campaign transmission section transmits an intermediate response including a job ID corresponding to the request to the in-vehicle system. When receiving the intermediate response, the in-vehicle system transmits a response request of a final response corresponding to the first request to the center apparatus as a second request to which the job ID is assigned.

That is, the in-vehicle system may transmit the request twice when communicating with the center apparatus. Then, the center apparatus may start an application program corresponding to the requested process and cause to the program execute the process during the two times of request transmission. As a result, even when an external compute service employing the serverless architecture is used, the service can be used only for a period for executing a necessary process. Therefore, when the system is charged according to the use time of the service, the operation cost of the center apparatus can be reduced.

### First Embodiment

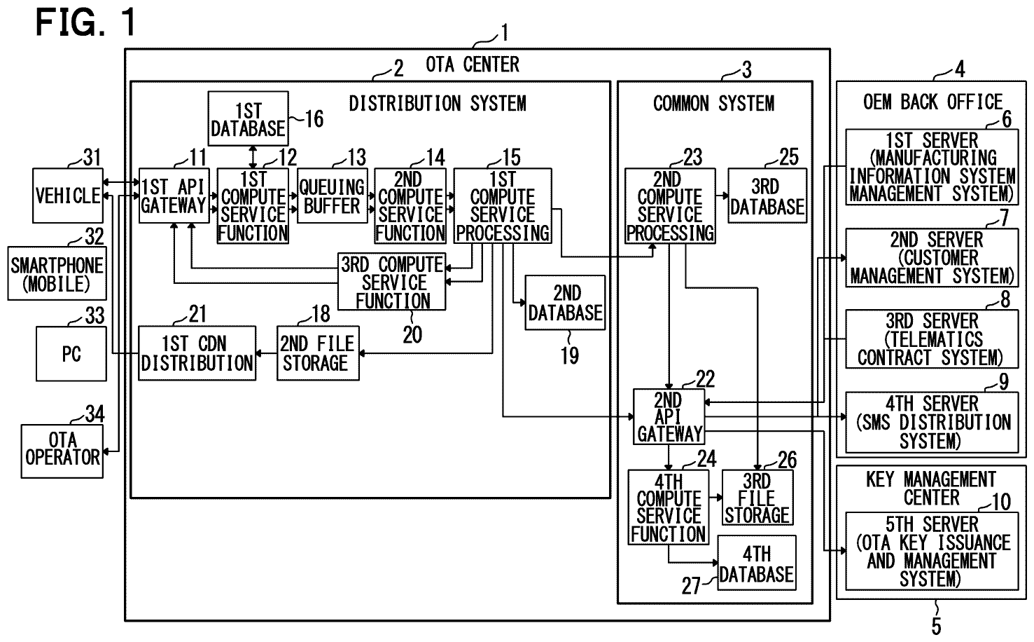

Hereinafter, a first embodiment will be described. As illustrated in FIG. 1, an OTA center 1 which is a center apparatus of the present embodiment includes a distribution system 2 and a common system 3. In the common system 3, a distribution package including an update program and data of the ECU to be distributed to a vehicle 31 which is a vehicle is generated and managed, and the generated distribution package is distributed to the vehicle 31 via the distribution system 2 by wireless communication, that is, by an OTA.

When the common system 3 generates a package, necessary data is transmitted and received to and from an original equipment manufacturer (OEM) back office 4 which is an external server system and a key management center 5. The OEM back office 4 includes a first server 6 to a fourth server 9, and the like. These servers 6 to 9 are similar to those illustrated in FIG. 53, and are systems for manufacturing information management system, customer management system, telematics contract, and short message service (SMS) distribution, respectively. The key management center 5 includes a fifth server 10 that is a system that issues and manages a key used for the OTA.

In the first server 6 to the fifth server 10, the above-described server architecture is used, a resource is constantly allocated to the application program, and the program is executed as a resident type process.

An application programming interface (API) gateway section (1) 11 of the distribution system 2 performs wireless communication with the vehicle 31 and an OTA operator 34. The data received by the API gateway section 11 is sequentially transferred to a compute service function section (1) 12, a queuing buffer section 13, a compute service function section (2) 14, and a compute service processing section (1) 15. The compute service function section 12 accesses a database section (1) 16. The compute service processing section 15 accesses a file storage section 18 and a database section (2) 19. The database section 19 stores campaign information that is update information of software corresponding to the vehicle 31 that requires program update. The API gateway section 11 exchanges data input/output, instructions, and responses with the vehicle 31, the OTA operator 34, a smartphone 32, a PC 33, and the like. Note that the API gateway section 11 may perform wired communication with the OTA operator 34 or the PC 33.

The data output from the compute service processing section 15 is output to the API gateway section 11 via the compute service function section (3) 20. A contents distribution network (CDN) distribution section 21 accesses the file storage section 18 and distributes data stored in the file storage section 18 to the vehicle 31 by the OTA. The CDN distribution section 21 is an example of a network distribution section.

The API gateway section (2) 22 of the common system 3 inputs to output data to and from the compute service processing section 15 of the distribution system 2, and the compute service processing section (2) 23 and the compute service function section (4) 24 included in the common system 3. The compute service processing section 23 accesses a database section (3) 25 and a file storage section (3) 26. The compute service function section 24 accesses a file storage section 26 and a database section (4) 27. The API gateway section 22 also accesses the respective servers 6 to 10 included in the OEM back office 4 and the key management center 5. The API gateway section 22 exchanges data input/output, instructions, and responses with the respective servers 6 to 10 included in the OEM back office 4 and the key management center 5.

In the above configuration, the compute service function sections 12, 14, 20, and 24 and the compute service processing sections 15 and 23 employ a serverless architecture. The “serverless architecture” is activated in response to occurrence of an event, and a resource is automatically allocated for execution of a code of an application program by an on-demand method. The allocated resource is configured to be automatically released when the execution of the code is completed, and is based on a design concept opposite to the above-described “server architecture”.

In addition, the “serverless architecture” is activated in response to the occurrence of an event, resource being dynamically allocated to the execution of the code of the application program, and the allocated resource is released when the execution of the code is completed. When the execution of the code is completed, the resource is released. The resource may be released immediately after completion of the execution of the code, or may be released after waiting for a predetermined time, for example, 10 seconds, after completion of the execution.

Here, four principles for configuring a serverless architecture are:
Use a computing service, without using a server, to execute a program code on demand;
A straight function having only one purpose;
Configure a push-based event-driven pipeline; and
Configure a thicker and stronger front end, and so on.

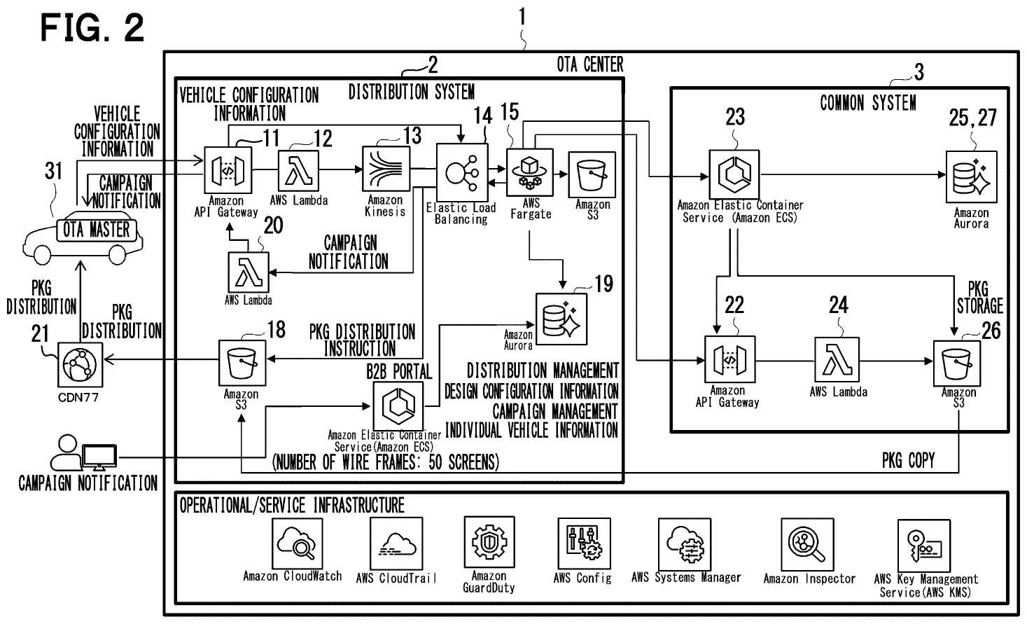

FIG. 2 is an example of a case where a center apparatus 1 illustrated in FIG. 1 is configured using an Amazon web service (AWS) cloud.

Amazon API Gateway corresponds to the API gateway sections 11 and 22.

AWS Lambda corresponds to the compute service function sections 12, 20, and 24.

Amazon Kinesis corresponds to the queuing buffer section 13.

Elastic Load Balancing corresponds to the compute service function section 14.

AWS Fargate corresponds to the compute service processing section 15.

Amazon S3 corresponds to the file storage sections 18 and 26.

Amazon Aurora corresponds to the database sections 19, 25, and 27.

The CDN 77 corresponds to the CDN distribution section 21, which is a service provided by the CDN 77. This may be replaced with the Amazon CloudFront service provided by the AWS. The CDN 77 is a cache server distributed throughout the world. In addition, both AWS Lambda and AWS Fargate are serverless computing services, and can implement equivalent functions. Therefore, the compute service function section 14 and the compute service processing section 15 may be aggregated in any block diagram.

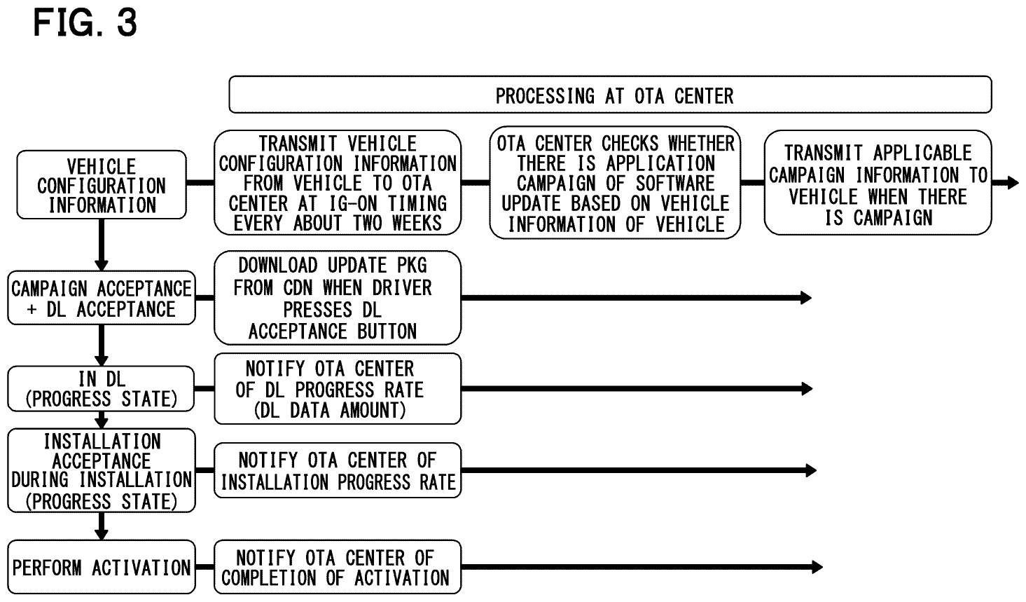

Next, the operation of the present embodiment will be described. As illustrated in FIG. 3, in the phase of “vehicle configuration information synchronization”, the vehicle configuration information is transmitted to the OTA center 1 at the timing when the ignition switch is turned ON in the vehicle 31, for example, every two weeks. The vehicle configuration information is information related to hardware and software of an ECU mounted on the vehicle. Based on the transmitted vehicle configuration information, the OTA center 1 checks whether there is campaign information to be applied for software update. When there is corresponding campaign information, the campaign information is transmitted to the vehicle 31. When the vehicle configuration information is transmitted by the vehicle 31, the process of comparing the information with the vehicle configuration information of the vehicle 31 held on the OTA center 1 side and updating the information to the newer information is referred to as a synchronization process of the vehicle configuration information. The vehicle configuration information is an example of the vehicle information.

In the phase of “campaign acceptance +DL acceptance”, when the driver of the vehicle 31 receiving the campaign information presses a button for accepting the download, the button displayed on the screen of the onboard device, the data package for program update is downloaded from the CDN distribution section 21. During the download, the vehicle 31 notifies the OTA center 1 of the progress rate of the download process.

When the download is completed and the installation performed with “installation acceptance”, the vehicle 31 notifies the OTA center 1 of the progress rate of the installation process. When the installation process is completed, the status of the vehicle 31 is “execution of activation”, and the activation is completed, the OTA center 1 is notified of the completion of the activation.

The “campaign acceptance+DL acceptance” and the “installation acceptance” including the “installation acceptance” may be obtained from the driver at the time of “campaign acceptance+DL acceptance”.

Hereinafter, details of each process described above will be described.

### <Reception of Vehicle Configuration Information→Transmission of Campaign Information>

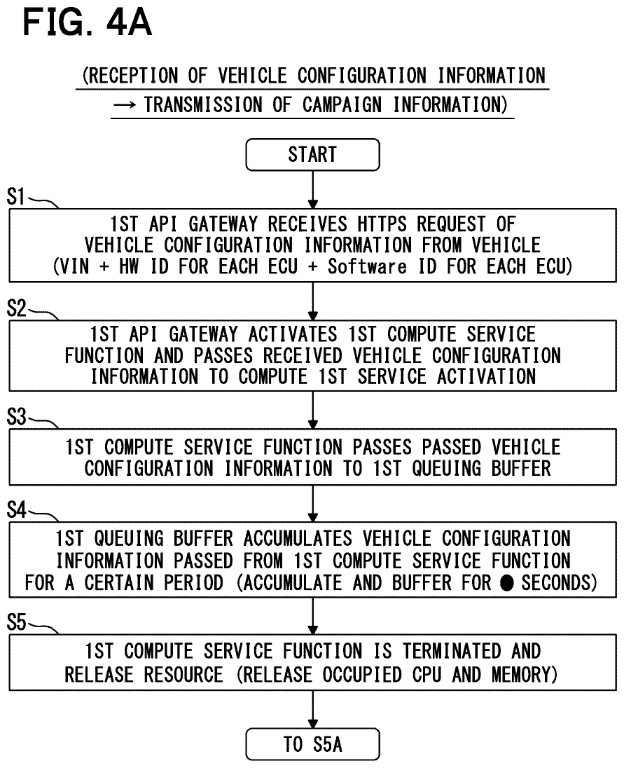

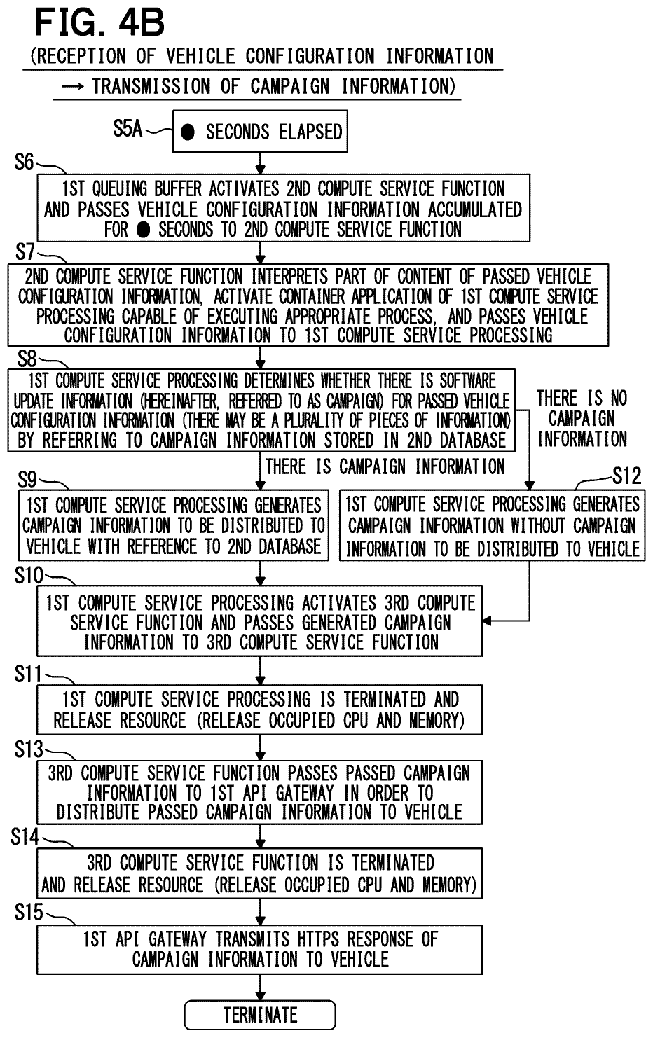

As illustrated in FIG. 4, the API gateway section 11 receives a Hypertext Transfer Protocol Secure (HTTPS) request of the vehicle configuration information from the vehicle 31 (S1). The request content is, for example, a vehicle identification number (VIN), a hardware ID of each ECU, a software ID of each ECU, and the like. Next, when activating the compute service function section 12, the API gateway section 11 passes the received vehicle configuration information to the function section 12 (S2).

The compute service function section 12 passes the vehicle configuration information to the queuing buffer section 13 (S3). The queuing buffer section 13 accumulates and buffers the passed vehicle configuration information for a certain period, for example, one second or several seconds (S4). The compute service function section 12 terminates the process and releases the resources such as the CPU and the memory occupied for performing the process (S5). The compute service function section 12 may receive the TCP port number from the API gateway section 11 and store the TCP port number in the shared memory as necessary.

When the certain period has elapsed (S5A), the queuing buffer section 13 activates the compute service function section 14 and passes the vehicle configuration information accumulated within the certain period to the compute service function section 14 (S6). The queuing buffer section 13 is an example of an access buffer control section. When the compute service function section 14 interprets part of the content of the passed vehicle configuration information and activates the container application of the compute service processing section 15 capable of executing the appropriate process, the compute service function section passes the vehicle configuration information to the compute service processing section 15 (S7).

The container is a collection of libraries, programs, and the like necessary for creating a container as a logical section on the host OS and operating an application. Resources of the OS are logically separated and shared and used by a plurality of containers. An application executed in the container is referred to as a container application.

The compute service processing section 15 accesses the database section 19 and determines whether there is campaign information which is software update information corresponding to the passed vehicle configuration information (S8). When the campaign information exists, the compute service processing section 15 generates the campaign information to be distributed to the vehicle 31 with reference to the database section 19 (S9). The compute service processing section 15 is an example of a campaign determination section and a campaign generation section. In addition, the compute service function section 14 corresponds to a first compute service section, and the compute service processing section 15 corresponds to a second compute service section.

The compute service processing section 15 activates a compute service function section 20 and passes the generated campaign information (S10). The compute service processing section 15 terminates the process and releases the resources such as the CPU and the memory occupied for performing the process (S11). When there is no campaign in step S8, the campaign information for making notification of “there is no campaign” to be distributed to the vehicle 31 is generated (S12), and then the process proceeds to step S10.

The compute service function section 20 passes the passed campaign information to the API gateway section 11 in order to distribute the passed campaign information to the corresponding vehicle 31. The compute service function section 20 terminates the process and releases the resources such as the CPU and the memory occupied for performing the process (S14). The API gateway section 11 transmits an HTTPS response including the campaign information to the vehicle 31 (S15). The API gateway section 11 is an example of a campaign transmission section.

In the above process, the compute service function section 20 may acquire the TCP port number stored by the compute service function section 12 from the shared memory as necessary, and request the API gateway section 11 to distribute the HTTPS response for the TCP port number.

### <Registration of Campaign Information→Registration of Distribution Package to CDN Distribution Section 21>

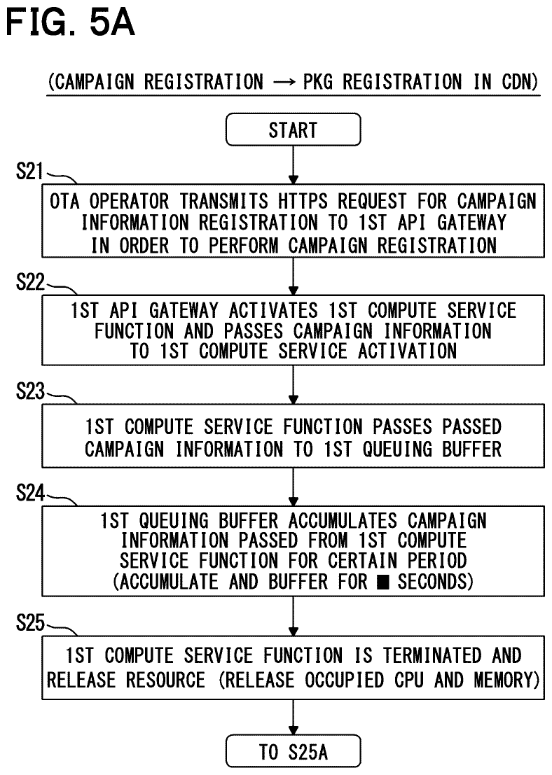

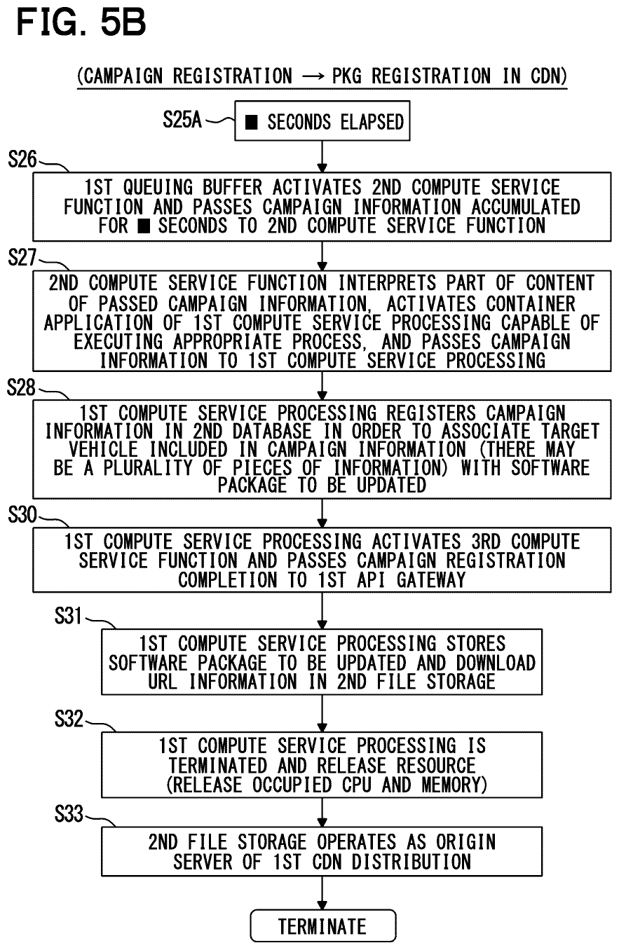

As illustrated in FIG. 5, the OTA operator 34 transmits an HTTPS request for registering campaign information (S21). When activating the compute service function section 12, the API gateway section 11 passes the received campaign information (S22).

The compute service function section 12 passes the campaign information to the queuing buffer section 13 (S23). The queuing buffer section 13 accumulates and buffers the passed campaign information for a certain period (S24). The compute service function section 12 terminates the process and releases the resources such as the CPU and the memory occupied for performing the process (S25). The compute service function section 12 is an example of a campaign registration section and corresponds to a fifth compute service section.

When the certain period has elapsed (S25A), the queuing buffer section 13 activates the compute service function section 14 and passes the campaign information accumulated within the certain period to the compute service function section 14 (S26). When the compute service function section 14 interprets part of the content of the passed campaign information and activates the container application of the compute service processing section 15 capable of executing the appropriate process, the compute service function section passes the campaign information to the compute service processing section 15 (S27).

The compute service processing section 15 registers the campaign information in the database section 19 in order to associate the target vehicle included in the passed campaign information with the software package to be updated (S28). In addition, the compute service processing section 15 activates the compute service function section 20 and passes a notification indicating that the registration of the campaign information is completed to the API gateway section 11 (S30). The compute service processing section 15 is an example of a campaign registration section and corresponds to a fourth compute service section.

Next, the compute service processing section 15 stores the software package to be updated and the URL information for download in the file storage section 18 (S31). The compute service processing section 15 terminates the process and releases the resources such as the CPU and the memory occupied for performing the process (S32). The file storage section 18 operates as an origin server of the CDN distribution section 21 (S33). The compute service processing section 15 is an example of a package distribution section and corresponds to a third compute service section.

### <Data Access from Vehicle→Transmit Distribution Package from CDN to Vehicle>

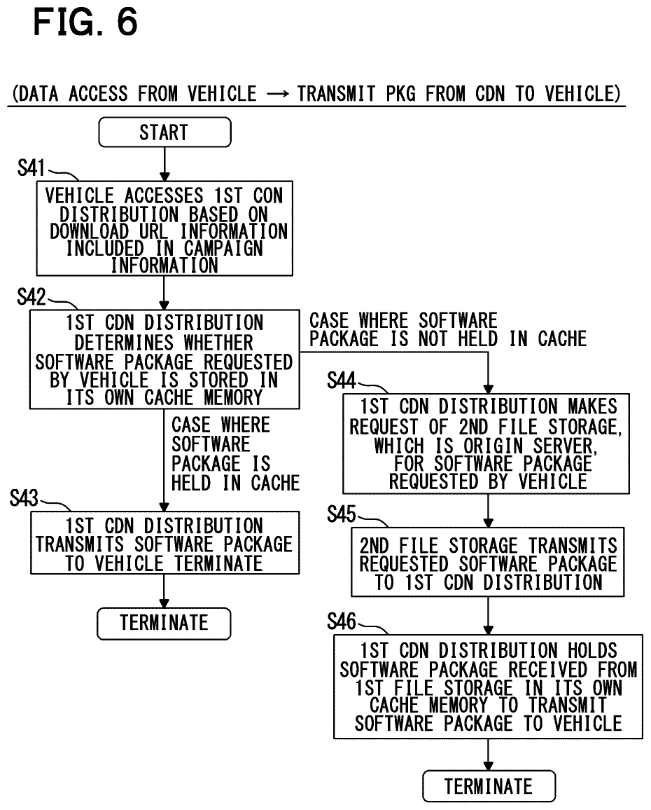

As illustrated in FIG. 6, in the vehicle 31, an OTA master including a data communication module (DCM) and a central ECU actually mounted on the vehicle 31 accesses the CDN distribution section 21 based on the download URL information included in the campaign information (S41). The CDN distribution section 21 determines whether the software package requested from the vehicle 31 is held in its own cache memory (S42). When the software package is held in the cache memory, the CDN distribution section 21 transmits the software package to the vehicle 31 (S43).

On the other hand, when the requested software package is not held in the cache memory, the CDN distribution section 21 makes a request of the file storage section 18 which is the origin server for the software package (S44). Then, the file storage section 18 transmits the requested software package to the CDN distribution section 21 (S45). The CDN distribution section 21 holds the software package received from the file storage section 18 in its own cache memory to transmit the software package to the vehicle 31 (S46).

### <Registration of Software Update Data>

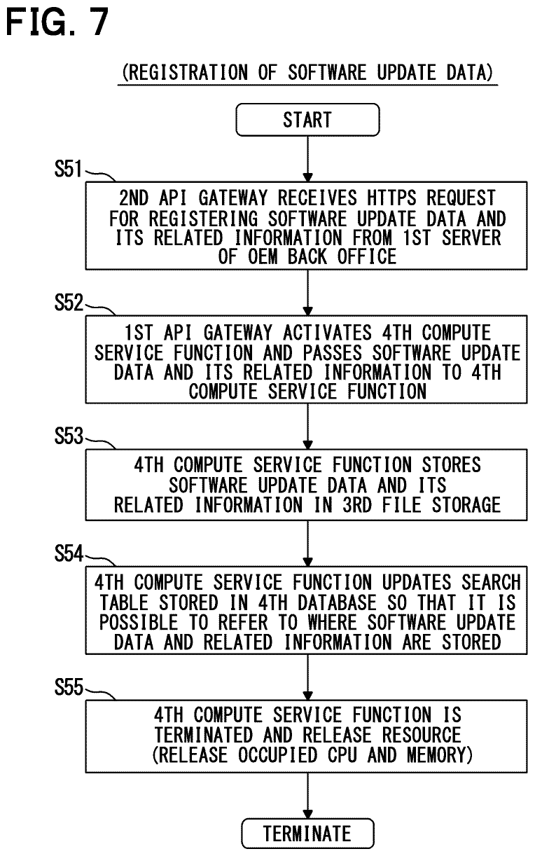

As illustrated in FIG. 7, the API gateway section 22 receives a request for registration of the software update data and its related information as an HTTPS request from the first server 6 of the OEM back office 4 (S51). The API gateway section 22 activates the compute service function section 24 and passes the software update data and the related information (S52). The compute service function section 24 stores the software update data and the related information in the file storage section 26 (S53).

The compute service function section 24 updates the search table stored in the database section 27 so that it is possible to refer to where the software update data and the related information are stored (S54). The compute service function section 24 terminates the process and releases the resources such as the CPU and the memory occupied for performing the process (S55).

### <Registration of Case Information→Generation of Package>

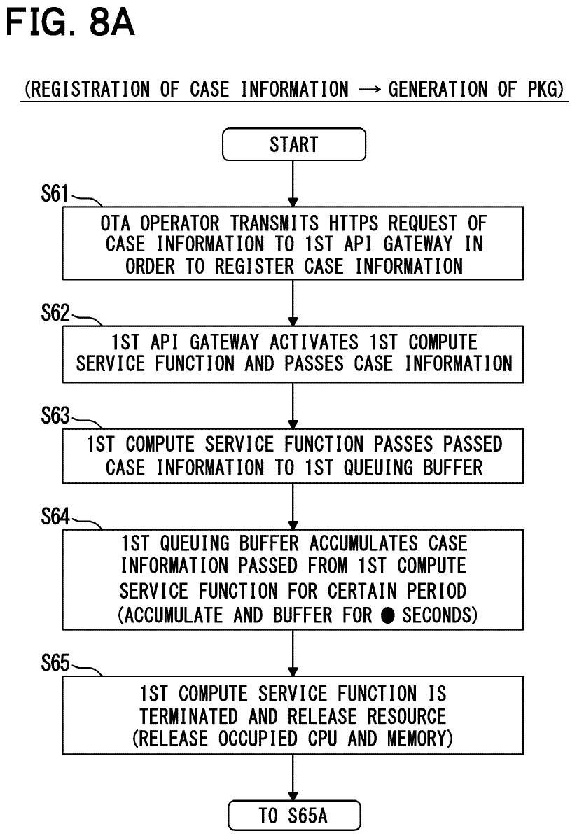

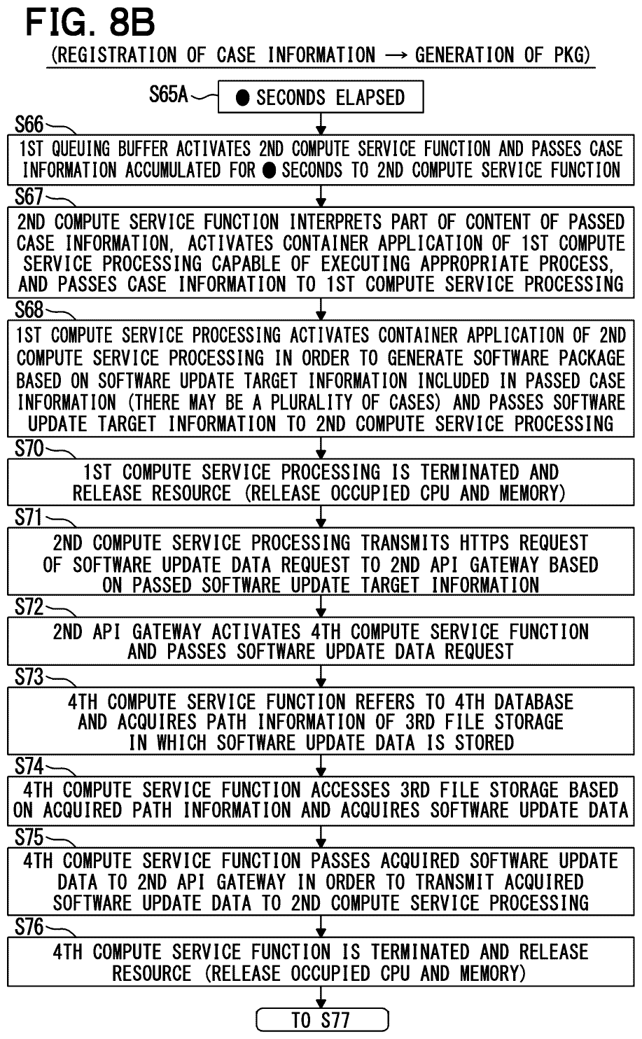

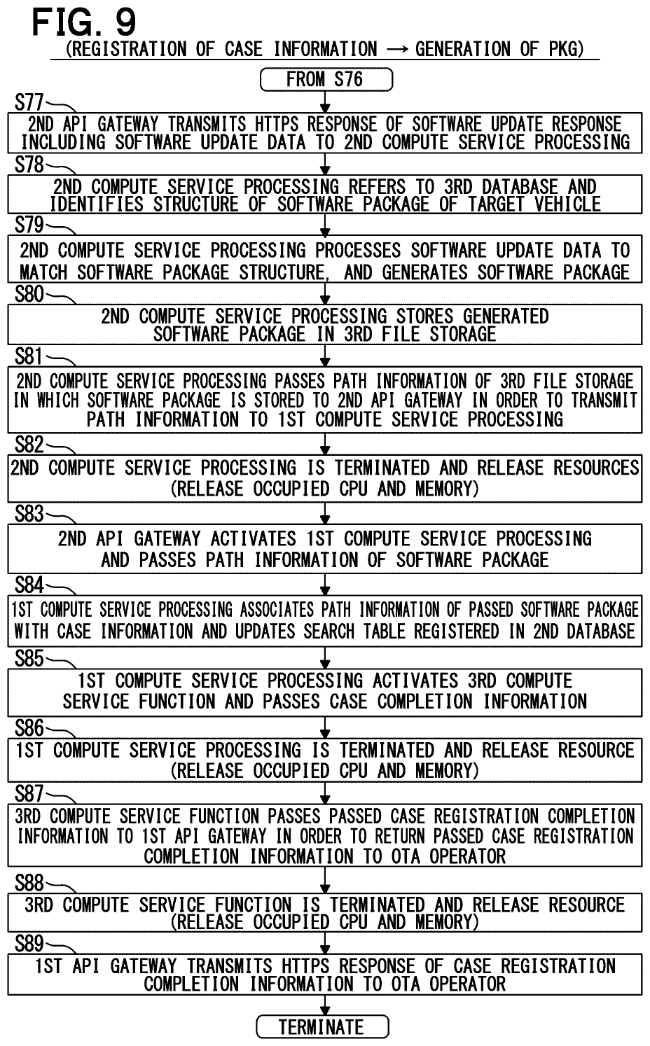

As illustrated in FIG. 8, in order to register the case information, the OTA operator 34 transmits an HTTPS request of the case information to the API gateway section 11 (S61). The case information is a collection of hardware information and software information of the ECU to which a certain distribution package is applicable. When activating the compute service function section 12, the API gateway section 11 passes the received case information to the function section 12 (S62).

The compute service function section 12 passes the case information to the queuing buffer section 13 (S63). The queuing buffer section 13 accumulates and buffers the passed case information for a certain period (S64). The compute service function section 12 terminates the process and releases the resources such as the CPU and the memory occupied for performing the process (S65). The compute service function section 12 may receive the TCP port number from the API gateway section 11 and store the TCP port number in the shared memory as necessary.

When the certain period has elapsed, the queuing buffer section 13 activates the compute service function section 14 and passes the case information accumulated within the certain period to the compute service function section 14 (S66). When the compute service function section 14 interprets part of the content of the passed case information and activates the container application of the compute service processing section 15 capable of executing the appropriate process, the compute service function section passes the case information to the compute service processing section 15 (S67).

The compute service processing section 15 accesses the database section 19, activates a container application of the compute service processing section 23 in order to generate a software package based on the software update target information included in the passed case information, and passes the software update target information to the compute service processing section 23 (S68). The compute service processing section 15 terminates the process and releases the resources such as the CPU and the memory occupied for performing the process (S70).

The compute service processing section 23 transmits an HTTPS request of a software update data request to the API gateway section 22 based on the passed software update target information (S71). The API gateway section 22 activates the compute service function section 24 and passes a software update data request (S72). The compute service function section 24 refers to a database section 27 and acquires the path information of the file storage section 26 in which the software update data is stored (S73).

The compute service function section 24 accesses the file storage section 26 based on the acquired path information and acquires software update data (S74). In order to transmit the acquired software update data to the compute service processing section 23, the acquired software update data is passed to the API gateway section 22 (S75). The compute service function section 24 terminates the process and releases the resources such as the CPU and the memory occupied for performing the process (S76). The compute service function section 24 is an example of a data management section.

The API gateway section 22 transmits an HTTPS response of a software update response including the software update data to the compute service processing section 23 (S77). The compute service processing section 23 refers to a database section 25 and identifies the structure of the software package of the target vehicle (S78). The software update data is processed to match the structure of the identified software package to generate a software package (S79). The compute service processing section 23 stores the generated software package in the file storage section 26 (S80). The compute service processing section 23 is an example of a package generation section.

The compute service processing section 23 passes the path information of the file storage section 26 in which the software package is stored to the API gateway section 22 in order to transmit the path information to the compute service processing section 15 (S81). The compute service processing section 23 terminates the process and releases the resources such as the CPU and the memory occupied for performing the process (S82).

The API gateway section 22 activates the compute service processing section 15 and passes the path information of the software package (S83). The compute service processing section 15 associates the passed path information of the software package with the case information, and updates the search table registered in the database section 19 (S84). The compute service processing section 15 activates the compute service function section 20 and passes the case registration completion information (S85). The compute service processing section 15 terminates the process and releases the resources such as the CPU and the memory occupied for performing the process (S86).

The compute service function section 20 passes the passed case registration completion information to the API gateway section 11 in order to return the case registration completion information to the OTA operator 34 (S87). The compute service function section 20 terminates the process and releases the resources such as the CPU and the memory occupied for performing the process (S88). The API gateway section 11 transmits an HTTPS response of the case registration completion information to the OTA operator 34 (S89).

In the above process, the compute service function section 20 may acquire the TCP port number stored by the compute service function section 12 from the shared memory as necessary, and request the API gateway section 11 to distribute the HTTPS response for the TCP port number.

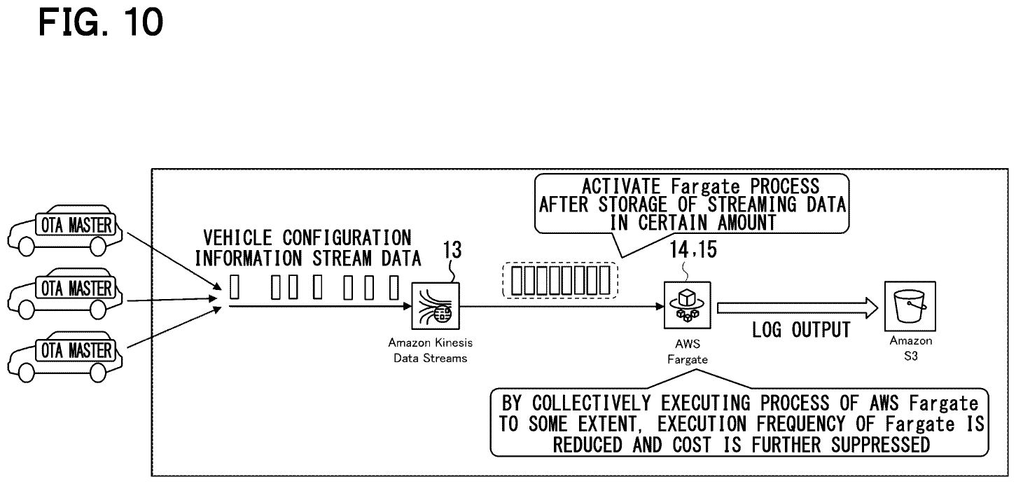

Next, effects of the present embodiment will be described. As illustrated in FIG. 10, the queuing buffer section 13 accumulates a certain amount of stream data of the vehicle configuration information transmitted from each vehicle 31 and then passes the stream data to the next-stage compute service function section 14 and compute service processing section 15. Assuming that the above functions are implemented by AWS Fargate, the consumption of the computing resource can be saved by reducing the execution frequency of the process.

Although FIG. 10 illustrates an example in which the vehicle configuration information transmitted from each vehicle 31 is buffered, when the OTA operator 34 performs campaign registration or case information registration, similarly, the queuing buffer section 13 accumulates a certain amount of information and then passes the information to the next-hop compute service function section 14 and compute service processing section 15.

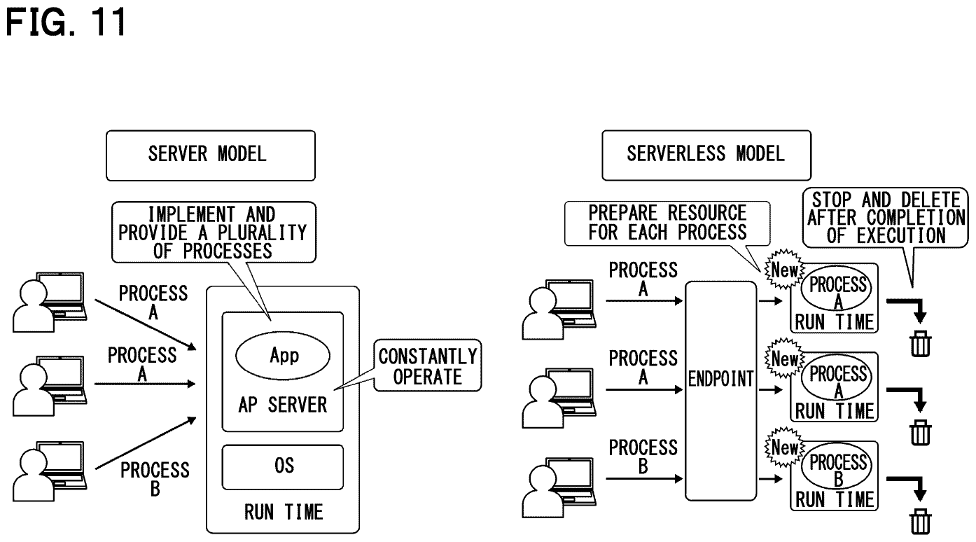

In addition, as illustrated in FIG. 11, in the conventional server model, an application program and a server constantly operate in a state of occupying resources, and one server executes a plurality of processes. On the other hand, in the model employing the serverless architecture as in the present embodiment, the corresponding application program being activated when a request for each process occurs, and the execution of the program is stopped and deleted when the process is terminated. Therefore, at this point, the resource used for the process is released.

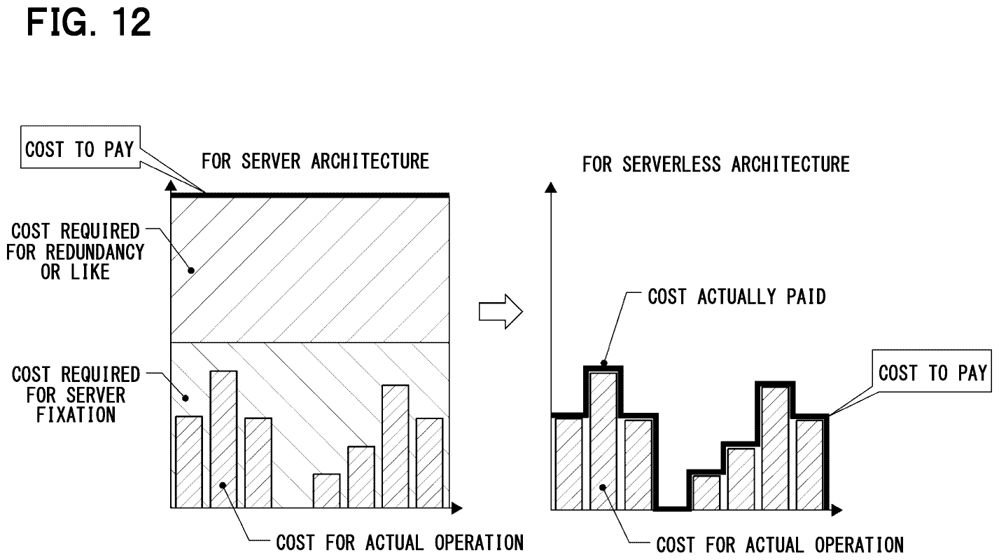

As a result, as illustrated in FIG. 12, in the conventional server model, a fixed cost associated with operating the server constantly is extra compared to an actual operating cost. In addition, when the server is made redundant in advance, the cost is further increased. On the other hand, when the serverless architecture is used as in the present embodiment, only the cost of substantially actual operation is borne, so that the running cost required for the infrastructure can be greatly reduced.

As described above, according to the present embodiment, the OTA center 1 manages data to be written to a plurality of ECUs mounted on the vehicle 31, and executes, by the application program, a plurality of functions for transmitting update data to the vehicle 31 by wireless communication. At this time, a serverless architecture is used in which an application program that implements at least some functions being activated in response to occurrence of an event, a resource being dynamically allocated for execution of a code of the application program by an on-demand method, and the resource allocated to the application program is released when the execution of the code is completed.

In the program employing the serverless architecture, the resource being dynamically allocated and the program being activated every time access from the vehicle 31 occurs, and the resource is released when the execution of the code is completed. Therefore, as compared with a case of employing a server architecture executed as a resident type process, consumption of computing resources of the infrastructure can be saved, and as a result, running costs for the infrastructure can be reduced.

### Second Embodiment

Hereinafter, the parts equal to those in the first embodiment will be denoted by the equal reference numerals, description thereof will be omitted, and different parts will be described. Assuming that communication between the vehicle 31 and the OTA center 1 is performed by a transmission control protocol (TCP), which is connection-type communication, it is necessary to perform connection management between transmission and reception.

First, when a connection is established, the following handshake process is required:
a TCP packet in which a SYN (connection establishment request) flag is enabled is transmitted as an establishment request from the transmission side;
the reception side transmits an ACK (Acknowledge) in response to this, and simultaneously the SYN flag of the TCP header as a connection establishment request from the reception side after enabling; and
the transmission side transmits an ACK packet for SYN from the reception side.

When disconnecting the connection, the following handshake process is required:
the transmitting side first transmits FIN (connection end request);
the reception side transmits an ACK and subsequently transmits a FIN; and
after receiving FIN and transmitting the last ACK, the transmission side waits for a certain period of time and ends the connection.

In the configuration of the first embodiment, in consideration of performing the connection management described above, it is necessary to constantly link the compute service function sections 12 and 20 illustrated in FIG. 1. In addition, since the compute service function sections 12 and 20 need to operate the processes until the processes at the subsequent stages are completed and a response is returned, it is not possible to receive the maximum benefit of employing the serverless architecture.

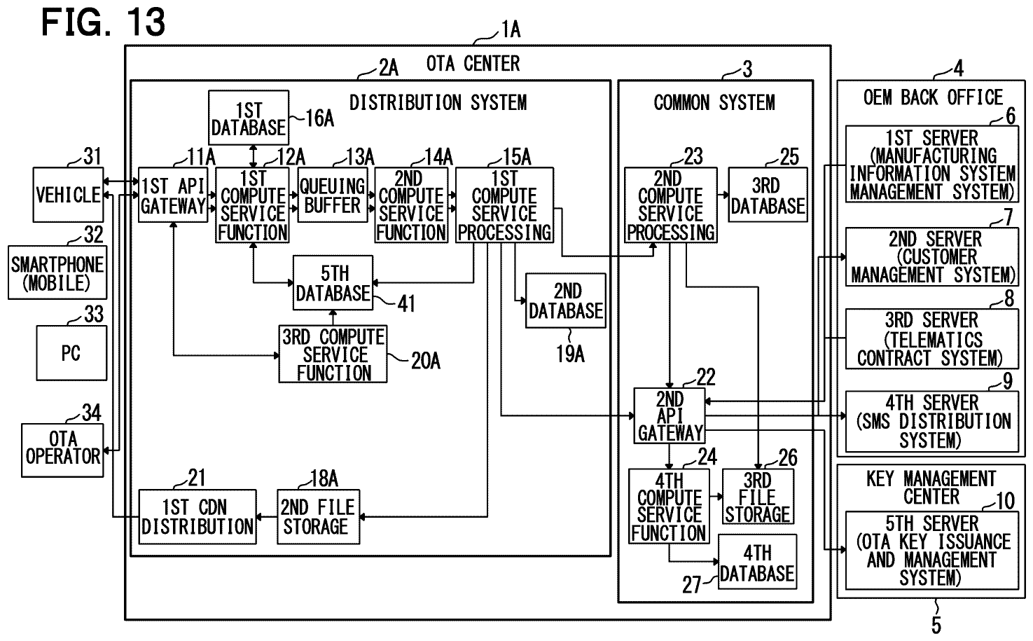

Therefore, as illustrated in FIG. 13, in an OTA center 1A according to the second embodiment, a database section 41 is disposed between a compute service function section 12A and a compute service processing section 15A in a distribution system 2A. A compute service function section 20A can access the database section 41. In the above description, the compute service function sections 12A and 20A and the database section 41 are an example of a status management section.

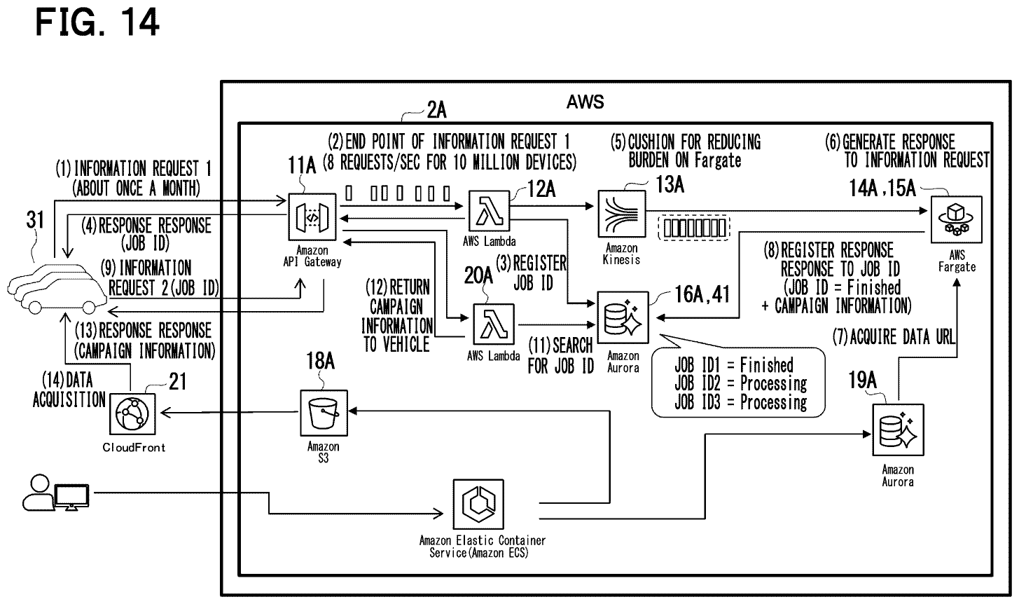

FIG. 14 is an example of a case where the configuration illustrated in FIG. 13 is configured using the AWS cloud. Amazon Aurora corresponding to the database sections 16A and 41 is disposed between AWS Lambda corresponding to the compute service function section 12A and AWS Fargate corresponding to the compute service processing section 15A, and Amazon Aurora manages the job ID.

Next, the operation of the second embodiment will be described.

### <Reception of Vehicle Configuration Information→Transmission of Job ID and Transmission of Campaign Information>

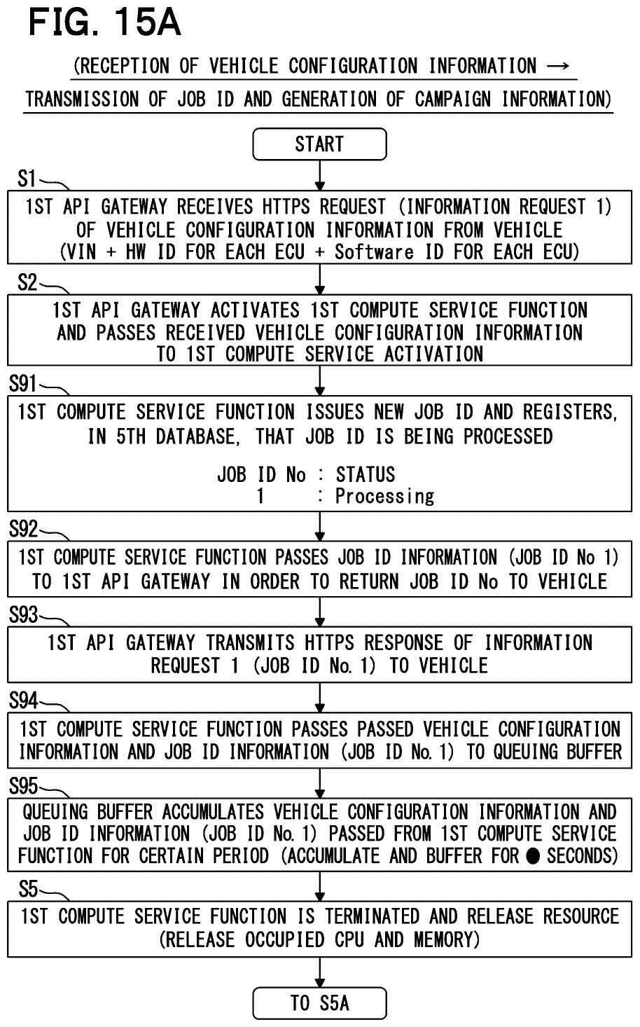

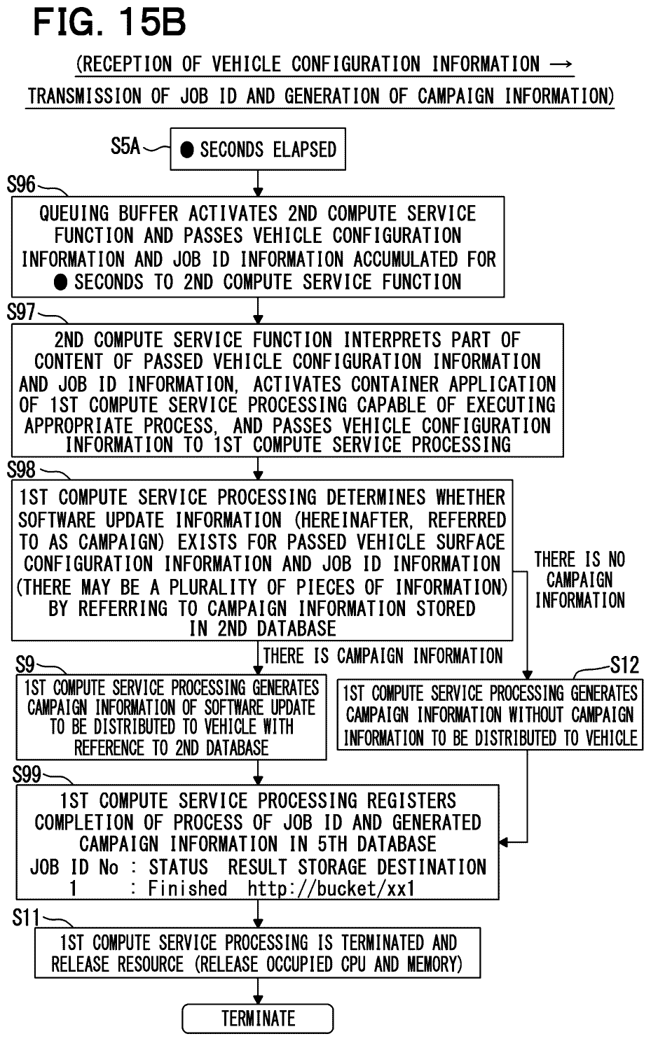

As illustrated in FIG. 15, first, steps S1 and S2 are executed, and the request in step S1 is an “information request 1”. This request is assumed to be transmitted from one vehicle 31, for example, every two weeks or about once a month. Assuming that there is an information request 1 at a frequency of once a month from one vehicle 31, about 8 requests are transmitted per second from 10 million vehicles 31.

Subsequently, the compute service function section 12A issues a new job ID, and registers the fact that the job ID is in Processing in the database section 41 (S91). The job ID is issued for each piece of information request 1. In order to return the job ID to the vehicle 31 that is an outside of the OTA center 1A, the job ID information is passed to an API gateway section 11A. The job ID information is, for example, “Job ID No.=1” (S92). Then, the API gateway section 11A transmits an HTTPS response to the information request of the job ID information to the vehicle 31 (S93).

The compute service function section 12A passes the vehicle configuration information received from the vehicle 31 and the job ID information to the queuing buffer section 13A (S94). The queuing buffer section 13A accumulates and buffers the passed vehicle configuration information and job ID information for a certain period, for example, several seconds (S95).

When steps S5 and S5A are executed, a queuing buffer section 13A activates a compute service function section 14A and passes the vehicle configuration information and the job ID information accumulated within a certain period to the compute service function section 14A (S96). When the compute service function section 14A interprets part of the content of the passed vehicle configuration information and job ID information and activates the container application of the compute service processing section 15A capable of executing the appropriate process, the compute service function section passes the vehicle configuration information and the job ID information to the compute service processing section 15A (S97).

The compute service processing section 15A accesses a database section 19A and determines whether there is campaign information corresponding to the passed vehicle configuration information and job ID information (S98). Steps S9 and S12 are executed according to the presence or absence of the campaign information. In subsequent step S99, the compute service processing section 15A registers the fact that the process of the job ID is Finished and the generated campaign information in the database section 41. Then, when step S11 is executed, the process is terminated.

### <Reception of Campaign Information Request→Check of Generation Status of Campaign Information and Transmission of Campaign Information>

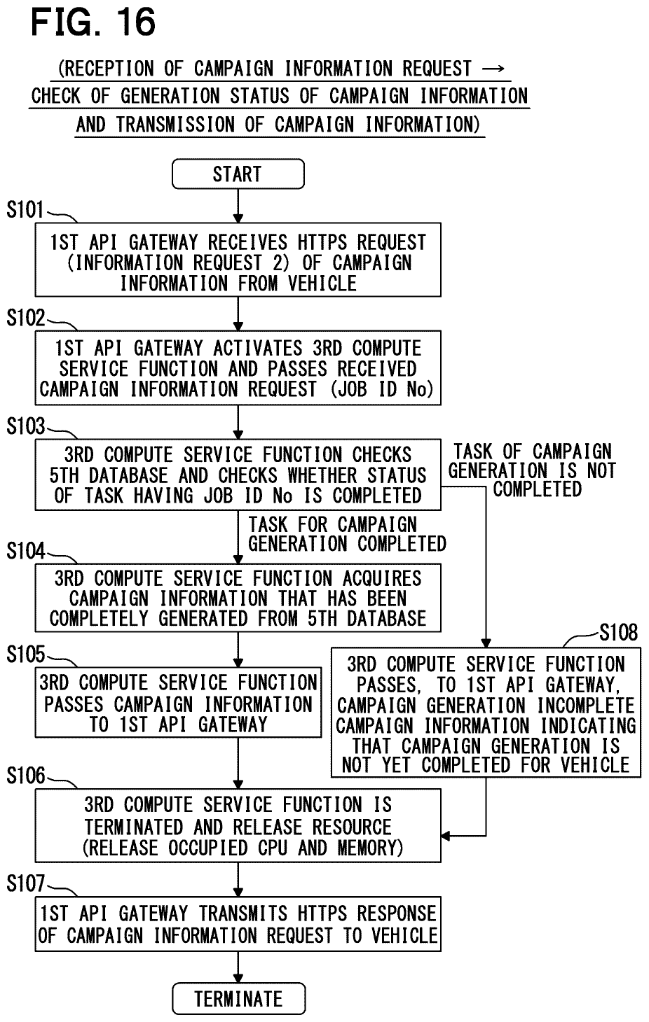

As illustrated in FIG. 16, when receiving an HTTPS request (information request 2) of the campaign information from the vehicle 31 (S101), the API gateway section 11A activates the compute service function section 20A to pass the received campaign information request (S102). The request includes a job ID number. The compute service function section 20A checks the database section 41 and checks whether the status of the generation task of the job ID number is completed (S103).

When the campaign generation task has been completed, the compute service function section 20A acquires the generated campaign information from the database section 41 (S104) and passes the acquired campaign information to the API gateway section 11 (S105). The compute service function section 20A terminates the process and releases the occupied resources such as the CPU and the memory (S106). The API gateway section 11 transmits an HTTPS response of the campaign information request to the vehicle 31 (S107).

On the other hand, when the task of campaign generation is incomplete, the compute service function section 20A passes the campaign information indicating that the generation of the campaign information is incomplete to the API gateway section 11A (S108), and then the process proceeds to step S106.

### <Registration of Campaign Information (Information Request 1)→Registration of Distribution Package to CDN Distribution Section 21>

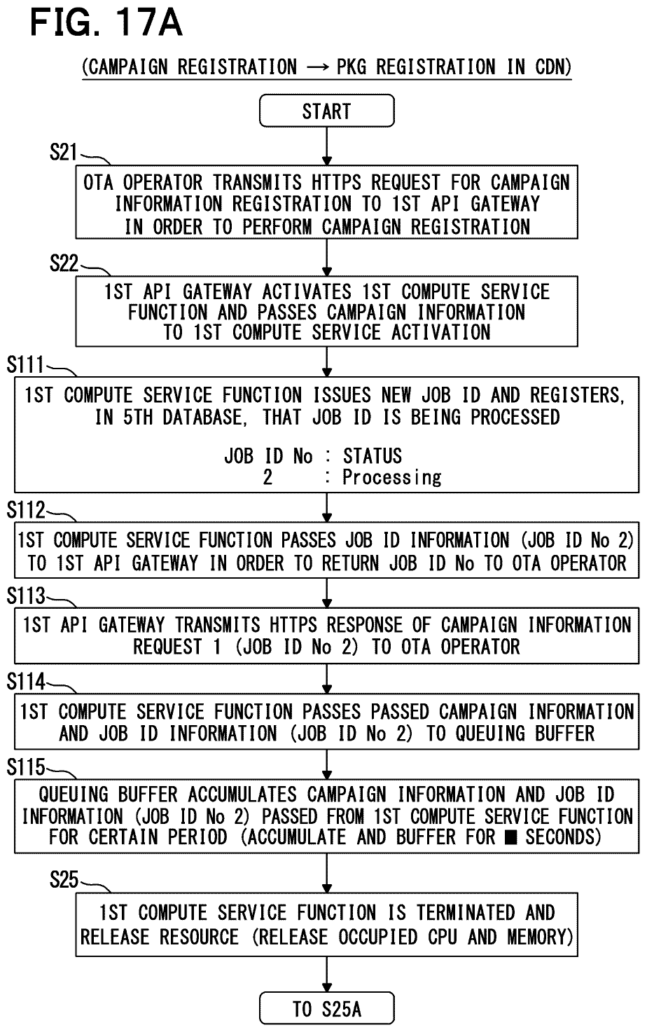

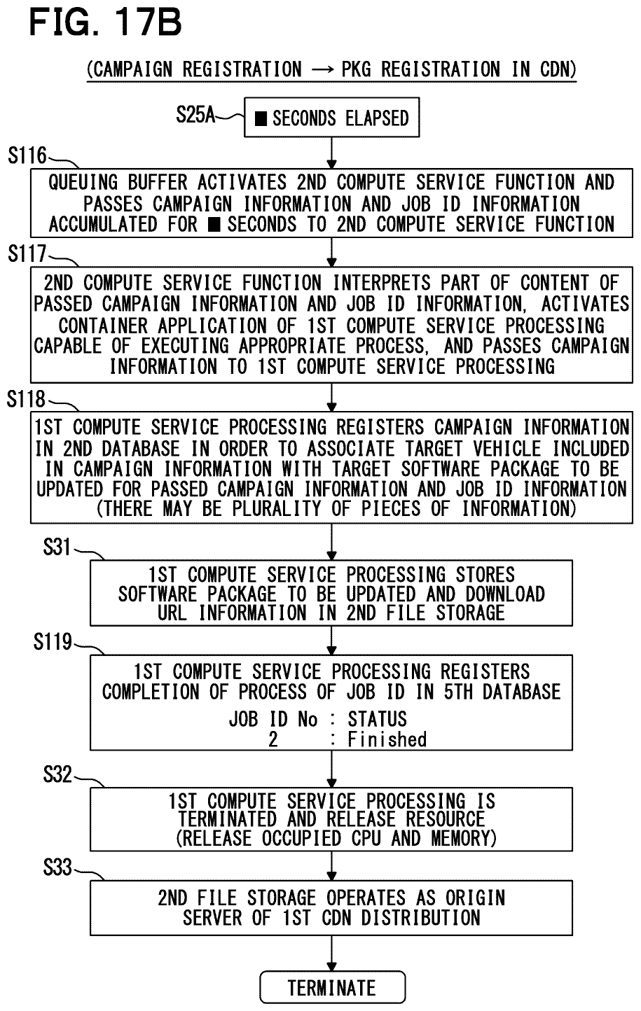

As illustrated in FIG. 17, when steps S21 and S22 are executed (information request 1), the compute service function section 12A issues a new job ID, and registers the fact that the job ID is in processing in the database section 41 (S111). Subsequently, in order to return the job ID number to the OTA operator 34, the job ID information is passed to an API gateway section 11A (S112).

The API gateway section 11A transmits an HTTPS response of the campaign information request to the OTA operator 34 (S113). The compute service function section 12A passes the passed campaign information and job ID information to the queuing buffer section 13A (S114). The queuing buffer section 13A accumulates and buffers the passed campaign information and job ID information for a certain period (S115). Then, steps S25 and S25A are executed.

The queuing buffer section 13A activates the compute service function section 14A and passes the campaign information accumulated within a certain period and the job ID information to the compute service function section 14A (S116). When the compute service function section 14A interprets part of the content of the passed campaign information and job ID information and activates the container application of the compute service processing section 15A capable of executing the appropriate process, the compute service function section passes the campaign information to the compute service processing section 15A (S117).

The compute service processing section 15A registers the campaign information in the database section 19A in order to associate the target vehicle included in the passed campaign information and job ID information with the software package to be updated (S118). Next, the compute service processing section 15A executes steps S31, S119, S32, and S33. In step S119, the compute service processing section 15A registers completion of the process of the job ID in the database section 41.

### <Registration of Campaign Information (Information Request 2)→Registration of Distribution Package to CDN Distribution Section 21>

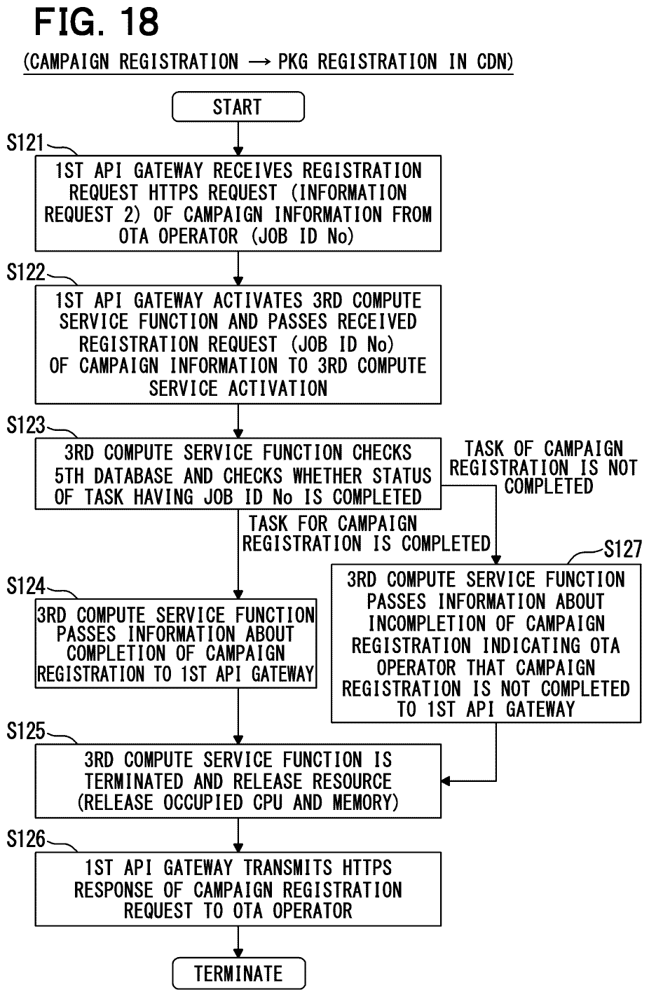

As illustrated in FIG. 18, when receiving the HTTPS request for campaign information registration from the OTA operator 34 (S121), the API gateway section 11A activates the compute service function section 20A and passes the received registration request (the information request 2) (S122). The compute service function section 20A checks the database section 41 and checks whether the status of the registration task of the job ID number is completed (S123).

When the campaign registration task has been completed, the compute service function section 20A passes information indicating registration completion to the API gateway section 11A (S124). The compute service function section 20A terminates the process and releases the occupied resources such as the CPU and the memory (S125). The API gateway section 11Atransmits an HTTPS response of the campaign information registration request to the OTA operator 34 (S126).

On the other hand, when the task of campaign registration is incomplete, the compute service function section 20A passes the campaign information indicating that the registration of the campaign information is incomplete to the API gateway section 11A (S127), and then the process proceeds to step S125.

### <Case Information (Information Request 1)→Generation of Package>

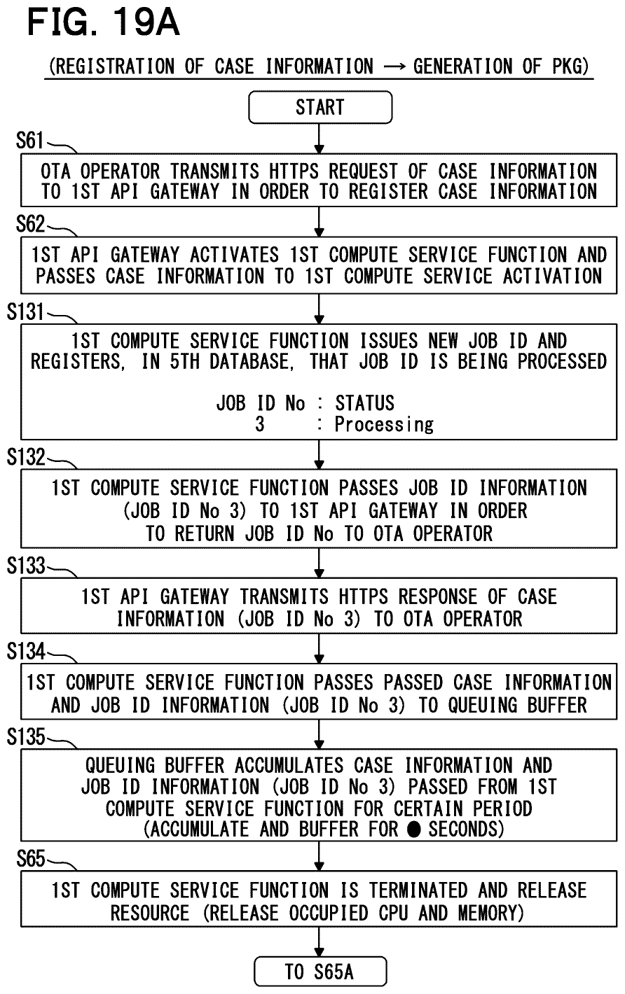

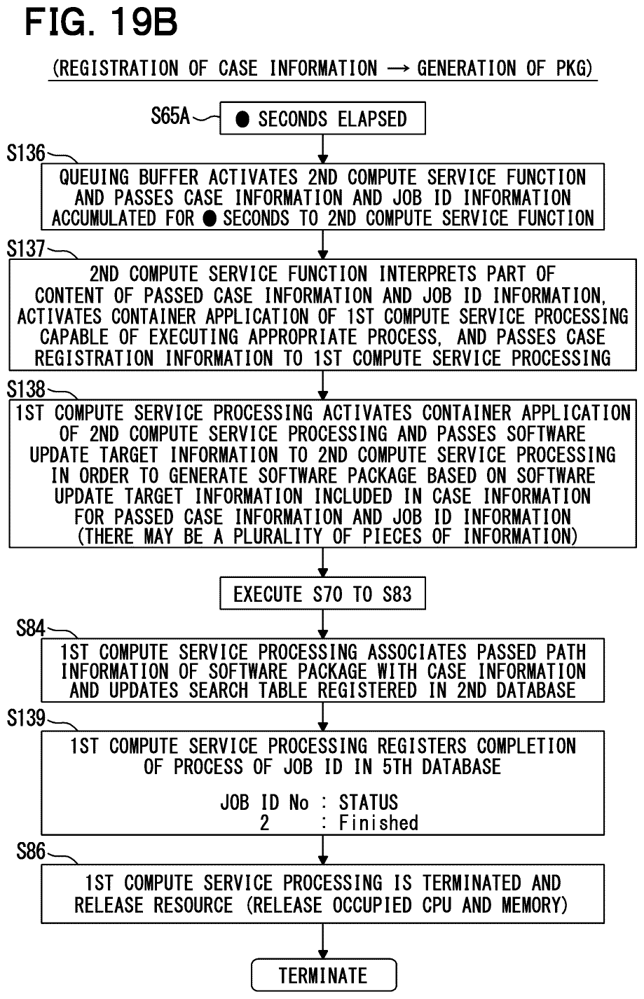

As illustrated in FIG. 19, when steps S61 and S62 are executed (information request 1), the compute service function section 12 issues a new job ID, and registers the fact that the job ID is in processing in the database section 41 (S131). In order to return the job ID to the OTA operator 34, the job ID information is passed to the API gateway section 11 (S132). Then, the API gateway section 11 transmits an HTTPS response to the information request of the case information to the OTA operator 34 (S133).

The compute service function section 12A passes the passed case information and job ID information to the queuing buffer section 13A (S134). The queuing buffer section 13A accumulates and buffers the passed case information and job ID information for a certain period, for example, several seconds (S135).

When steps S65 and S65A are executed, the queuing buffer section 13A activates the compute service function section 14A and passes the case information and the job ID information accumulated within a certain period to the compute service function section 14A (S136). When the compute service function section 14A interprets part of the content of the passed case information and job ID information and activates the container application of the compute service processing section 15A capable of executing the appropriate process, the compute service function section passes the case information and the job ID information to the compute service processing section 15A (S137).

In order to generate a software package based on the software update information included in the passed case information, the compute service processing section 15A activates the container application of the compute service processing section 23 and passes the software update target information to the compute service processing section 23 (S138).

Thereafter, steps S70 to S86 are executed, but step S139 is executed instead of step S85. In step S139, the compute service processing section 15A registers completion of the process of the job ID in the database section 41.

### <Case Information (Information Request 2)→Generation of Package>

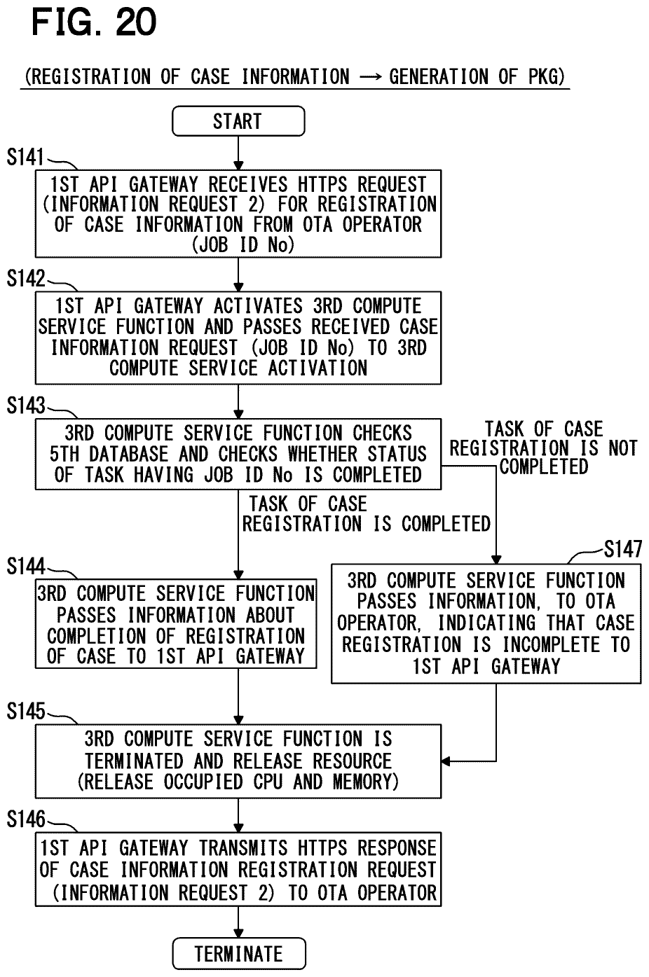

As illustrated in FIG. 20, when receiving an HTTPS request (information request 2) for registration of case information from the OTA operator 34 (S141), the API gateway section 11A activates the compute service function section 20A and passes the received request for registration of the case information (S142). The compute service function section 20A checks the database section 41 and checks whether the status of the task having the job ID number attached to the request is completed (S143).

When the task of registration of the case information has been completed, when the compute service function section 20A passes information indicating completion of registration of the case information to the API gateway section 11A (S144), then the compute service function section terminates the process and releases the occupied resources (S145). Then, the API gateway section 11A transmits an HTTPS response of the case information registration request to the OTA operator 34 (S146). On the other hand, when the task of registration of the case information is incomplete, the compute service function section 20A passes information indicating that the case information registration is incomplete, the information being to be transmitted to the OTA operator 34, to the API gateway section 11 (S147), and then the process proceeds to step S145.

As described above, according to the second embodiment, the compute service function sections 12A and 20A and the database section 41 assign the job ID information to the request received from the vehicle 31, manage the status indicating whether the process corresponding to the request is in progressing or completed, and return a response to the processed request to the vehicle 31. As a result, it is not necessary for the compute service function sections 12A and 20A to be continuously activated until the process corresponding to the request is completed, so that it is possible to enjoy more advantages obtained by employing the serverless architecture.

### Third Embodiment

In the configuration of the second embodiment, since the communication traffic between the vehicle 31 and the API gateway section 11 of the OTA center 1A increases, there is a concern about an increase in the burden of the communication fee. Furthermore, in this configuration, when there is a design error or the like on the vehicle 31 side or the OTA center 1A side, communication retry from the vehicle 31 occurs in an infinite loop, and the OTA center 1A may fall into an overload state.

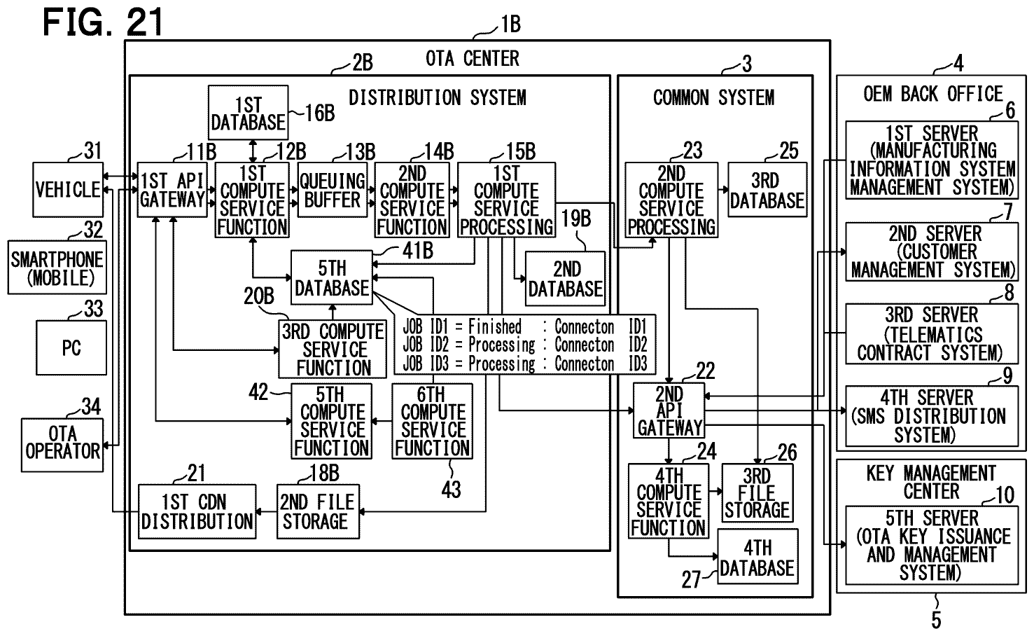

Therefore, as illustrated in FIG. 21, in an OTA center 1B of the third embodiment, compute service function sections 42 and 43 are added to the configuration of the second embodiment. The compute service function section 43 accesses the compute service function section 42 and a database section 41B, and the compute service function section 42 accesses an API gateway section 11B. In the database section 41B, the connection ID number is managed together with the job ID number and the status. A compute service function section 20B is an example of a distribution destination management section.

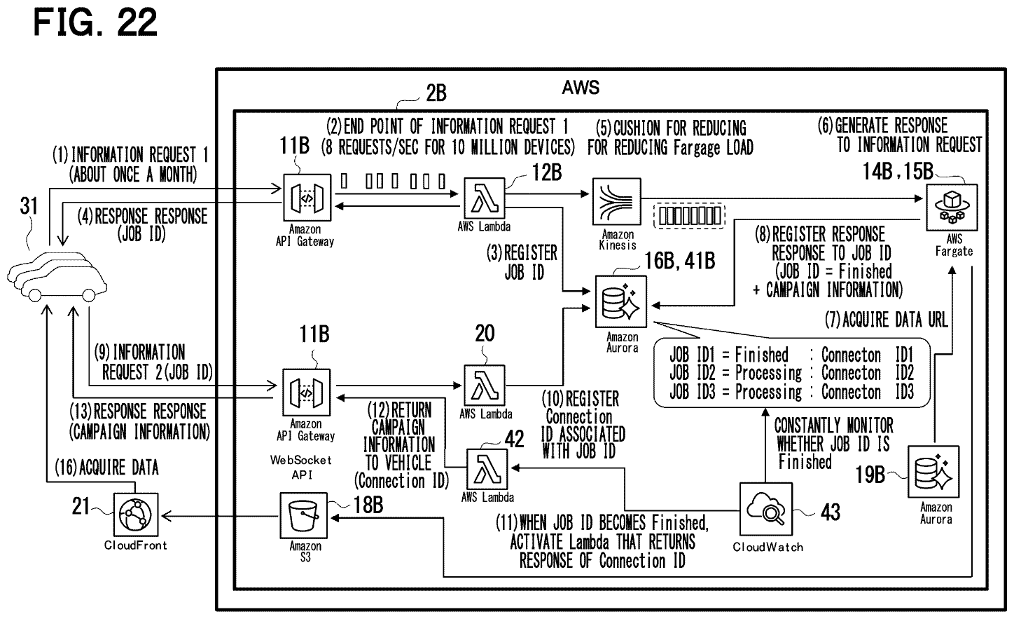

FIG. 22 is an example in which the configuration illustrated in FIG. 21 is configured using the AWS service.

Amazon API Gateway corresponds to the API gateway section 11B.

AWS Lambda corresponds to the compute service function sections 12B, 20B, and 42.

AWS Fargate corresponds to the compute service processing sections 14B and 15B.

Amazon Aurora corresponds to the database sections 19B, 25, and 27.

CloudWatch corresponds to the compute service function section 43.

Next, the operation of the third embodiment will be described.

### <Reception of Vehicle Configuration Information→Transmission of Job ID and Transmission of Campaign Information>

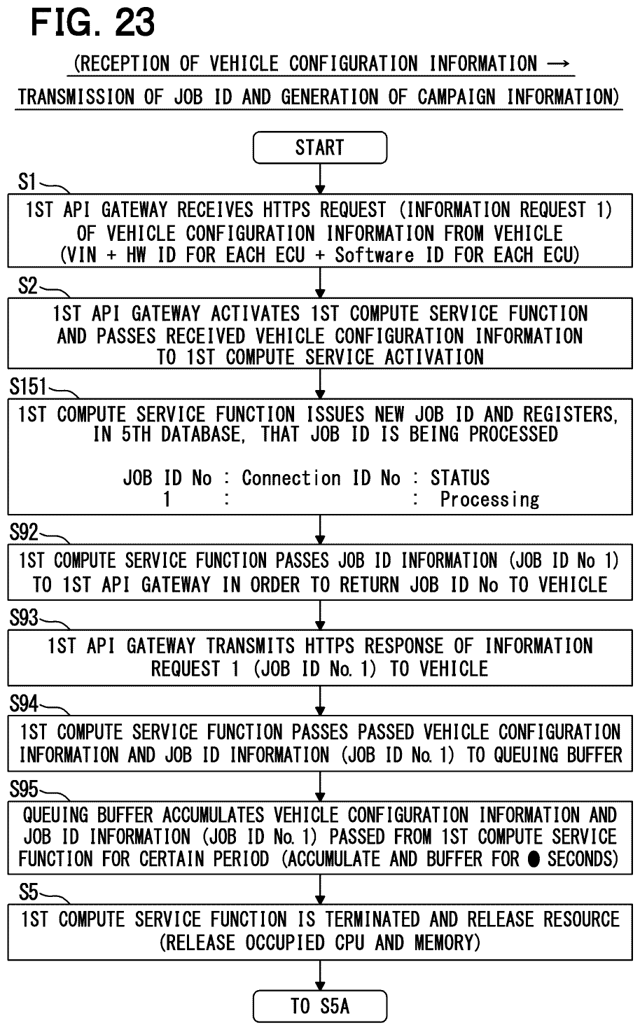

As illustrated in FIG. 23, when steps S1 and S2 are executed, the compute service function section 12B issues a new job ID, and registers the fact that the job ID is in processing and the connection ID number in the database section 41B (S151). Thereafter, steps S92 to S11 are executed as in the second embodiment. The connection ID number is a so-called TCP port number. The API gateway section 11B does not stores the job ID, but stores a connection ID number that is a TCP port number when communication with the vehicle 31 is performed.

### <Reception of Campaign Information Request→Check of Generation Status of Campaign Information and Transmission of Campaign Information>

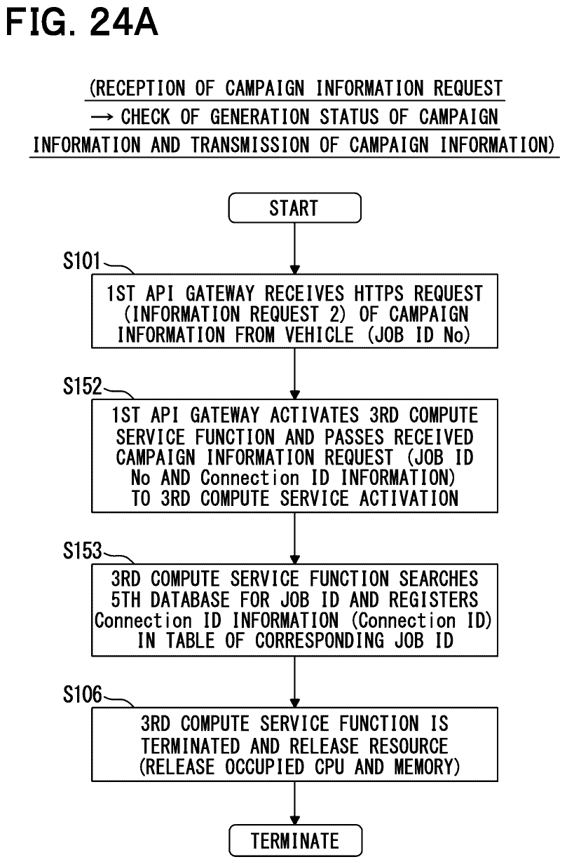

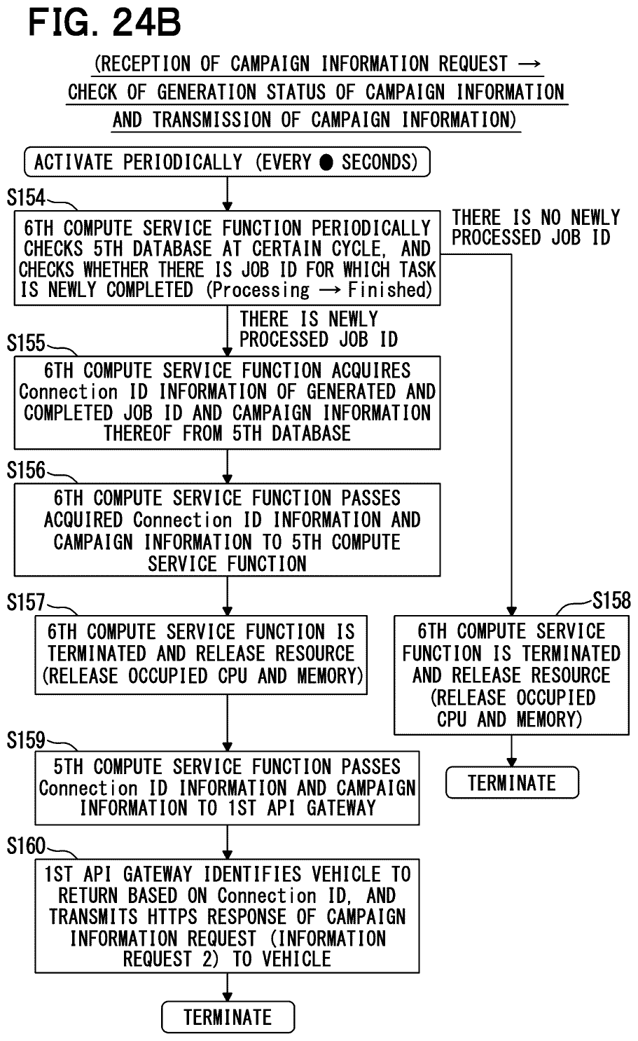

As illustrated in FIG. 24, when executing step S101, the API gateway section 11B activates the compute service function section 20B and passes the received campaign information request (S152). The request includes connection ID information together with the job ID number. The compute service function section 20B searches the database section 41B by the job ID number, and registers the connection information in the table of the corresponding job ID number (S153). Then, step S106 is executed.

The process of steps S154 to S160 is activated periodically, for example, every several seconds. The compute service function section 43 periodically checks the database section 41B at a certain cycle, and checks whether there is a job ID number of a newly task-completed job (S154). When there is a job ID number of a task-completed job, the compute service function section 43 acquires connection ID information and campaign information of the job ID number from the database section 41B (S155). When passing the acquired connection ID information and campaign information to the compute service function section 42 (S156), the compute service function section 43 terminates the process and releases the occupied resource (S157).

Subsequently, the compute service function section 42 passes the connection ID information and the campaign information to the API gateway section 11B (S159). The API gateway section 11B identifies the vehicle 31 to which information is to be returned based on the connection ID information to transmit an HTTPS response to the campaign information request to the vehicle 31 (S160). On the other hand, in a case where there is no job ID number of a task-completed job in step S154, the process similar to that in step S157 is performed (S158), and then the process is terminated.

### <Registration of Campaign Information (Information Request 2)→Registration of Distribution Package to CDN Distribution Section 21>

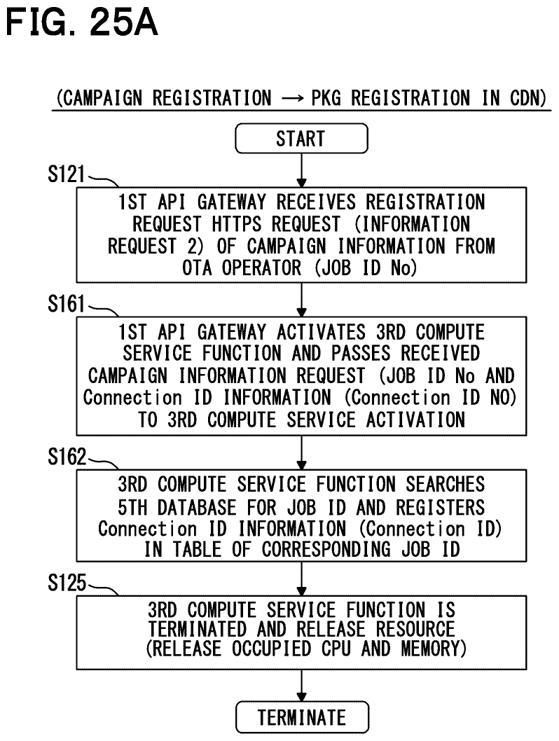

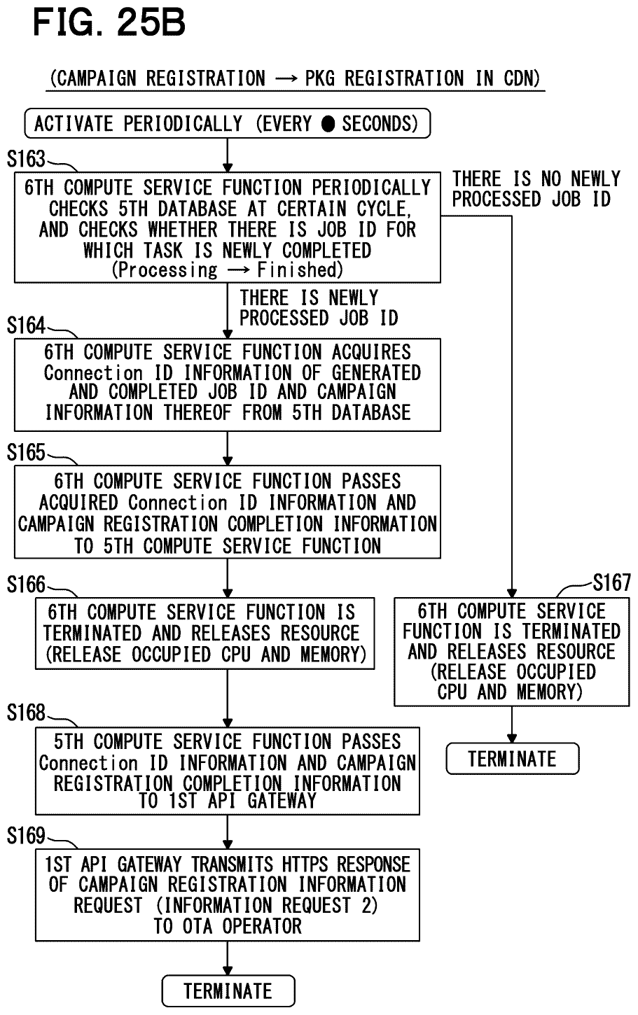

For the information request 1, steps S21 to S33 are executed as in the second embodiment. In step S91, the compute service function section 12A issues a new job ID, and registers the fact that the job ID is in Processing and the connection ID number in the database section 41. Then, as illustrated in FIG. 25, when executing step S121, the API gateway section 11B executes the process similar to that of steps S152 and S153 (S161, S162), and then executes step S125. The process of steps S163 to S169 is similar to the process of steps S154 to S160, but the transmission destination of the response in step S169 is the OTA operator 34.

### <Data Access from Vehicle→Transmit Distribution Package from CDN to Vehicle>

### <Registration of Software Update Data>

These processes are similar to those in the first embodiment.

### <Registration of Case Information and Generation of Package>

This process is similar to that of the second embodiment.

### <Reception of Registration Request of Case Information→Check of Registration Status of Case Information and Transmission of Case Registration Information (Result)>

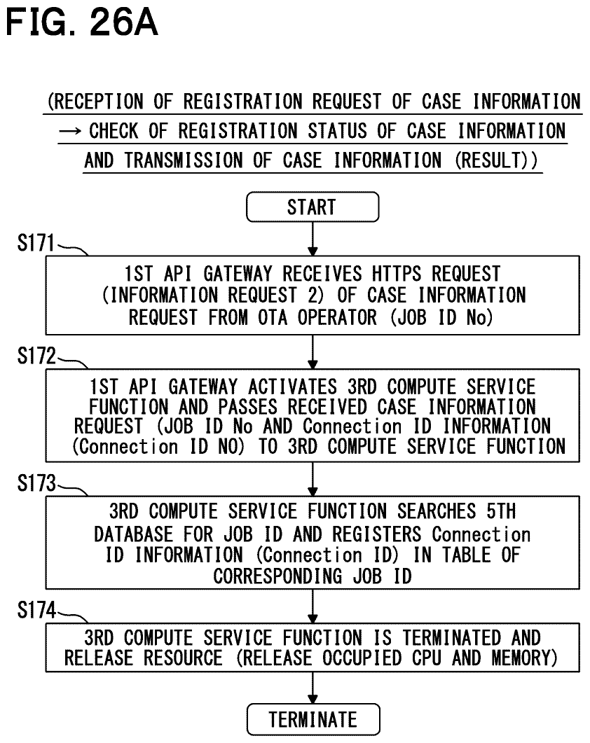

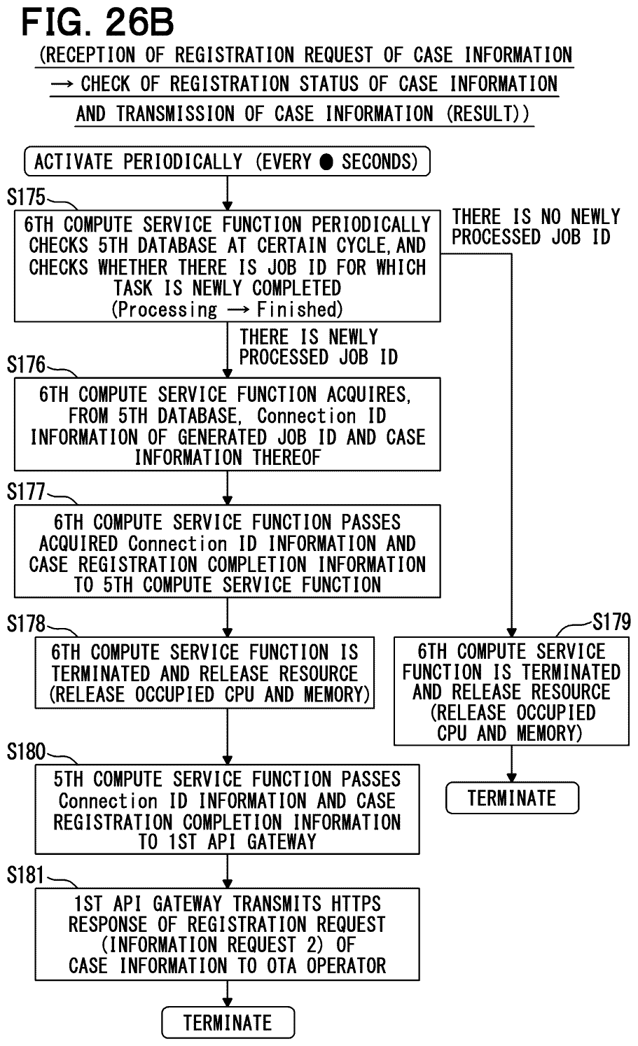

As illustrated in FIG. 26, the process of steps S171 and S172 is similar to that of steps S141 and S142, but the information to be passed to the compute service function section 20B includes connection ID information. In the process of steps S173 to S181, the process of steps S153 to S160 illustrated in FIG. 24 is performed for the case information instead of the campaign information.

As described above, according to the third embodiment, when receiving a request to which a job number is assigned from the vehicle 31 or the OTA operator 34, the compute service function section 20B assigns a connection number associated with the job number and registers the request in the database section 41B, and when there is a request for which process has been completed by referring to the database section 41, the compute service function sections 42 and 43 identify the vehicle 31 or the OTA operator 34 as a transmission destination of a response based on the connection number corresponding to the job number of the request to transmit the response to the identified vehicle 31 or OTA operator 34 via the API gateway section 11B. As a result, since the vehicle 31 or the OTA operator 34 checks with the API gateway section 11B whether the process of the job number is completed, a process of repeatedly transmitting a request is not necessary, and the communication occurring in the second embodiment can be reduced, so that the amount of communication traffic between the vehicle 31 or the OTA operator 34 and the API gateway section 11B can be reduced.

### Fourth Embodiment

Regarding the configuration of the third embodiment, it is assumed that the processing load of AWS Fargate corresponding to the compute service processing section 15B disposed at the subsequent stage of the queuing buffer section 13B is adjusted by autoscaling. In this case, normally, using a target tracking scaling policy or the like of an elastic container service (ECS), the number of tasks or the like is controlled by using a CloudWatch metrics and an alarm in the ECS.

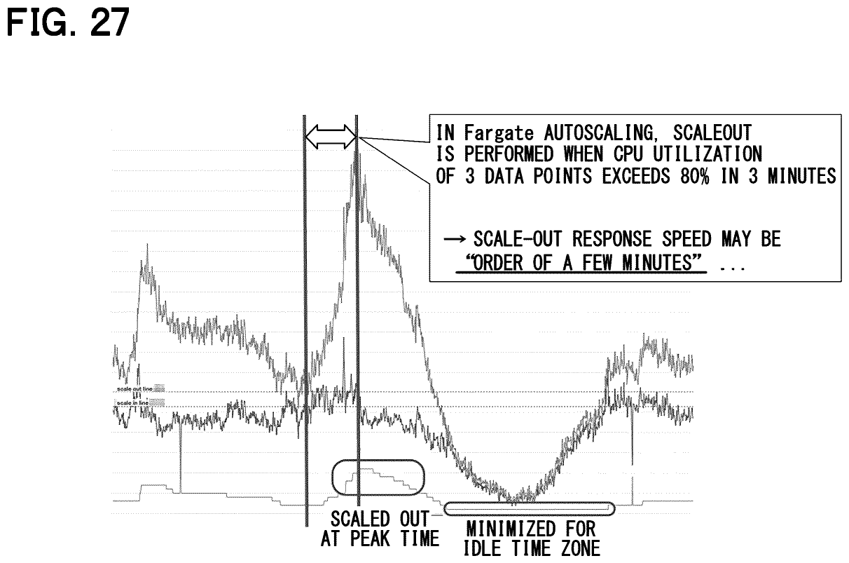

Since there is constantly a time lag between the CloudWatch metrics and alarm activation, it is difficult to perform scaling in units of several seconds, and scaling in units of minutes is basically performed. For this reason, in the serverless application simply applying AWS Fargate, as illustrated in FIG. 27, there is a problem that it is not possible to cope with a sudden rapid increase in communication traffic from the vehicle 31.

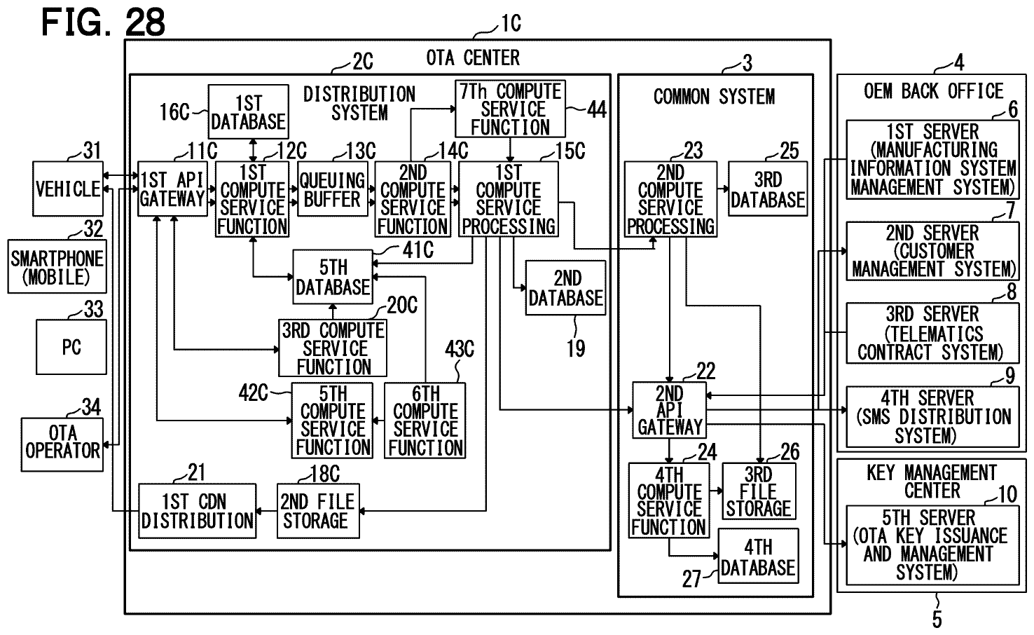

Therefore, in an OTA center 1C of the fourth embodiment illustrated in FIG. 28, a compute service function section 44 is added to the configuration of the third embodiment in a distribution system 2C. A compute service function section 14C accesses the compute service function section 44, and the compute service function section 44 accesses a compute service processing section 15C.

The compute service function section 44 actively performs scale-out. In order to autoscale AWS Fargate corresponding to the compute service processing section 15C at high speed, for example, the number of connections to the Fargate task that is a data plane is acquired every 3 seconds using Step Functions, and the upper limit of the number of tasks of the ECS that is a control plane is increased according to the result. As a result, the processing capability of the compute service processing section 15C is adjusted. The compute service function section 44 is an example of a processing capability adjustment section.

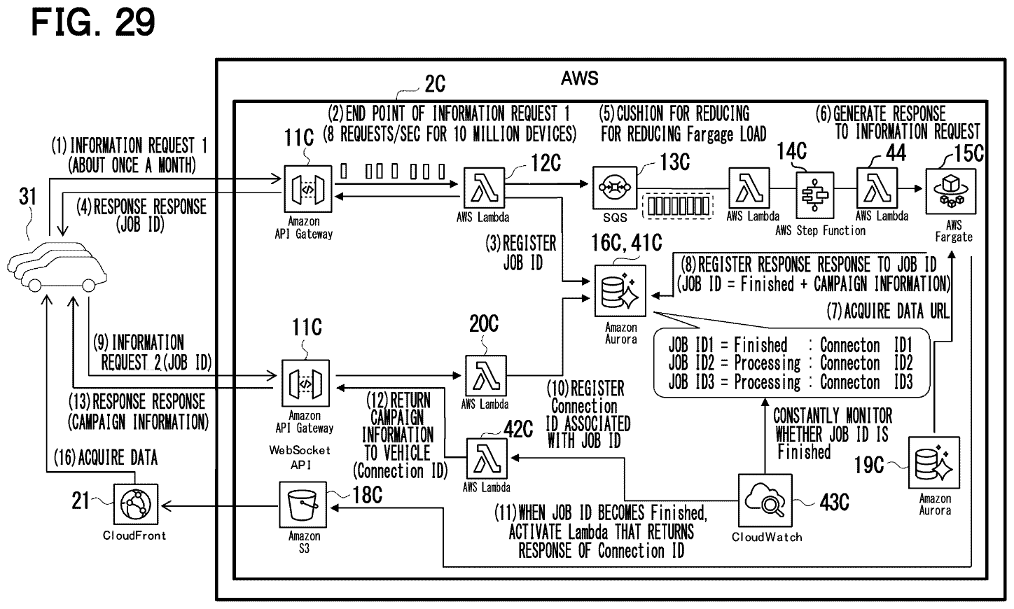

FIG. 29 is an example of a case where a center apparatus 1C illustrated in FIG. 28 is configured using the AWS cloud.

Amazon API Gateway corresponds to an API gateway section 11C.

AWS Lambda corresponds to compute service function sections 12C, 20C, 42C, and 44.

SQS corresponds to a queuing buffer section 13C.

AWS Step Functions corresponds to the compute service function section 14C.

Amazon Aurora corresponds to database sections 16C and 41C.

CloudWatch corresponds to a compute service function section

43C.

Next, the operation of the fourth embodiment will be described.

### <Reception of Vehicle Configuration Information→Transmission of JOB_ID and Generation of Campaign Information>

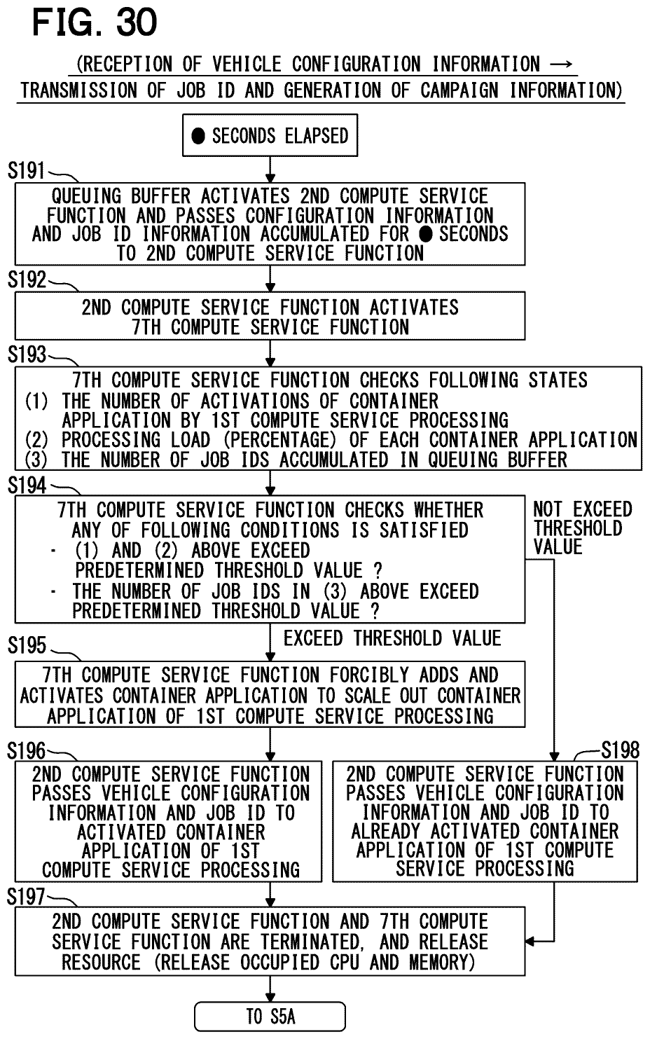

Steps S1 to S5A are executed as in the second embodiment illustrated in FIG. 15. Subsequently, as illustrated in FIG. 30, when the process similar to that of step S96 is executed (S191), the compute service function section 14C activates the compute service function section 44 (S192). The compute service function section 44 checks the following (1) to (3) (S192):
(1) The number of container applications in the compute service processing section 150;
(2) The processing load factor of each container application; and
(3) The number of job IDs accumulated in the queuing buffer section 13C.

Subsequently, the compute service function section 44 checks whether any of the following conditions is satisfied (S194):
the number of activations in the above (1) exceeds a predetermined threshold value;
the load factor of the above (2) exceeds a predetermined threshold value; and
the number of job IDs in (3) above exceeds a predetermined threshold value.

When any of the conditions exceeds the threshold value, the compute service function section 44 forcibly adds and activates the container application in order to scale out the container application of the compute service processing section 15C (S195).

Next, the compute service function section 14C passes the vehicle configuration information and the job ID to the activated container application of the compute service processing section 15C (S196). Then, the compute service function sections 14C and 44 terminate the process and release the occupied resources (S197). On the other hand, in step S194, when the value does not exceed the threshold value under any condition, the compute service function section 14C passes the vehicle configuration information and the job ID to the already activated container application of the compute service processing section 15C (S198), and then the process proceeds to step S197. Thereafter, steps S98 to S11 illustrated in FIG. 15 are executed.

As described above, according to the fourth embodiment, when checking the processing load of the compute service processing section 15C configured to generate the campaign notification information for the vehicle 31 and the number of pieces of vehicle configuration information received from the vehicle 31, the compute service function section 44 determines whether it is necessary to increase or decrease the processing capability of the compute service processing section 15C, and increases or decreases the processing capability as necessary. As a result, it is possible to cope with a case where the amount of communication traffic with the vehicle 31 or the OTA operator 34 rapidly increases.

### Fifth Embodiment

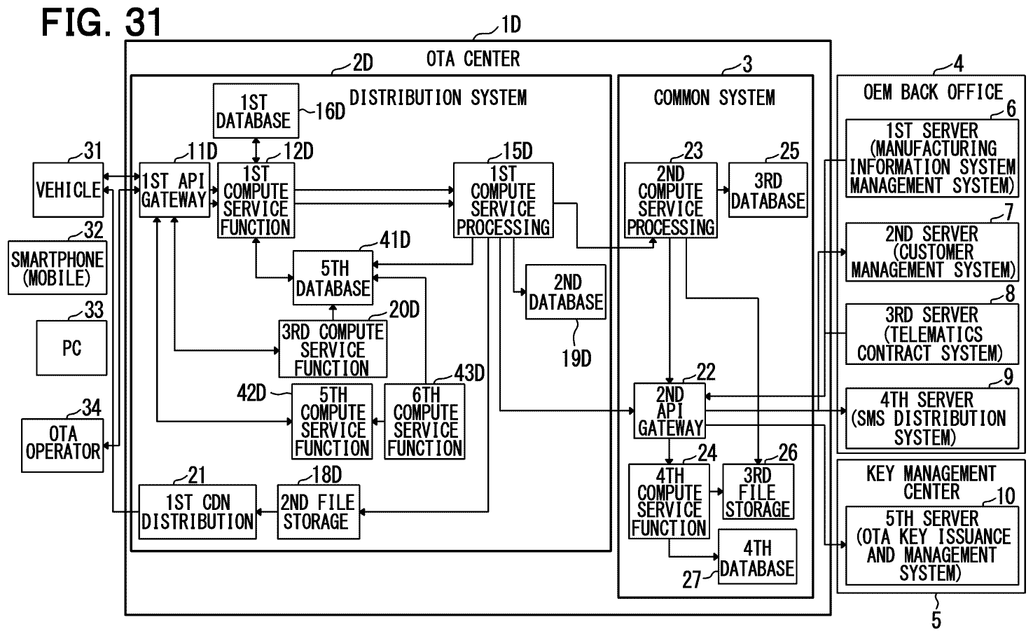

In the fifth embodiment, a configuration in which the development cost is optimized is illustrated. As illustrated in FIG. 31, in an OTA center 1D of the fifth embodiment, the queuing buffer section 13 and the compute service function section 14 are deleted from the configuration of the second embodiment in a distribution center 2D.

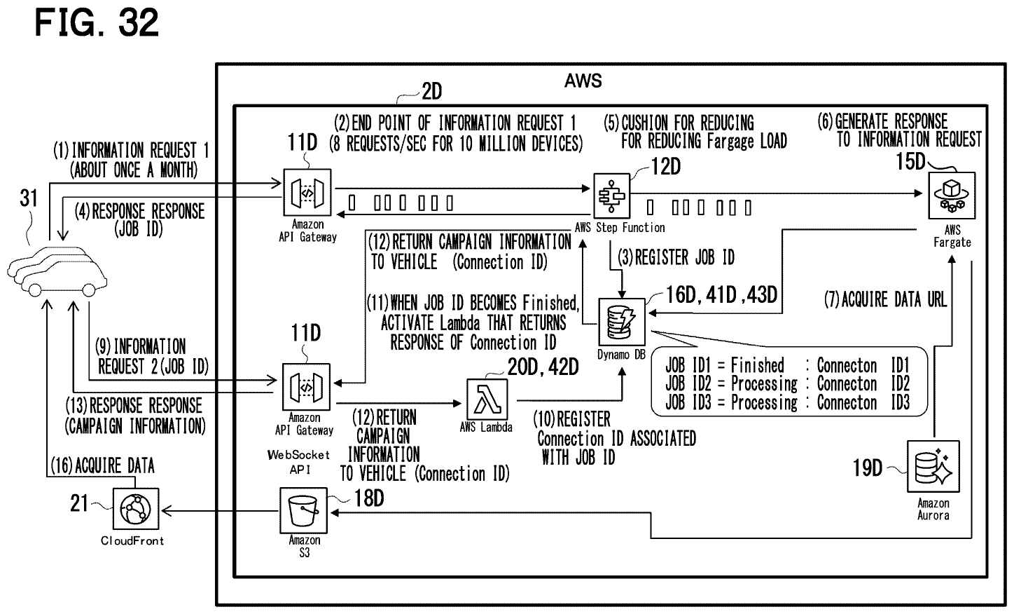

FIG. 32 is an example of a case where a center apparatus 1D illustrated in FIG. 31 is configured using the AWS cloud.

Amazon API Gateway corresponds to an API gateway section 11D.

AWS Lambda corresponds to compute service function sections 20D and 42D.

AWS Step Functions corresponds to a compute service function section 12D.

Dynamo DB corresponds to the database sections 16D and 41D and a compute service function section 43D.

Next, the operation of the fifth embodiment will be described.

### <Reception of Vehicle Configuration Information→Transmission of Job ID and Transmission of Campaign Information>

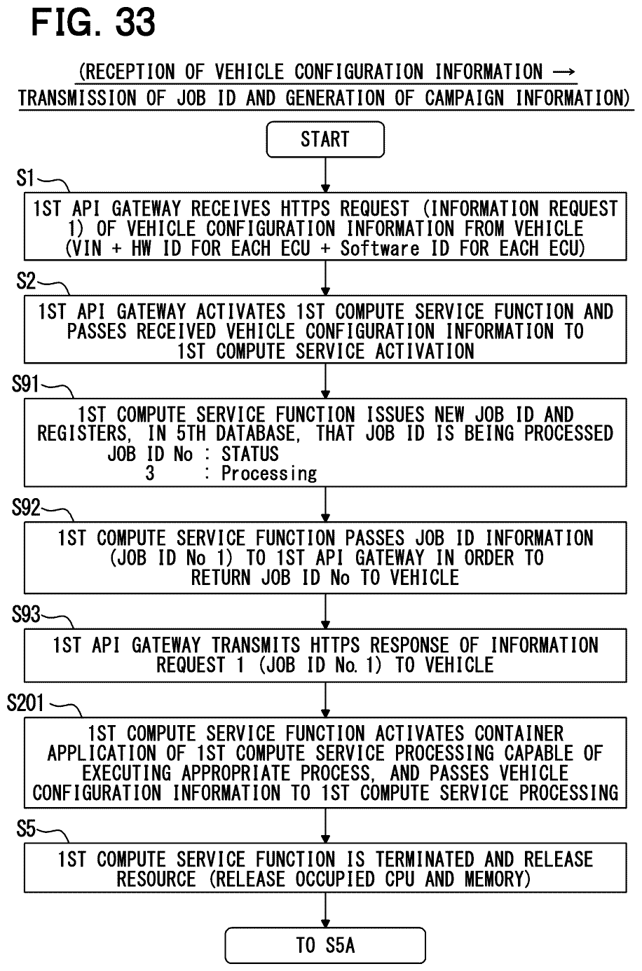

As illustrated in FIG. 33, when steps S1 to S93 are executed, the compute service function section 12D activates a container application of a compute service processing section 15D capable of executing the appropriate process, and passes the vehicle configuration information to the compute service processing section 15D (S201). Then, steps S5 to S11 are executed.

### <Reception of Campaign Information Request→Check of Generation Status of Campaign Information and Transmission of Campaign Information>

This is similar to the process illustrated in FIG. 24 of the third embodiment.

### <Registration of Campaign Information→Registration of Distribution Package to CDN Distribution Section 21D>

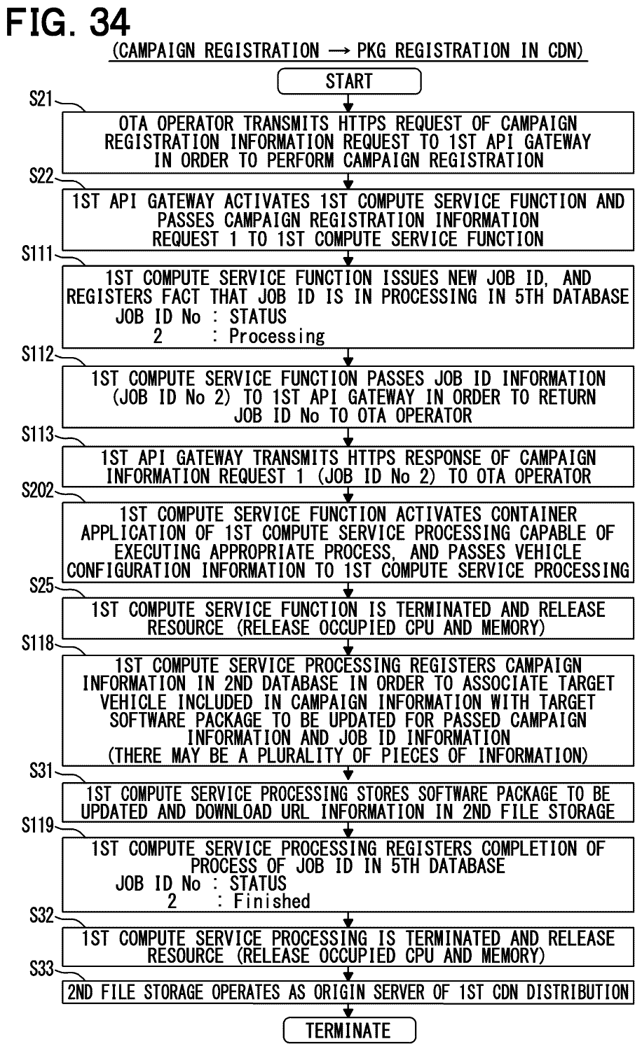

As illustrated in FIG. 34, when steps S21 to S113 are executed, the compute service function section 12D activates a container application of the compute service processing section 15D capable of executing the appropriate process, and passes the vehicle configuration information to a compute service processing section 15D (S202). Then, steps S25, S118, and S31 to S33 are executed.

### <Registration of Campaign Information→Registration of Distribution Package to CDN Distribution Section 21>

This is similar to the process illustrated in FIG. 25 of the second embodiment.

### <Data Access from Vehicle→Transmit Distribution Package from CDN to Vehicle>

This is similar to the process illustrated in FIG. 6 of the first embodiment.

### <Registration of Software Update Data>

This is similar to the process illustrated in FIG. 7 of the first embodiment.

### <Registration of Case Information→Generation of Package>

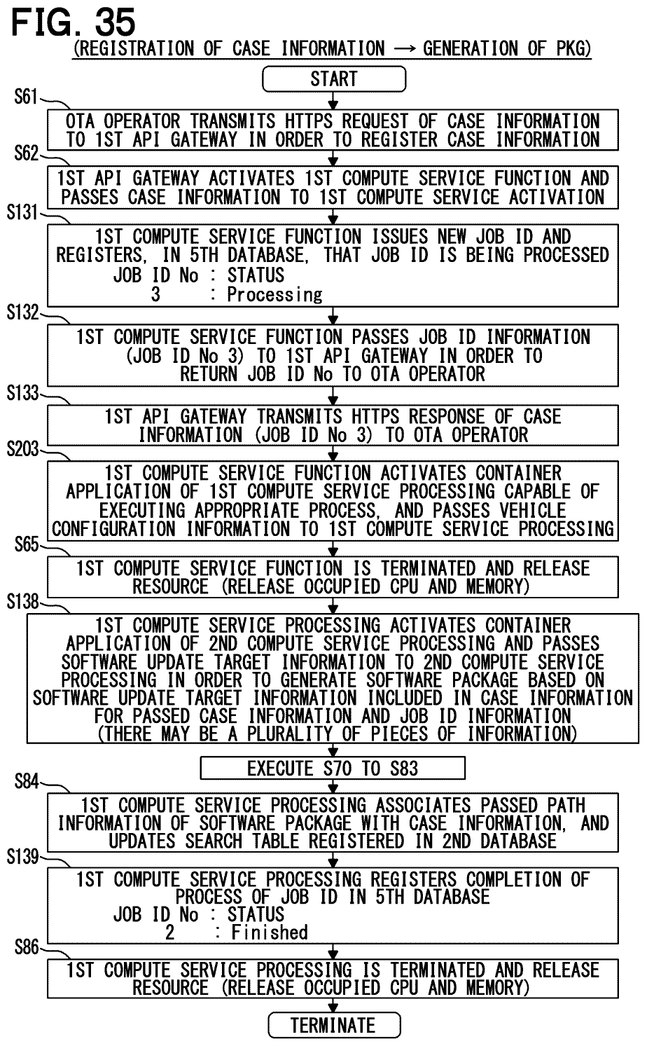

As illustrated in FIG. 35, when steps S61 to S133 are executed as in FIG. 19 of the second embodiment, the compute service function section 12D activates the container application of the compute service processing section 15D capable of executing the appropriate process, and passes the vehicle configuration information to the compute service processing section 15D (S203). Then, when steps S65 and S138 are executed, S70 to S86 are executed as in FIG. 19 of the second embodiment.

### <Reception of Registration Request of Case Information→Check of Registration Status of Case Information and Transmission of Case Registration Information (Result)>

This is similar to the process illustrated in FIG. 26 of the third embodiment.

As described above, according to the fifth embodiment, the OTA center 1D can be configured at low cost by deleting the queuing buffer section 13 and the compute service function section 14.

### Sixth Embodiment

In the sixth embodiment, in order to enhance security, a signed URL having an expiration date is used. By using the signed URL, a start date and time at which the user can start accessing the content, a date and time or a period of time when the user can access the content, can be designated, and an IP address of the user who can access the content or a range of the IP addresses can be designated. The signature is an example of the access control information.

For example, when the OTA center creates a signed URL using the secret key and returns the signed URL to the vehicle, the vehicle side downloads or streams content from the CDN using the signed URL. The CDN verify the signature using a public key, and verify that the user is qualified to access the file.

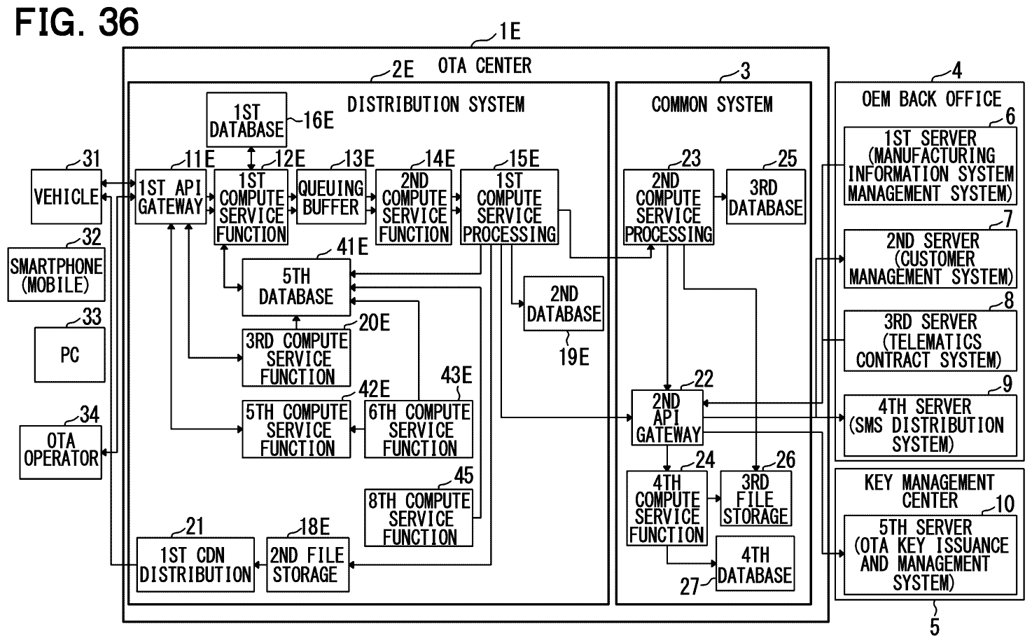

As illustrated in FIG. 36, an OTA center 1E of the sixth embodiment is obtained by adding a compute service function section 45 to the configuration of the second embodiment in a distribution system 2E. The compute service function section 45 accesses a compute service processing section 15E. A database section 41E manages an expiration date and a signed URL.

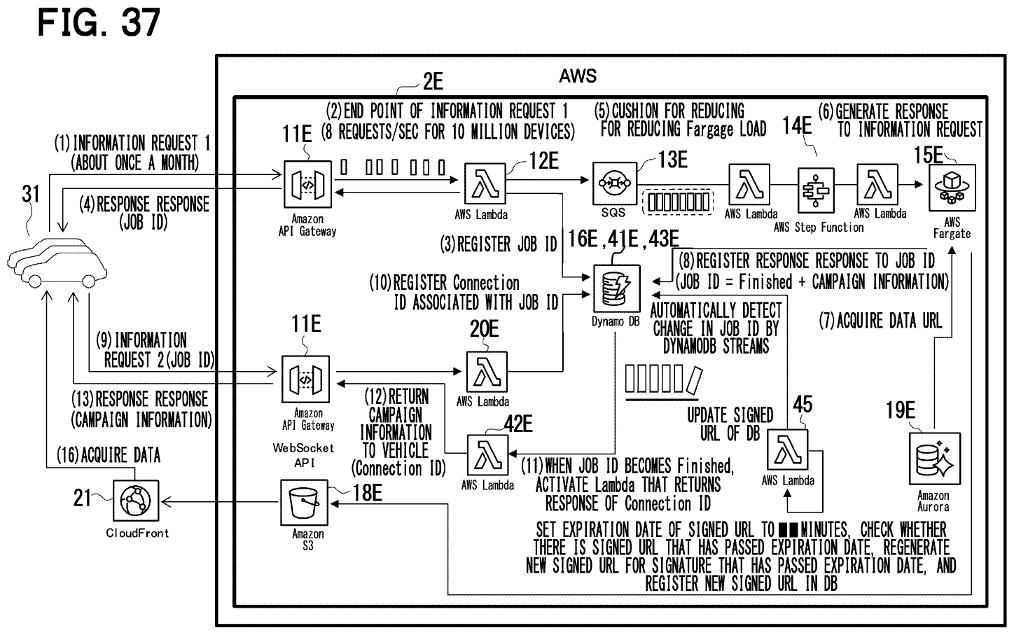

FIG. 37 is an example of a case where the center apparatus 1E illustrated in FIG. 36 is configured using the AWS cloud.

Amazon API Gateway: corresponds to an API gateway section 11E.

AWS Lambda corresponds to compute service function sections 12E, 14E, 20E, and 45.

AWS Step Functions corresponds to a compute service function section 14E.

SQS corresponds to a queuing buffer section 13E.

Dynamo DB corresponds to database sections 16E and 41E and a compute service function section 42E.

Next, the operation of the sixth embodiment will be described.

### <Reception of Vehicle Configuration Information→Transmission of Job ID and Transmission of Campaign Information>

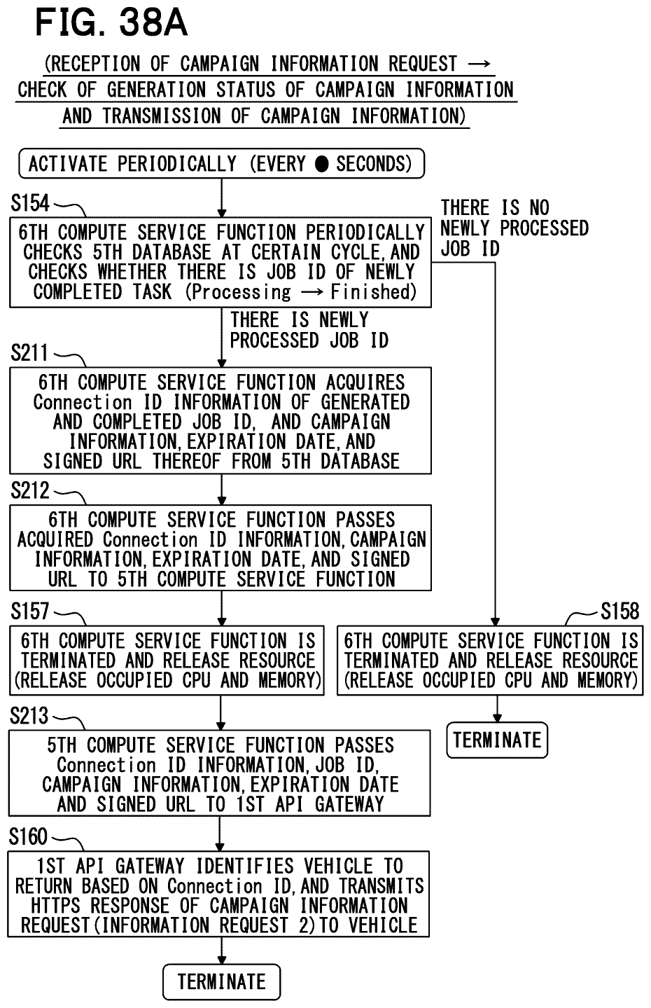

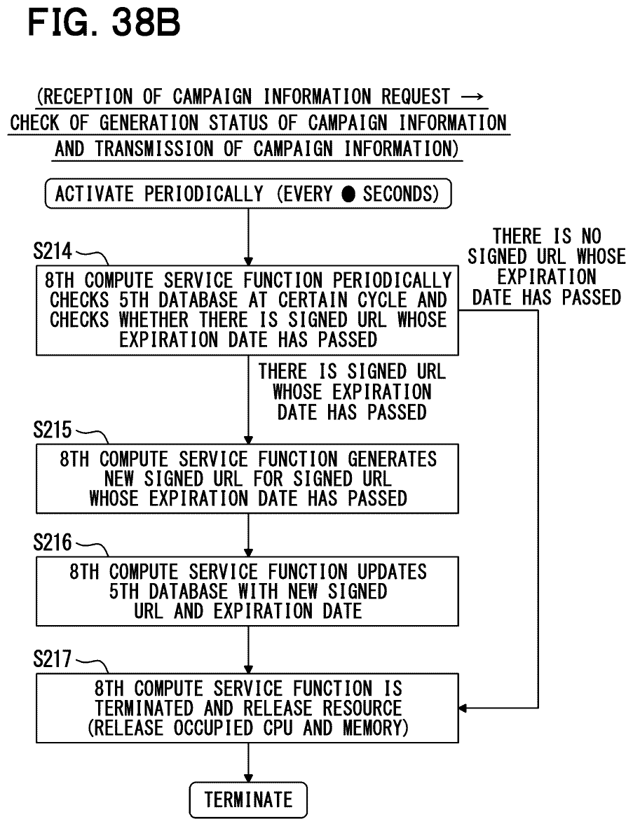

First, steps S1 to S5 and steps S92 to S11 are executed as in the process illustrated in FIG. 23 of the third embodiment. Subsequently, steps S101 to S106 are executed as in the process illustrated in FIG. 24. Then, as illustrated in FIG. 38, when step S154 is executed, when there is a job ID number of a task-completed job, a compute service function section 43E acquires connection ID information and campaign information of the job ID number, and an expiration date and a signed URL from the database section 41E (S211). When each piece of the acquired information is passed to a compute service function section 42E (S212), step S157 is executed. The compute service function section 42E passes each of the above information to the API gateway section 11E (S213), and then executes step S160.

The process of steps S214 to S217 is periodically executed. The compute service function section 45 periodically checks the database section 41E to check whether there is a signed URL whose expiration date has passed (S214). When there is a signed URL whose expiration date has passed, a signed URL to which a new expiration date is added is generated (S215), and the database section 41E is updated (S216). Then, the compute service function section 45 terminates the process and releases the occupied resource (S217).

### <Registration of Campaign Information→Registration of Distribution Package to CDN Distribution Section 21>

This process is similar to that of the third embodiment.

### <Data Access from Vehicle→Transmit Distribution Package from CDN to Vehicle>

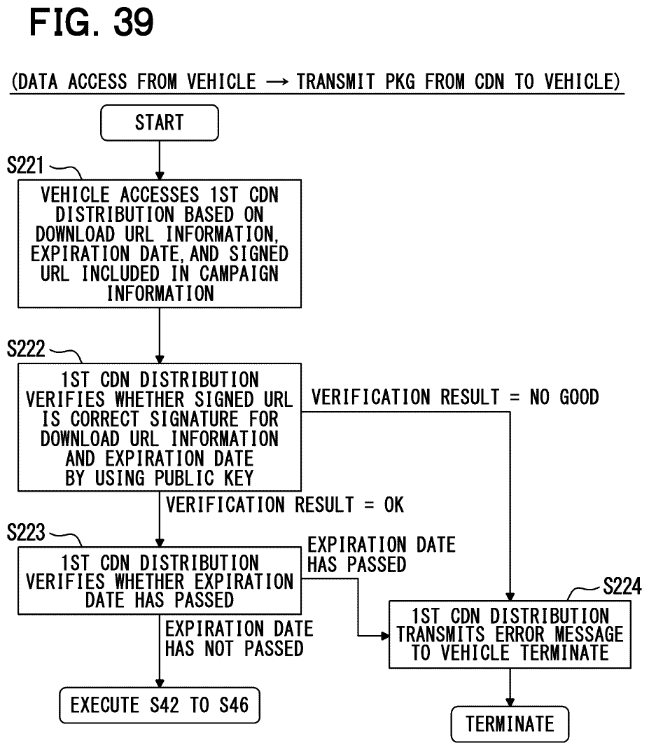

As illustrated in FIG. 39, the vehicle 31 accesses the CDN distribution section 21 based on the download URL information, the expiration date, and the signed URL included in the campaign information (S221). The CDN distribution section 21 verifies whether the expiration date and the signature of the signed URL are correct using the public key (S222). When the verification result is OK, the CDN distribution section 21 verifies whether the expiration date has passed (S223), and executes steps S42 to S46 when the expiration date has not passed. On the other hand, when the expiration date has passed, the CDN distribution section 21 transmits an error message to the vehicle 31 (S224).

### <Registration of Software Update Data>

### <Registration of Case Information→Generation of Package>

### <Reception of Case Information Registration Request→Check of Generation Status of Case Information and Transmission of Case Information>

These processes are similar to those in the third embodiment.

As described above, according to the sixth embodiment, since the campaign information includes the expiration date and the signed URL in together with the download URL information, and the OTA center 1E checks the expiration date and verifies the signature, it is possible to assign the date and time when the access to the content can be started and the date and time when the access can be made, and to limit the users who can access the content by the CDN distribution section 21. Therefore, the security of communication with the vehicle 31 can be improved.

Note that, in the first to sixth embodiments, in a case where the OTA operator 34 accesses the API gateway section 11, or in a case where the OEM back office 4 accesses the API gateway section 22 and the key management center 5 accesses the API gateway section 22, a process may be performed by a program employing a server architecture.

### Seventh Embodiment

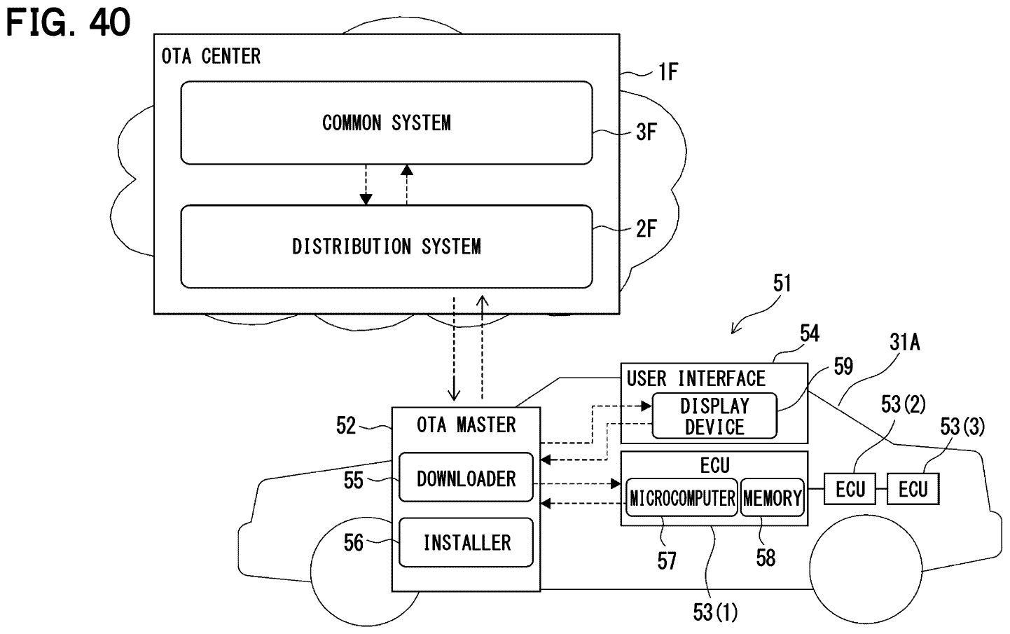

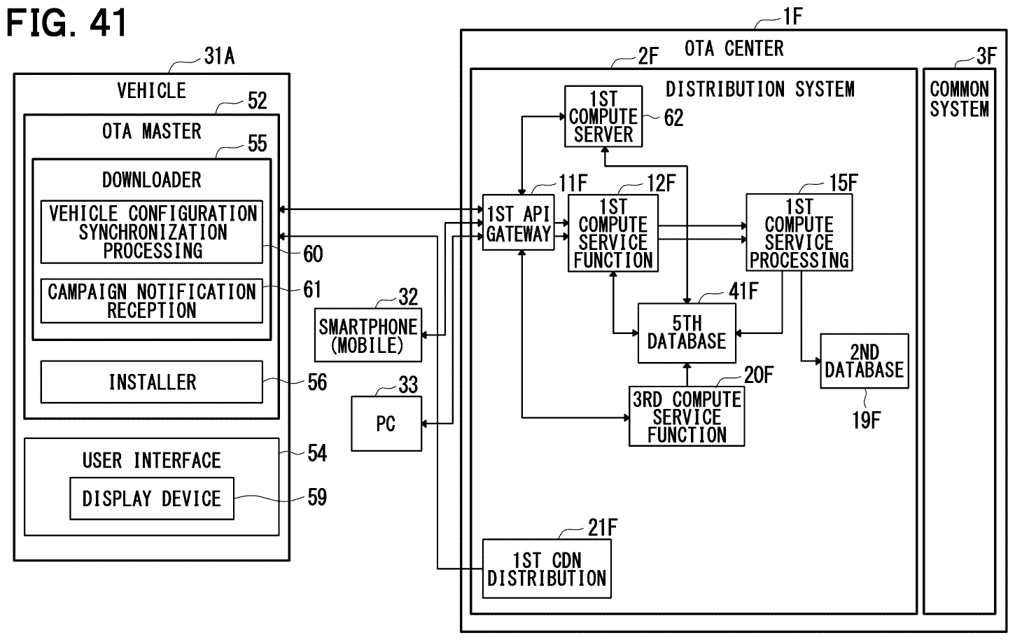

The seventh embodiment relates to a process by an in-vehicle system that performs wireless communication with the OTA center 1 and the like. As illustrated in FIGS. 40 and 41, an in-vehicle system 51 mounted on a vehicle 31A includes an OTA master 52, ECUs 53 (1) to 53 (3), a user interface section 54, and the like. The OTA master 52 includes a downloader 55 and an installer 56. The ECU 53 includes a microcomputer 57, a memory 58, and the like, and the user interface section 54 includes a display device 59.

Note that the vehicle-side system may have the following configuration. The vehicle-side system includes a DCM and a central ECU (also referred to as CGW). The DCM and the central ECU are connected via a bus so as to be able to perform data communication. The bus is an Ethernet, a CAN (registered trademark) bus, or the like.

Some or all of the functions of the OTA master 52 may be implemented in the central ECU. As an example, the DCM may perform only data communication with the outside such as the CDN 21 or the OTA center 1F, and all the functions of the OTA master 52 may be implemented by the central ECU. In this case, the DCM performs wireless communication with the outside, but transfers data to the central ECU. Alternatively, the DCM may function as a downloader 55 of the OTA master 52 in addition to communicating data with the outside. The functions of the downloader 55 are, for example, generation of vehicle configuration information, metadata verification, package verification, and verification of campaign information. Alternatively, the function of the OTA master 52 may be implemented in the DCM. In this case, functions other than the OTA master 52 are implemented in the central ECU. Alternatively, the DCM and the central ECU may be integrated.

That is, the central ECU may have some or all of the functions of the DCM, or the DCM may have some or all of the functions of the central ECU. In the OTA master 52, function sharing between the DCM and the central ECU may be configured in any manner. The OTA master 52 may include two ECUs of the DCM and the central ECU, or may include one integrated ECU having a DCM function and a central ECU function.

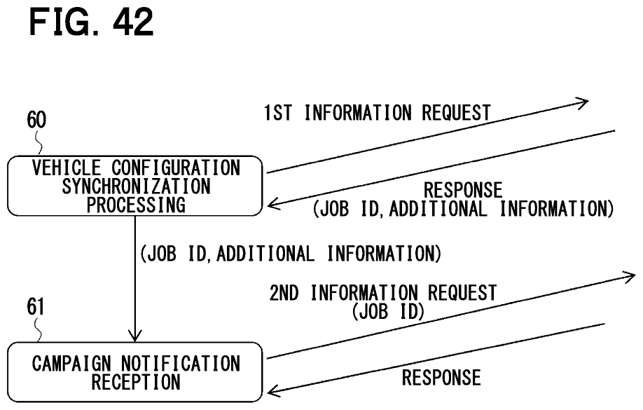

In an OTA center 1F illustrated in FIG. 41, only the functional section according to the gist of the seventh embodiment is illustrated as blocks. The downloader 55 includes a vehicle configuration synchronization processing section 60 and a campaign notification reception section 61. As illustrated in FIG. 42, when collecting various pieces of data output from the ECU 53 or the like as vehicle configuration information, the vehicle configuration synchronization processing section 60 generates digest information obtained by applying a hash function to full data of the collected information. The digest information of the vehicle information is transmitted to the OTA center 1F together with information request 1 (the first request). In addition, a response (the intermediate response) corresponding to the information request 1 is received from the OTA center 1F together with the job ID and the additional information.

The additional information includes parameters and the like for switching the process on the vehicle side, and a process for each vehicle and a process for each service are performed by using the parameters. Furthermore, as will be described later, the additional information may include a standby time which is a transmission condition from a time point at which the response is received until the information request 2 is transmitted.

Based on the additional information described above, or when determining that the standby time preset in the vehicle 31A has elapsed, the campaign notification reception section 61 transmits the information request 2 (the second request) to which the job ID is attached to access the OTA center 1F. In addition, a response (the final response) corresponding to the information request 2 is received from the OTA center 1F together with the campaign information. The response includes campaign information indicating that there is a campaign, campaign information indicating that there is no campaign, a request for transmitting vehicle configuration information of full data, and before the process of the information request 1 is completed (in processing).

A compute server section 62 employing a server architecture is added to a distribution system 2F. The compute server section 62 performs data transfer with the API gateway section 11F and the database section 41F. Note that the in-vehicle system 51 mounted on the vehicle 31A in the seventh embodiment is also applicable to the OTA center 1 described in embodiments other than the seventh embodiment.

Next, the operation of the seventh embodiment will be described.

### <Transmission of Vehicle Configuration Information→Reception of Campaign Information (Process by the OTA Master)>

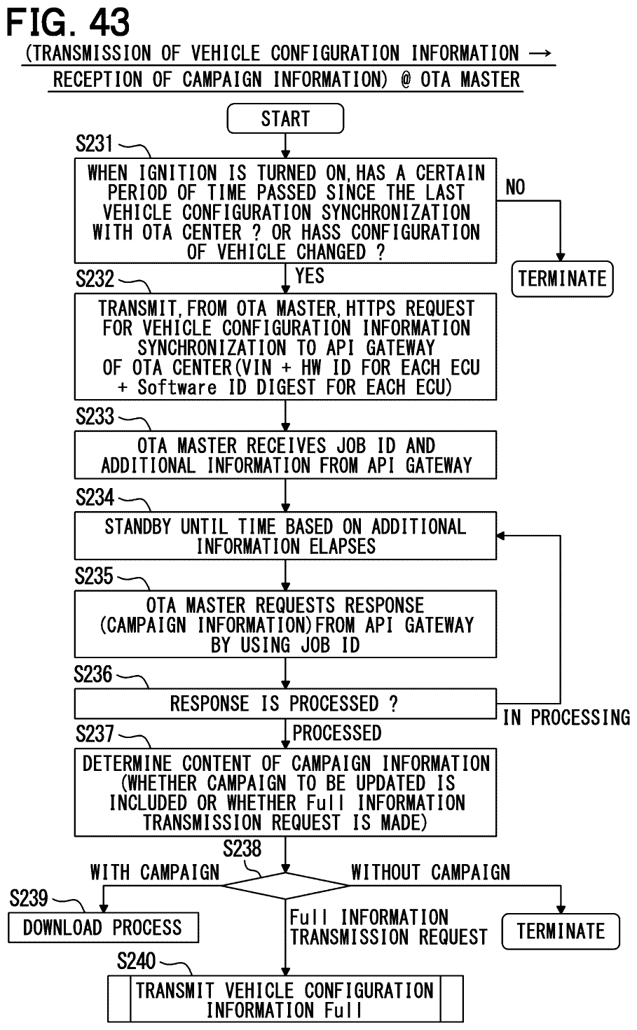

As illustrated in FIG. 43, when the ignition switch of the vehicle 31A is turned on, the OTA master 52 determines whether a certain period has changed from the date on which the synchronization process of the vehicle configuration information has been performed last with the OTA center 1F, or whether the vehicle configuration information has changed (S231). When any of them changes, the OTA master 52 transmits an HTTPS request (the information request 1) related to the synchronization process of the vehicle configuration information to the API gateway section 11F of the OTA center 1F (S232). Alternatively, when a notification indicating that there is a campaign is received from the OTA center 1F in step S231, the process also proceeds to step SS232.

When receiving a response corresponding to the information request 1 from the API gateway section 11F together with the job ID and the additional information (S233), the OTA master 52 waits for the lapse of the standby time included in the additional information (S234). When the standby time has elapsed, the OTA master 52 transmits the information request 2 to which the job ID is assigned to the API gateway section 11F, and requests a response including campaign information (S235). Note that the standby time is not limited to that given by the additional information, and may be set in the in-vehicle system 51 in advance.

When the response is received and processed, the content of the campaign information is determined (S236, S237). That is, it is determined whether a campaign to be updated is included, whether transmission of the full data of the vehicle configuration information is requested, or the like. According to the content, the process goes through subsequent step S238 and branches. When there is a campaign to be updated, a download process is performed as in the previous embodiment (S239). When the transmission request for the full data is made, entire data of the vehicle configuration information is transmitted to the OTA center 1F (S240).

Next, a case where transmission of full data is requested will be described.

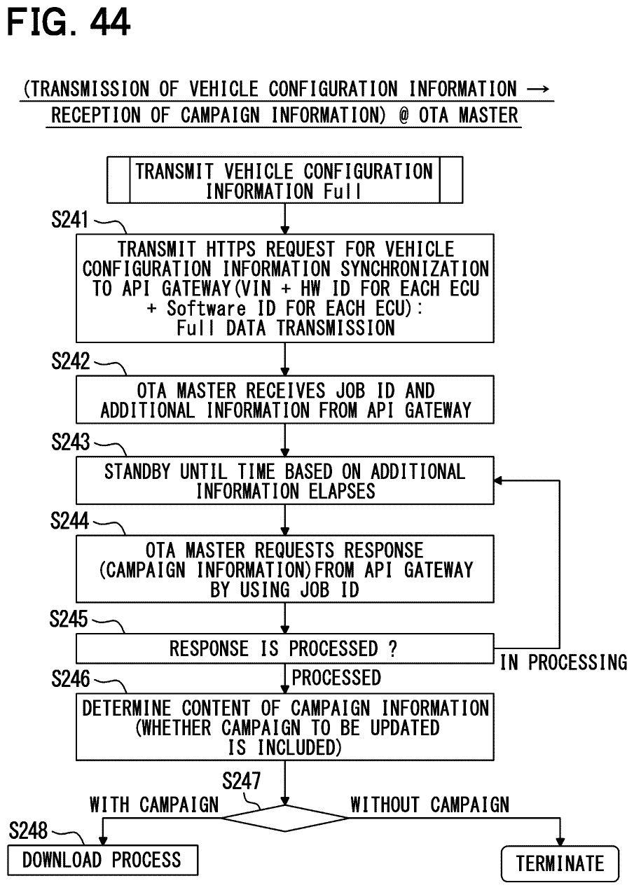

As illustrated in FIG. 44, when the full data of the vehicle configuration information is transmitted, the HTTPS request is transmitted by replacing digest information with the entire data in step S232 (S241). The subsequent process of steps S242 to S248 is similar to the process of steps S233 to S239. Note that step S241 corresponds to the information request 1, step S242 corresponds to the intermediate response, step S244 corresponds to the information request 2, and step S245 corresponds to the final response.

### <Transmission of Vehicle Configuration Information→Transmission of Campaign Information (Process by the OTA Center)>

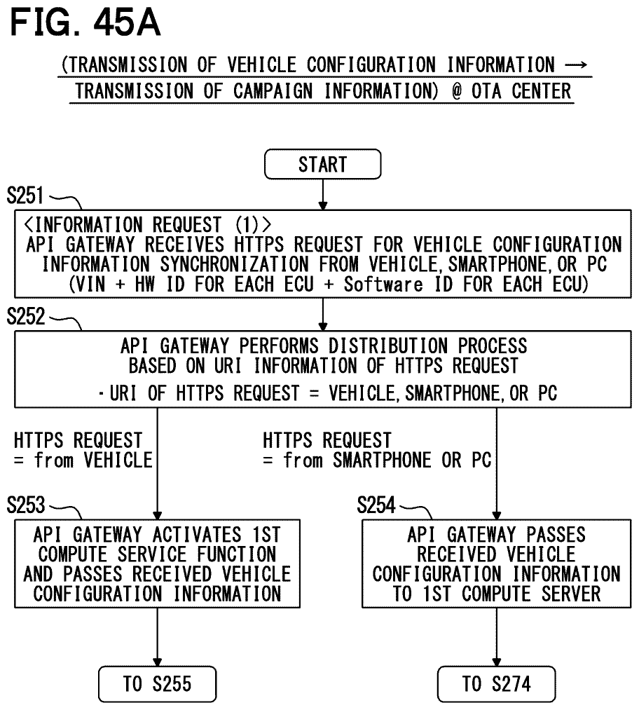

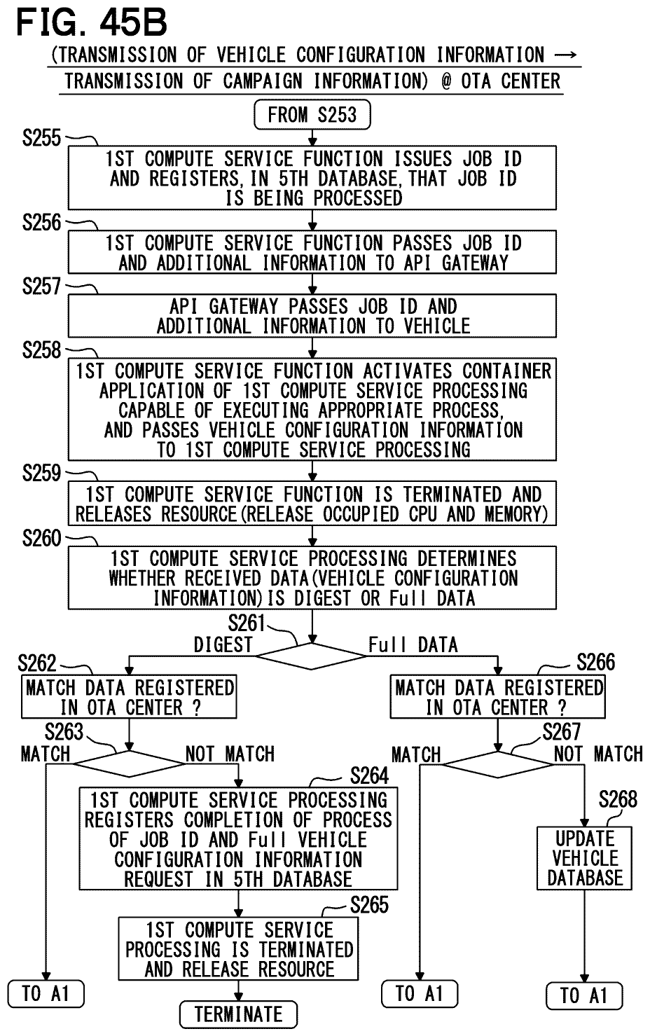

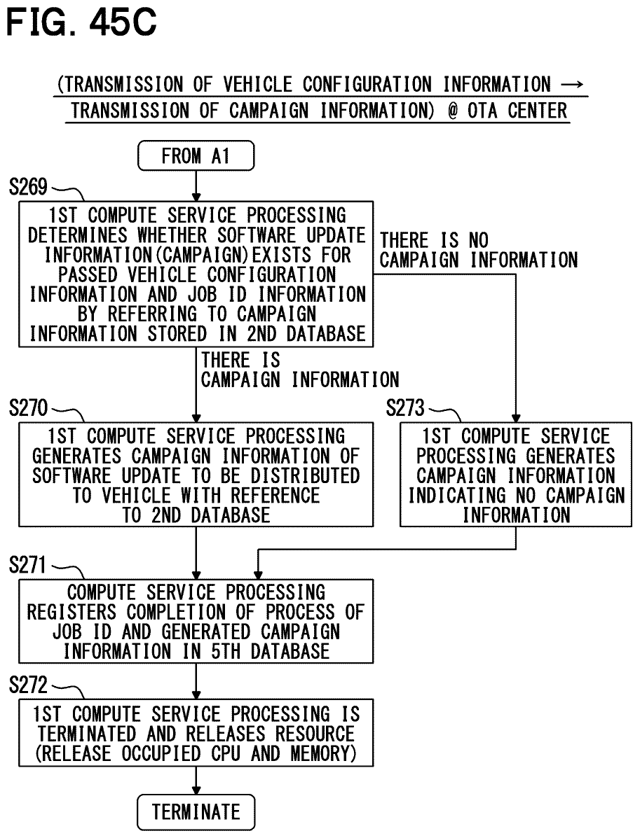

As illustrated in FIG. 45, in the process corresponding to the reception of the information request 1, the API gateway section 11F of the OTA center 1F receives the HTTPS request related to the synchronization of the vehicle configuration information from the vehicle 31A, the mobile 32, or the PC 33 (S251). Then, the API gateway section 11F distributes the request to any of the vehicle 31A, the mobile 32, and the PC 33 based on the URI information included in the request (S252).

When the transmission source of the request is the vehicle 31A, the API gateway section 11F activates a compute service function section 12F and passes the received vehicle configuration information (S253). When the compute service function section 12F issues a job ID and registers that the job with the ID is in process in the database section 41F (S255), the compute service function section passes the job ID to the API gateway section 11F together with the additional information (S256). The API gateway section 11F passes the job ID and the additional information to the vehicle 31A. This is the intermediate response (S257).

Next, the compute service function section 12F starts a container application of a compute service processing section 15F capable of executing an appropriate process, and passes the vehicle configuration information (S258). Then, the compute service function section 12F terminates the process and releases the occupied resource (S259). Subsequently, the compute service processing section 15F determines whether the received vehicle configuration information is a hash value (the digest value) obtained by applying a hash function to the full data or the full data itself (S260, S261). When it is a digest value, it is determined whether the digest value matches a value registered in the OTA center 1F (S262, S263).

When both values match, the compute service processing section 15F determines whether there is a campaign that is software update information for the passed vehicle configuration information and job ID information with reference to the campaign information stored in the database section 19F (S269). When there is corresponding campaign information, the compute service processing section 15F generates campaign information to be distributed to the vehicle 31A with reference to a database section 19F (S270).

Then, the compute service processing section 15F registers the completion of the process corresponding to the job ID and the generated campaign information in the database section 19F (S271). Then, the compute service processing section 15F terminates the process and releases the occupied resource (S272). When there is no corresponding campaign information in step S269, the compute service processing section 15F generates campaign information indicating that there is no corresponding campaign information (S273), and advances the process to step S271.

On the other hand, when two values do not match in step S263, the compute service processing section 15F registers, in the database section 41F, that the process corresponding to the job ID has been terminated and that the full data vehicle configuration information has been requested (S264). Then, a process similar to that in step S272 is performed (S265). When the received vehicle configuration information is full data in step S261, it is determined whether the received vehicle configuration information matches a value registered in the OTA center 1F (S266, S267). When two pieces of data match, the process directly proceeds to step S269, and when two pieces of data do not match, the vehicle configuration information database on the OTA center 1F side is updated (S268), and then the process proceeds to step S269. For example, the database section 19F corresponds to a vehicle configuration information database.

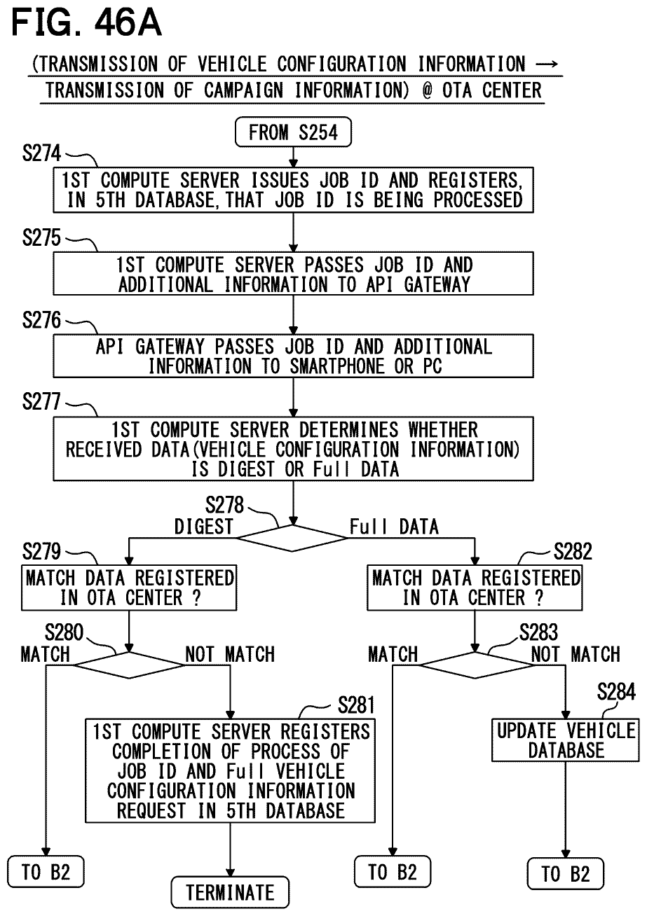

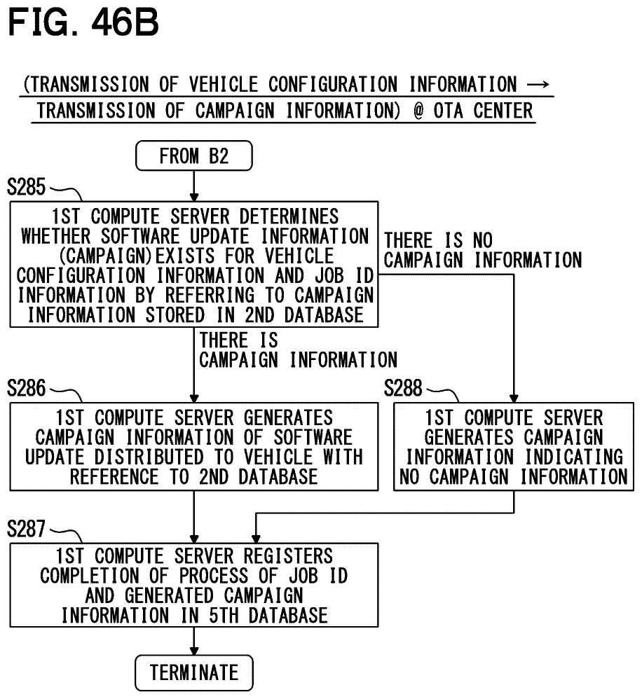

In step S252, when the transmission source of the request is the smartphone 32 or the PC 33, the API gateway section 11F passes the received vehicle configuration information to the compute server section 62 (S254). Then, the process proceeds to step S274 illustrated in FIG. 46. In the subsequent process of steps S274 to S288, a process executed by the compute service processing section 15F in steps S255 to S257, S260 to S264, and S266 to S273 (excluding S272) is executed by the compute server section 62.

When the transmission source of the request is the smartphone 32 or the PC 33, the smartphone 32 or the PC 33 communicates with the OTA master 52 of the vehicle 31A to acquire and store in advance the digest value of the vehicle configuration information and the full data of the vehicle configuration information. In addition, the smartphone 32 or the PC 33 acquires and stores the full data of the vehicle configuration information in advance. When the smartphone 32 or the PC 33 transmits the full data of the vehicle configuration information to the API gateway section 11F in step S251, the process always proceeds to step S266 in step S261.

### <Transmission of Vehicle Configuration Information→Transmission of Campaign Information (Process by the OTA Center)>

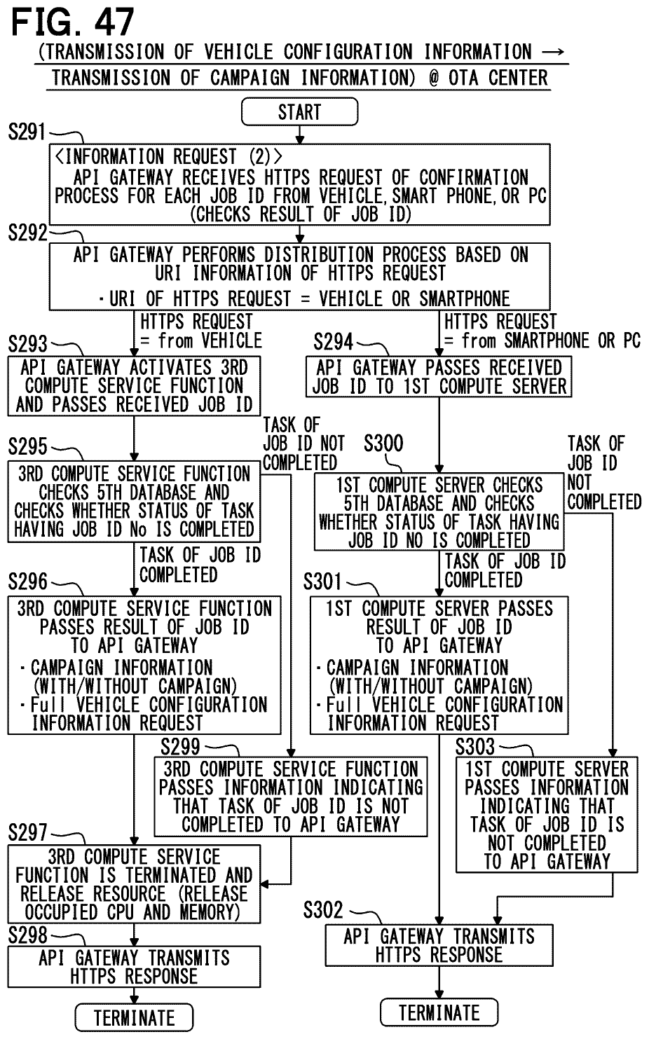

In the process of steps S291 to S294 illustrated in FIG. 47, the process of steps S251 to S254 is performed in response to the reception of the information request 2. In subsequent step S295, the compute service function section 20F checks the database section 41F to check whether the status of the task having the job ID is completed. When the task has been completed, the compute service function section 20F delivers a processing result of the task (the campaign information) to the API gateway section 11F (S296). At this point, the vehicle 31A may be requested to transmit the full data of the vehicle configuration information. Then, the compute service function section 20F terminates the process and releases the occupied resource (S297). The API gateway section 11F passes the HTTPS response to the vehicle 31A (S298). This is the second time response.

In the process of steps S300 to S302 subsequent to step S294, the compute server section 62 executes the process performed by a compute service processing section 20F in steps S295 to S298 (excluding S297). Note that, in step S302, the API gateway section 11F passes the HTTPS response to the smartphone 32 or the PC 33.

As described above, according to the seventh embodiment, when the in-vehicle system 51 transmits the information request 1 including the vehicle configuration information collected in the vehicle 31A to the OTA center 1F, the API gateway section 11F transmits an intermediate response including the job ID corresponding to the request to the in-vehicle system 51. Upon receiving the response, the in-vehicle system 51 transmits a response request of a final response corresponding to the information request 1 to the OTA center 1F as the information request 2 to which the job ID is assigned.

That is, the in-vehicle system 51 may transmit the information request twice when communicating with the OTA center 1F. Then, the OTA center 1F may start an application program corresponding to the requested process and execute the process during the two times of request transmission. As a result, even when an external compute service employing the serverless architecture is used, the service can be used only for a period for executing a necessary process. Therefore, when the system is charged according to the use time of the service, the operation cost of the OTA center 1F can be reduced.

Further, the API gateway section 11F transmits the intermediate response to the in-vehicle system 51, the intermediate response including additional information including a transmission condition of the information request 2. After receiving the response, the in-vehicle system 51 transmits the information request 2 when the transmission condition is satisfied. The transmission condition includes, for example, a standby time from when the in-vehicle system 51 receives the intermediate response to when the information request 2 is transmitted, and the in-vehicle system 51 transmits the information request 2 when the standby time elapses. As a result, the in-vehicle system 51 can wait for transmission of the information request 2 for a time determined to be necessary for the OTA center 1F side to execute the requested process.

Note that a configuration in which the compute server section 62 is omitted is also possible. In this case, even when the transmission source of the request is the mobile 32 or the PC 33, the compute service function section 12F is activated.

### Eighth Embodiment

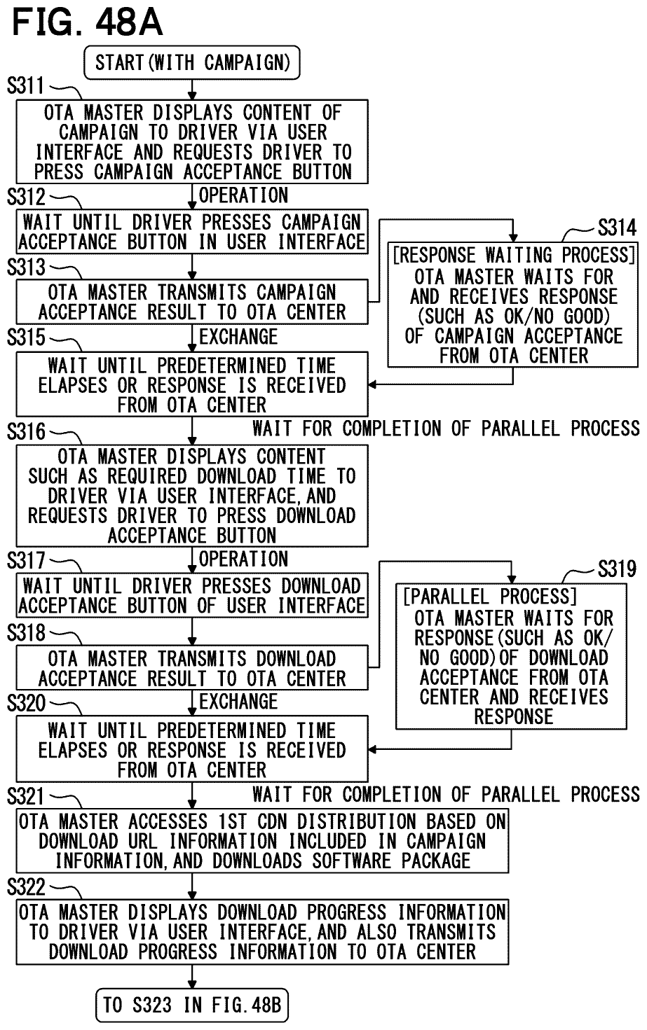

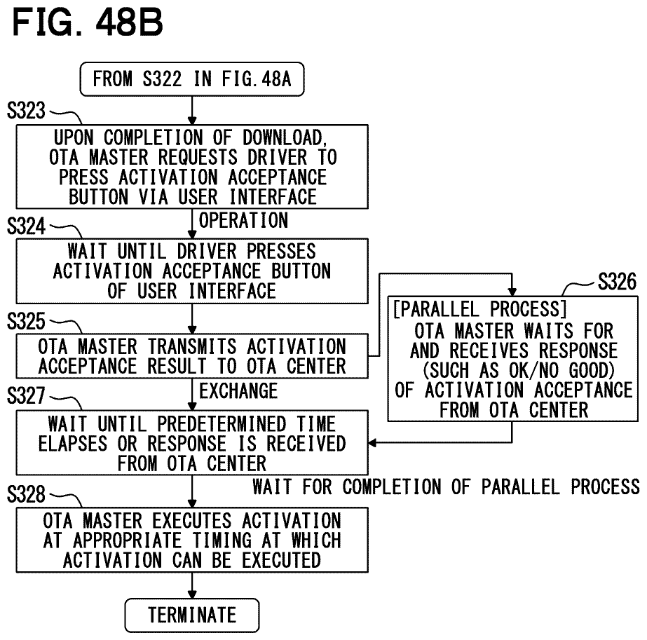

The eighth embodiment illustrated in FIG. 48 assumes that, in a case where there is campaign information to be transmitted to the vehicle 31A, the occupant of the vehicle 31A sequentially accepts program update, download, and activation by the campaign. At this time, a process performed between the OTA center 1F and the OTA master 52 will be described.

The OTA master 52 displays the content of the campaign on the display device 59 of a user interface 54 to make a request of the occupant (the driver) for the press of the campaign acceptance button (S311). Then, the OTA master 52 waits until the driver presses the campaign acceptance button (S312). When the acceptance button is pressed, the OTA master 52 transmits the result of the campaign acceptance to the OTA center 1F (S313), and waits for and receives a response to the campaign acceptance from the OTA center 1F (S314). Steps S313 and S315 are processed in parallel.

When executing step S313, the OTA master 52 waits for a response of campaign acceptance as in step S314 (S315). However, here, when a predetermined time has elapsed, the process proceeds to the next process even in a state where no response is actually received. When the response is received before the predetermined time elapses, the process proceeds to the next process. Similarly in the subsequent process, in a case where a response from the OTA center 1F is waited for, when the response is received before a predetermined time elapses, the process proceeds to the next process.

In subsequent step S316, the OTA master 52 displays the content such as the time required for the download process on the display device 59, and requests the driver to press the download acceptance button. Then, the OTA master 52 waits until the driver presses the download acceptance button (S317). When the acceptance button is pressed, the OTA master transmits a result of the download acceptance to the OTA center 1F (S318), and waits for and receives a response to the download acceptance from the OTA center 1F (S319). Steps S318 and S319 are processed in parallel.

In addition, when executing step S318, the OTA master 52 waits for a response of download acceptance as in step S319 (S320). However, when a predetermined time elapses, the process proceeds to the next process even in a state where no response is actually received. In subsequent step S321, the OTA master 52 accesses a CDN distribution section 21F based on the download URL information included in the campaign information, and downloads the software package. Then, the OTA master 52 displays the progress information about the download process on the display device 59 to indicate the progress information to the driver, and also transmits the progress information to the OTA center 1F (S322).

When the download process is completed, the OTA master 52 displays an activation acceptance button on the display device 59 and requests the driver to press the button (S323). Then, the OTA master 52 waits until the driver presses the activation acceptance button (S324). When the driver presses the acceptance button, the OTA master transmits a result of the activation acceptance to the OTA center 1F (S325), and waits for and receives a response of the activation acceptance from the OTA center 1F (S326). Steps S325 and S326 are processed in parallel.

When executing step S325, the OTA master 52 waits for the response of the activation acceptance as in step S326 (S325). However, when a predetermined time elapses, the process proceeds to the next process even in a state where no response is actually received. In subsequent step S328, the OTA master 52 executes the activation at an appropriate timing at which the activation can be executed.

As described above, according to the eighth embodiment, the in-vehicle system 51 includes the user interface section 54 on which the occupant of the vehicle 31A performs an input operation. Then, when the process based on the input operation performed on the user interface section 54 involves reception of a response from the OTA center 1F, when the response is received or a predetermined time has elapsed, the process proceeds to the next user interface process. As a result, even when it takes a relatively long time to receive the response from the OTA center 1F, it is possible to prevent the occupant from feeling that the execution of the user interface process is delayed.

### Ninth Embodiment

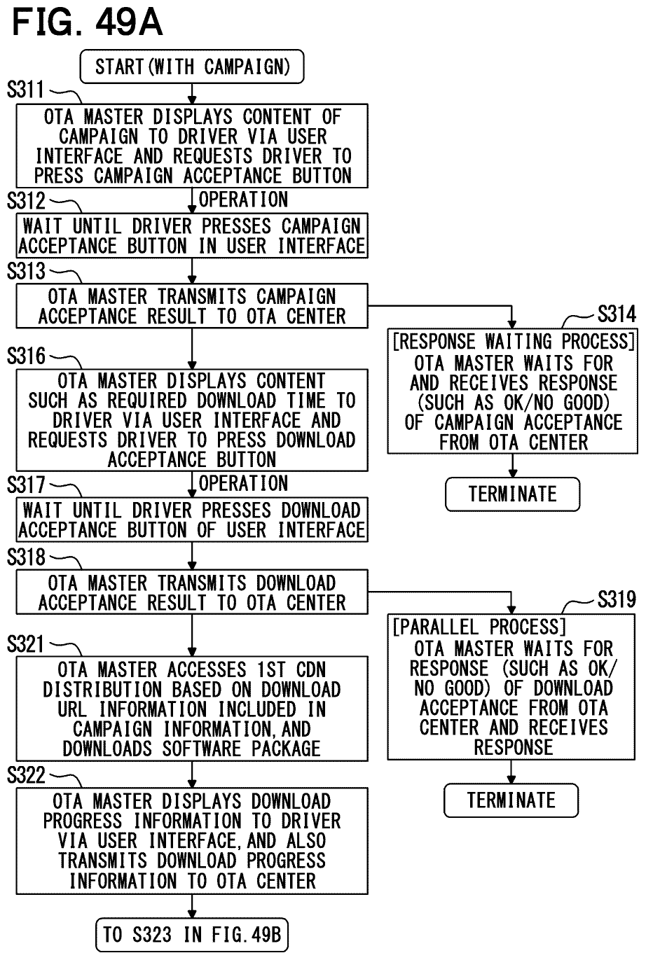

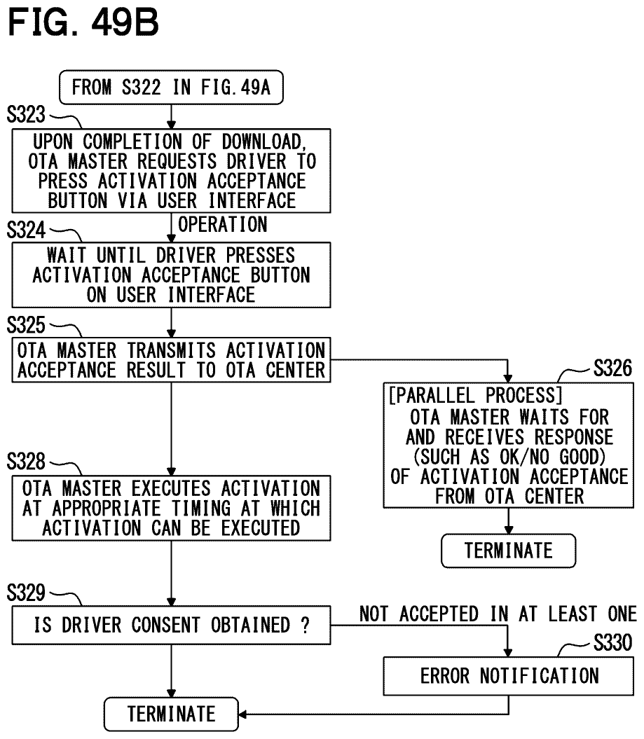

The ninth embodiment illustrated in FIG. 49 is a modification of the eighth embodiment, and steps S315, S320, and S327 are excluded from the process illustrated in FIG. 48. Therefore, the process immediately proceeds to the next process without waiting for the elapse of a predetermined time in these processes. When step S328 is executed, the OTA master 52 determines whether the driver's consent has been obtained for each process (S329), and when the driver's consent has not been obtained in at least one process, the OTA master notifies the OTA center 1F of an error (S330).

### Tenth Embodiment

The tenth embodiment is a modification of the seventh embodiment, and illustrates a case where a process for a request made by a premium member is preferentially performed by registering some drivers of the vehicles 31A in the OTA center 1F as premium members in advance.

Note that the premium member is an example of the current update target vehicle, and the VIN list of the premium member is an example of the VIN list of the current update target vehicle. In order to prevent access concentration on the OTA center and the distribution system, only some of the update target vehicles are notified of information indicating the presence of the campaign.

### <Registration of VIN List of Premium Member>

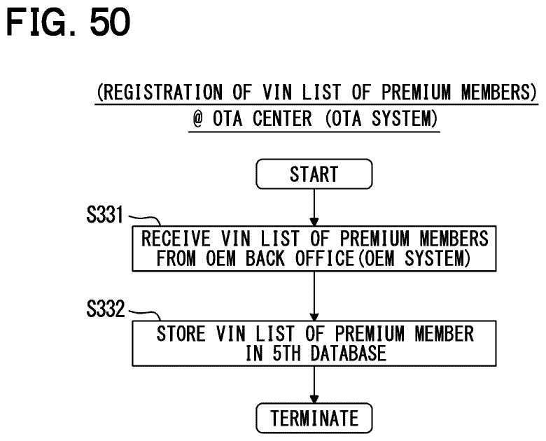

As illustrated in FIG. 50, when receiving the VIN list of premium members from the OEM back office 4 (S331), the OTA center 1F registers the list in the database section 41F (S332). The VIN list of premium members is an example of the priority processing list. Note that the OTA center 1F may create the priority processing list based on the owner information about the vehicle 31A instead of the VIN list of the premium members. The VIN list of the premium members is an example of the VIN list of the vehicles to be software updated.

It is assumed that software update is performed for some (for example, premium members) of vehicles to be software updated, the vehicles being grasped by the OEM back office 4. For example, in a case where there are 10 million vehicles to be software updated, in consideration of the communication load between the vehicle 31A and the OTA center 1F and the processing load in the OTA center 1F, it is assumed that the software update is performed on only the vehicle 31A designated as a premium member before the other vehicles. In this case, the VIN list of the vehicle 31A designated as the premium member is registered in the OTA center 1F from the OEM back office 4. For the non-premium member, even when HTTPS request for vehicle configuration information synchronization is transmitted from the vehicle 31A, the smartphone 32, or the PC 33 at this time, the process is performed as no campaign information in step S333 or S341 described later.

The VIN list registered in the OTA center 1F from the OEM back office 4 is updated by updating the VIN list from the OEM back office 4 or by a request from the OTA center 1F. As a result, the non-premium member's vehicle 31A that cannot be software updated at the beginning is registered in the VIN list and is software updated. Note that, in a case where the VIN list is not registered in the OTA center 1F from the OEM back office 4 or in a case where a blank VIN list is registered, all the vehicles 31A may be treated as premium members, and vehicle configuration information synchronization, campaign confirmation, and the like may be performed.

### <Transmission of Vehicle Configuration Information Field→Transmission of Campaign Information (Process by the OTA Center)>

When the transmission source of the request is the vehicle 31A, the process is performed as follows.

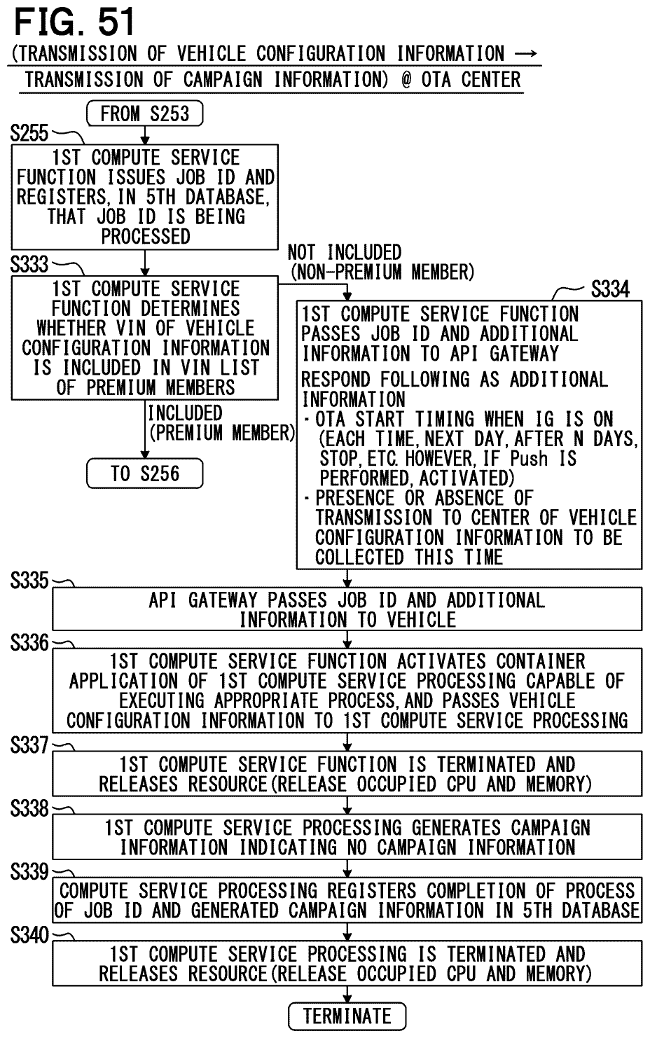

When steps S251 to S255 are executed as in the seventh embodiment, as illustrated in FIG. 51, the compute service function section 12F determines whether the VIN included in the vehicle configuration information is included in the VIN list of premium members (S333). When it is included in the list, step S256 and subsequent steps are executed. The VIN is an example of vehicle ID information.

When the VIN is not included in the VIN list, the compute service function section 12F passes the job ID and the additional information to the API gateway section 11F, and the additional information includes the following transmission conditions (S334).

Timing to transmit a request to the OTA center 1F when the ignition switch is turned on. For example, the timing is each time, the next day, N days later, stop, or the like. However, when there is a push notification from the OTA center 1F, the request may be transmitted accordingly.

Whether the vehicle configuration information to be collected this time is transmitted to the OTA center 1F.

For example, it is possible to designate a time at which a request is transmitted to the OTA center 1F next by the additional information. It is also possible to instruct not to include the vehicle configuration information at the time of transmitting the next request. The process in steps S335 to S340 is similar to that in steps S257 to S272.

Furthermore, in a case where the transmission source of the request is the smartphone 32 or the PC 33, the process is performed as follows.

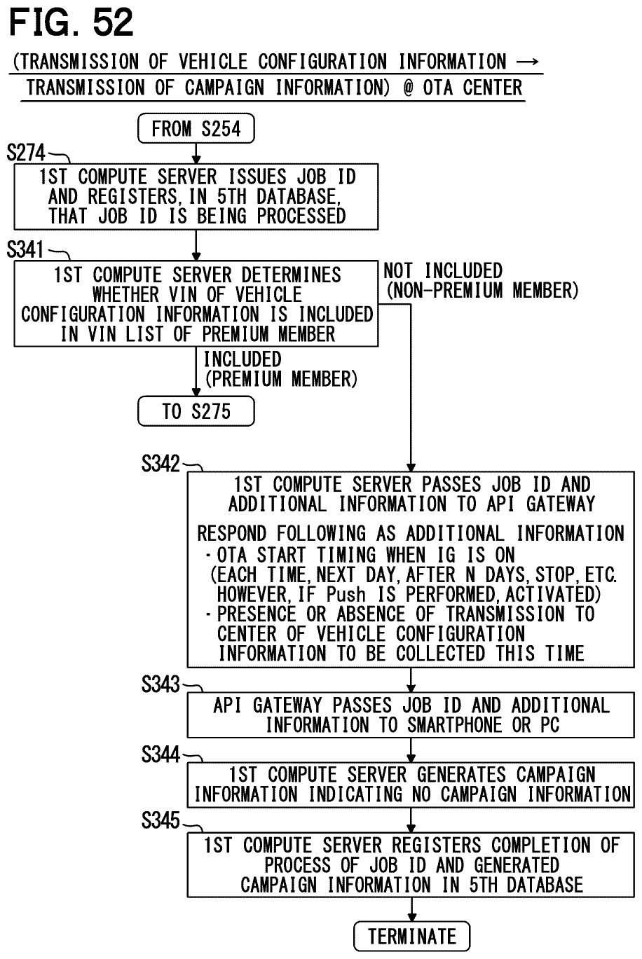

As illustrated in FIG. 52, when step S274 is executed, the compute server section 62 makes a determination similar to that in step S333 (S341). When the VIN is included in the VIN list of premium members, step S275 and subsequent steps are executed. When not included in the VIN list, the compute server section 62 makes a determination similar to that in step S334 (S342). Subsequent steps S343 to S345 are processes similar to those in steps S335, S338, and S339, and in S338 and S339, the compute server section 62 make execution instead of the compute service function section 12F.

As described above, according to the tenth embodiment, when the VIN of the vehicle 31A corresponding to the information request 1 is not registered in the VIN list of the premium member, the compute service function section 12F transmits, to the in-vehicle system 51 via the API gateway section 11F, information indicating that there is no campaign information as a final response to the request without determining whether there is the campaign information for the vehicle 31A. As a result, it is possible to preferentially transmit the campaign information to some users registered as premium members.

### Eleventh Embodiment

In the above embodiment, the HTTPS request of the vehicle configuration information, the HTTPS request of the campaign information registration, and the HTTPS request of the case information for the case information registration have been described as the information request 1, but the information request 1 may be other information. The information request 1 may be, for example, information for identifying a vehicle, such as a vehicle identification number (VIN). For example, as the information request 1, the VIN may be transmitted from the vehicle 31A, the smartphone 32, or the PC 33 to the OTA center. The vehicle identification information is an example of vehicle information. As a response to the information request 2 from the OTA center, for example, campaign information transmitted to the vehicle 31A is described. The information request 2 may be various instructions requested by the OTA center to the OTA master 52.

### Other Embodiments

The application program employing the serverless architecture is not limited to the one using the AWS, and other cloud computing services may be used.

The information portable terminal is not limited to a smartphone or a personal computer.

The outside with which the OTA center communicates is not limited to the vehicle or the OTA operator.

The access control information is not limited to the expiration date and the signed URL.

The transmission condition may be an area allowing transmission of the information request 2, for example, a parking lot.

Although the present disclosure has been described according to the embodiments, it is understood that the present disclosure is not limited to the above-described embodiments or structures. The present disclosure includes various modified examples and equivalents thereof. In addition, while the various elements are shown in various combinations and configurations, which are exemplary, other combinations and configurations, including more, less or only a single element, are also within the spirit and scope of the present disclosure.

Means and/or functions provided by each device or the like may be provided by software recorded in a substantive memory device and a computer that can execute the software, software only, hardware only, or some combination of them. For example, when the control device is provided by an electronic circuit that is hardware, it can be provided by a digital circuit including a large number of logic circuits, or an analog circuit.

The control unit and the method thereof of the present disclosure may be implemented by a dedicated computer provided by configuring a processor and a memory programmed to execute one or more functions embodied by a computer program. Alternatively, the control unit and the method described in the present disclosure may be implemented by a dedicated computer provided by forming a processor with one or more dedicated hardware logic circuits. Alternatively, the control unit and the method described in the present disclosure may be implemented by one or more dedicated computers including a combination of a processor and a memory programmed to execute one or multiple functions and a processor including one or more hardware logic circuits. The computer program may also be stored on a computer-readable and non-transitory tangible recording medium as an instruction executed by a computer.

What is claimed is:

1. A vehicle communication system configured to implement, by application programs, a plurality of functions for managing data to be written into an electronic control unit mounted on a vehicle and transmitting update data to the vehicle by wireless communication,
wherein
an application program of the application programs implementing at least one of the functions employs a server architecture in which a resource is always allocated and that is executed as a resident-type process,
an application program of the application programs implementing at least another one of the functions employs a serverless architecture in which the application program is activated upon occurrence of an event and is dynamically allocated with a resource in an on-demand manner for execution of a code of the application program, and in which the resource allocated to the application program is released when the execution of the code is terminated, the vehicle communication system comprising:
a campaign determination section that is configured to receive vehicle configuration information from a vehicle and determine whether there is campaign information for the vehicle;
a campaign generation section that is configured to generate campaign notification information for the vehicle when there is the campaign information;
a status management section that is configured to manage a generation state of the campaign information; and
a campaign transmission section that is configured to deliver the campaign notification information to a vehicle according to the generation state,
wherein
the vehicle communication system includes
a center apparatus in which an application program that implements functions of the campaign determination section, the status management section, and the campaign generation section employs the serverless architecture, and
an in-vehicle system that includes the electronic control unit and performs wireless communication with the center apparatus,
when the in-vehicle system transmits a first request including vehicle information to the center apparatus, the campaign transmission section transmits an intermediate response including a job ID corresponding to the request to the in-vehicle system, and
when receiving the intermediate response, the in-vehicle system transmits a response request of a final response corresponding to the first request to the center apparatus as a second request to which the job ID is assigned.

2. A vehicle communication system configured to implement, by application programs, a plurality of functions for managing data to be written into an electronic control unit mounted on a vehicle and transmitting update data to the vehicle by wireless communication,
wherein
an application program of the application programs implementing at least one of the functions employs a serverless architecture in which the application program is activated upon occurrence of an event and is dynamically allocated with a resource in an on-demand manner for execution of a code of the application program, and in which the resource allocated to the application program is released when the execution of the code is terminated, the vehicle communication system comprising:
a campaign determination section that is configured to receive vehicle configuration information from a vehicle and determine whether there is campaign information for the vehicle;
a campaign generation section that is configured to generate campaign notification information for the vehicle when there is the campaign information;
a status management section that is configured to manage a generation state of the campaign information; and
a campaign transmission section that is configured to deliver the campaign notification information to a vehicle according to the generation state,
wherein
the vehicle communication system includes
a center apparatus in which an application program that implements functions of the campaign determination section, the status management section, and the campaign generation section employs the serverless architecture, and
an in-vehicle system that includes the electronic control unit and performs wireless communication with the center apparatus,
when the in-vehicle system transmits a first request including vehicle information to the center apparatus, the campaign transmission section transmits an intermediate response including a job ID corresponding to the request to the in-vehicle system, and
when receiving the intermediate response, the in-vehicle system transmits a response request of a final response corresponding to the first request to the center apparatus as a second request to which the job ID is assigned.

3. The vehicle communication system according to claim 2, wherein
the in-vehicle system transmits the second request to the center apparatus when a predetermined time elapses after receiving the intermediate response.

4. The vehicle communication system according to claim 2, wherein
the campaign transmission section transmits the intermediate response including additional information including a transmission condition of the second request to the in-vehicle system, and
the in-vehicle system transmits the second request when the transmission condition is satisfied after receiving the intermediate response.

5. The vehicle communication system according to claim 4, wherein
the transmission condition includes a standby time from when the in-vehicle system receives the intermediate response to when the in-vehicle system transmits the second request, and
the in-vehicle system transmits the second request when the standby time elapses.

6. The vehicle communication system according to claim 4, wherein
the transmission condition includes designation of an area in which transmission of the second request is permitted.

7. The vehicle communication system according to claim 2, wherein
the in-vehicle system causes the first request to include a hash value obtained by applying a hash function to vehicle configuration information collected in the vehicle.

8. The vehicle communication system according to claim 7, wherein
the campaign transmission section transmits the final response to the in-vehicle system, the final response including a transmission request of entire data of vehicle configuration information collected in the vehicle, and
the in-vehicle system causes the second request to include the entire data in response to the transmission request.

9. The vehicle communication system according to claim 7, wherein
the campaign transmission section transmits information indicating that there is campaign information or no campaign information for the vehicle to the in-vehicle system as the final response according to a result of determination by the campaign determination section.

10. The vehicle communication system according to claim 9, wherein
the campaign determination section determines whether ID information of a vehicle corresponding to the first request is registered in a priority processing list, and
when the ID information is not registered in the priority processing list, the campaign determination section transmits, to the in-vehicle system via the campaign transmission section, information indicating that there is no campaign information as the final response without determining whether there is campaign information for the vehicle.

11. The vehicle communication system according to claim 2, wherein
the in-vehicle system includes a user interface section on which an occupant of a vehicle performs an input operation, and
when a process based on the input operation performed on the user interface section involves reception of a response from the center apparatus, the process proceeds to a next user interface process without waiting for reception of the response.

12. The vehicle communication system according to claim 2, wherein
the in-vehicle system includes a user interface section on which an occupant of the vehicle performs an input operation, and
when a process based on the input operation performed on the user interface section involves reception of a response from the center apparatus, the process proceeds to a next user interface process when the response is received or a predetermined time has elapsed.

13. An in-vehicle system including an electronic control unit and performing wireless communication with a center apparatus which is configured to implement, by application programs, a plurality of functions for managing data to be written into the electronic control unit mounted on a vehicle and transmitting update data to the vehicle by wireless communication,
wherein
an application program of the application programs implementing at least one of the functions employs a server architecture in which a resource is always allocated and that is executed as a resident-type process,
an application program of the application programs implementing at least another one of the functions employs a serverless architecture in which the application program is activated upon occurrence of an event and is dynamically allocated with a resource in an on-demand manner for execution of a code of the application program, and in which the resource allocated to the application program is released when the execution of the code is terminated,
the center apparatus includes:
a campaign determination section that is configured to receive vehicle configuration information from a vehicle and determine whether there is campaign information for the vehicle;
a campaign generation section that is configured to generate campaign notification information for the vehicle when there is the campaign information;
a status management section that is configured to manage a generation state of the campaign information; and
a campaign transmission section that is configured to deliver the campaign notification information to a vehicle according to the generation state,
wherein
the center apparatus in which an application program that implements functions of the campaign determination section, the status management section, and the campaign generation section employs the serverless architecture,
wherein
the in-vehicle system transmits a first request including vehicle information to the center apparatus, receives an intermediate response including a job ID corresponding to the request from the center apparatus, and when receiving the intermediate response, transmits a response request of a final response corresponding to the first request to the center apparatus as a second request to which the job ID is assigned.

14. An in-vehicle system including an electronic control unit and performing wireless communication with a center apparatus which is configured to implement, by application programs, a plurality of functions for managing data to be written into the electronic control unit mounted on a vehicle and transmitting update data to the vehicle by wireless communication,
wherein
an application program of the application programs implementing at least one of the functions employs a serverless architecture in which the application program is activated upon occurrence of an event and is dynamically allocated with a resource in an on-demand manner for execution of a code of the application program, and in which the resource allocated to the application program is released when the execution of the code is terminated,
the center apparatus includes:
a campaign determination section that is configured to receive vehicle configuration information from a vehicle and determine whether there is campaign information for the vehicle;
a campaign generation section that is configured to generate campaign notification information for the vehicle when there is the campaign information;
a status management section that is configured to manage a generation state of the campaign information; and
a campaign transmission section that is configured to deliver the campaign notification information to a vehicle according to the generation state,
wherein
the center apparatus in which an application program that implements functions of the campaign determination section, the status management section, and the campaign generation section employs the serverless architecture,
wherein
the in-vehicle system transmits a first request including vehicle information to the center apparatus, receives an intermediate response including a job ID corresponding to the request from the center apparatus, and when receiving the intermediate response, transmits a response request of a final response corresponding to the first request to the center apparatus as a second request to which the job ID is assigned.
